(19) United States
(12) Patent Application Publication
(10) Pub. No.: US 2014/0199616 A1
(43) Pub. Date: Jul. 17, 2014

(54) COLORED COMPOSITION, COLORED CURED FILM, COLOR FILTER, METHOD FOR PRODUCING COLOR FILTER, LIQUID CRYSTAL DISPLAY DEVICE, SOLID-STATE IMAGING DEVICE, AND NOVEL DIPYRROMETHENE METAL COMPLEX COMPOUND OR TAUTOMER THEREOF

(71) Applicant: FUJIFILM CORPORATION, Tokyo (JP)

(72) Inventor: Daisuke SASAKI, Shizuoka-ken (JP)

(73) Assignee: FUJIFILM CORPORATION, Tokyo (JP)

(21) Appl. No.: 14/217,504

(22) Filed: Mar. 18, 2014

Related U.S. Application Data
(63) Continuation of application No. PCT/JP2012/071095, filed on Aug. 21, 2012.

(30) Foreign Application Priority Data
Sep. 27, 2011 (JP) 2011-211351

(51) Int. Cl. C07F 3/06; G02B 1/04

(52) U.S. Cl. CPC C07F 3/06; G02B 1/04
USPC 430/7; 548/106; 252/586

(57) ABSTRACT

A colored composition including a dipyrromethene metal complex compound represented by the following formula (I) or a tautomer thereof:

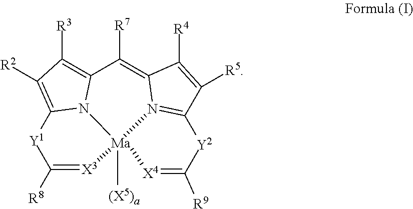

### CROSS-REFERENCE TO RELATED APPLICATIONS

This application is a continuation application of International Application No. PCT/JP/2012/071095, filed Aug. 21, 2012, the disclosure of which is incorporated herein by reference in its entirety. Further, this application claims priority from Japanese Patent Application No. 2011-211351, filed Sep. 27, 2011, the disclosure of which is incorporated herein by reference in its entirety.

### TECHNICAL FIELD

The invention relates to a colored composition, a colored cured film, a color filter, a method for producing a color filter, a liquid crystal display device, a solid-state imaging device, and a novel dipyrromethene metal complex compound or a tautomer thereof.

### BACKGROUND ART

Color filters have been conventionally produced by a process of preparing a colored composition by incorporating a pigment dispersed composition in which an organic pigment or an inorganic pigment is dispersed, a polyfunctional monomer, a polymerization initiator, an alkali-soluble resin, and other components as necessary, and forming a colored pattern using this composition by a photolithographic method, an inkjet method or the like.

In recent years, the use of color filters tends to be extended to monitors as well as televisions (TV) in the liquid crystal display device (LCD) applications. Along with this tendency of the extension of use, color filters have been required to have higher-level color characteristics in terms of chromaticity, contrast and the like. Furthermore, with regard to the color filters for image sensor (solid state imaging device) applications as well, there has been a similar demand for further enhancement in color characteristics, such as a decrease in color unevenness and an increase in color resolution.

However, in conventional pigment dispersion systems, problems such as the occurrence of scattering caused by coarse particles of pigments and an increase in viscosity caused by defective dispersion stability are likely to occur, and in many cases, it is difficult to further increase the contrast and brightness.

Thus, it has been hitherto considered to use not only pigments but also dyes as colorants (see, for example, Japanese Patent Application Laid-Open (JP-A) No. H06-75375). When a dye is used as a colorant, the color purity or the vividness of color of the dye itself can bring an enhancement in the hue or brightness of displayed images on the occasion of image display, and since coarse particles do not exist, it is useful in view of increasing the contrast.

Regarding examples of dyes, there are known compounds having a wide variety of colorant main bodies, such as dipyrromethene-based dyes, pyrimidine azo-based dyes, pyrazole azo-based dyes, and xanthene-based dyes (see, for example, JP-A Nos. 2008-292970 and 2007-039478, and Japanese Patent No. 3387541).

### SUMMARY OF INVENTION

### Technical Problem

However, when a dye is used, decreases in light resistance, heat resistance and voltage retention rate may easily occur as compared with the case of using a conventional pigment. From that point of view, the above-described dye compounds that have been conventionally known do not have sufficient heat resistance and light resistance, and further improvement has been desired.

The invention has been achieved in view of such circumstances as described above, and an object of the invention is to provide a colored composition which has high color purity, is capable of obtaining a high extinction coefficient in a thin layer, and has excellent fastness properties (particularly, heat resistance and light resistance), a color filter, and a method for producing the color filter; a liquid crystal display device which exhibits clear color and high contrast in a displayed image, and a solid state imaging device; and a dipyrromethene metal complex compound which has excellent color purity, has a high extinction coefficient that enables formation of a thinner layer, and has excellent fastness properties (particularly, heat resistance and light resistance), and a tautomer thereof.

### Solution to Problem

Specific means for solving the problem described above are as follows.

<1> A colored composition comprising a dipyrromethene metal complex compound represented by the following formula (I) or a tautomer thereof:

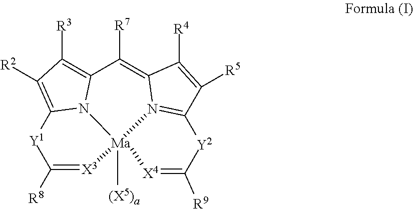

wherein, in formula (I), R² to R⁵ each independently represent a hydrogen atom or a monovalent substituent, provided that at least one of R² or R⁵ represents a heteroaryl group; R⁷ represents a hydrogen atom, a halogen atom, an alkyl group, an aryl group, or a heterocyclic group; Ma represents a metal or a metal compound; X³ and X⁴ each independently represent NR, a nitrogen atom, an oxygen atom, or a sulfur atom, wherein R represents a hydrogen atom, an alkyl group, an alkenyl group, an aryl group, a heterocyclic group, an acyl group, an alkylsulfonyl group, or an arylsulfonyl group; Y¹ and Y² each independently represent NR^{c}, a nitrogen atom, or a carbon atom, wherein R^{c} represents a hydrogen atom, an alkyl group, an alkenyl group, an aryl group, a heterocyclic group, an acyl group, an alkylsulfonyl group, or an arylsulfonyl group; R⁸ and R⁹ each independently represent an alkyl group, an alkenyl group, an aryl group, a heterocyclic group, an alkoxy group, an aryloxy group, an alkylamino group, an arylamino group, or a heterocyclic amino group; R⁸ and Y¹ may be bonded to each other to form a 5-membered, 6-membered or 7-membered ring; R⁹ and Y² may be bonded to each other to form a 5-membered, 6-membered or 7-membered ring; X⁵ represents a group capable of bonding to Ma; a represents 0, 1 or 2; and when a is 2, X⁵'s may be identical to or different from each other.

<2> A colored composition comprising a dipyrromethene metal complex compound obtained from a dipyrromethene compound represented by the following formula and a metal or a metal compound, or a tautomer thereof:

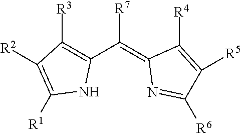

wherein, in the formula, R¹ to R⁶ each independently represent a hydrogen atom or a monovalent substituent, provided that at least one of R² or R⁵ represents a heteroaryl group; and R⁷ represents a hydrogen atom, a halogen atom, an alkyl group, an aryl group or a heterocyclic group.

<3> The colored composition according to <1> or <2>, wherein R² and R⁵ each independently represent a heteroaryl group.

<4> The colored composition according to any of <1> to <3>, wherein the heteroaryl group is represented by the following formula (II):

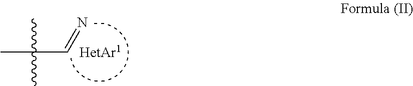

wherein, in formula (II), HetAr¹ represents a heteroaryl ring; the heteroaryl ring may have one or more substituents; and when the heteroaryl ring has a substituent, the substituent may be bonded to at least one of carbon atoms included in the heteroaryl ring to form a condensed ring together with the heteroaryl ring.

<5> The colored composition according to any of <1> to <4>, further comprising a polymerizable compound and a photopolymerization initiator.

<6> A colored cured film obtained by curing the colored composition according to any of <1> to <5>.

<7> A color filter comprising the colored cured film according to <6>.

<8> A method for producing a color filter, comprising:

applying the colored composition according to any of <1> to <5> onto a support to form a colored composition layer; and

patternwise exposing and developing the formed colored composition layer to form a patterned colored cured film.

<9> A liquid crystal display device comprising the color filter according to <7> or a color filter produced by the method for producing a color filter according to <8>.

<10> A solid-state imaging device comprising the color filter according to <7> or a color filter produced by the method for producing a color filter according to <8>.

<11> A dipyrromethene metal complex compound represented by the following formula (I) or a tautomer thereof:

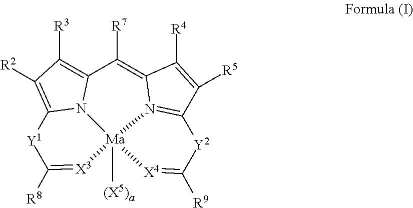

wherein, in formula (I), R² to R⁵ each independently represent a hydrogen atom or a monovalent substituent, provided that at least one of R² or R⁵ represents a heteroaryl group; R⁷ represents a hydrogen atom, a halogen atom, an alkyl group, an aryl group, or a heterocyclic group; Ma represents a metal or a metal compound; X³ and X⁴ each independently represent NR, a nitrogen atom, an oxygen atom, or a sulfur atom, wherein R represents a hydrogen atom, an alkyl group, an alkenyl group, an aryl group, a heterocyclic group, an acyl group, an alkylsulfonyl group, or an arylsulfonyl group; Y¹ and Y² each independently represent NR^{c}, a nitrogen atom, or a carbon atom, wherein R^{c} represents a hydrogen atom, an alkyl group, an alkenyl group, an aryl group, a heterocyclic group, an acyl group, an alkylsulfonyl group, or an arylsulfonyl group; R⁸ and R⁹ each independently represent an alkyl group, an alkenyl group, an aryl group, a heterocyclic group, an alkoxy group, an aryloxy group, an alkylamino group, an arylamino group, or a heterocyclic amino group; R⁸ and Y¹ may be bonded to each other to form a 5-membered, 6-membered or 7-membered ring; R⁹ and Y² may be bonded to each other to form a 5-membered, 6-membered or 7-membered ring; X⁵ represents a group capable of bonding to Ma; a represents 0, 1 or 2; and when a is 2, X⁵'s may be identical to or different from each other.

### Advantageous Effects of Invention

According to the invention, it is possible to provide a colored composition which has high color purity, is capable of obtaining a high extinction coefficient in a thin layer, and has excellent fastness properties (particularly, heat resistance and light resistance), a color filter, and a method for producing the color filter.

According to the invention, it is possible to provide a liquid crystal display device which exhibits clear color and high contrast in a displayed image, and a solid state imaging device.

According to the invention, it is possible to provide a dipyrromethene metal complex compound which has excellent color purity, has a high extinction coefficient that enables formation of a thinner layer, and has excellent fastness properties (particularly, heat resistance and light resistance), and a tautomer thereof.

### DESCRIPTION OF EMBODIMENTS

Hereinafter, the colored composition, a colored cured film obtained by curing the colored composition, a color filter and a method for producing the color filter, a liquid crystal display device and a solid-state imaging device, and a novel dipyrromethene metal complex compound and a tautomer thereof according to the invention will be described in detail.

The colored composition and the novel dipyrromethene metal complex compound and a tautomer thereof according to the invention can solve the problems that could not be solved with color resists using conventionally known dyes. Therefore, the colored composition, and the novel dipyrromethene metal complex compound and a tautomer thereof are particularly useful for color filters that are used in solid-state imaging devices or image display devices (for example, liquid crystal display devices and organic EL display devices).

The explanation on the constituent elements of the invention that will be described below is based on a representative exemplary embodiment of the invention, but the invention is not intended to be limited to such an exemplary embodiment.

In regard to the colored composition of the invention, the total solid content means the total mass of components excluding organic solvents from the overall composition of the colored composition.

The numerical value range represented by using “to” in the present specification means a range including the numerical values described before and after the “to” as the lower limit and the upper limit.

In the present specification, for example, the “alkyl group” represents a “linear, branched or cyclic” alkyl group. Furthermore, in regard to the description of a group (atomic group) in the present specification, a description which does not describe whether the group is substituted or unsubstituted is intended to include a group (atomic group) that does not have a substituent as well as a group (atomic group) that has a substituent. For example, the “alkyl group” includes an alkyl group that does not have a substituent (unsubstituted alkyl group) as well as an alkyl group that has a substituent (substituted alkyl group).

Furthermore, in the present specification, “(meth)acrylate” represents both or either of acrylate and methacrylate; “(meth)acryl” represents both or either of acryl and methacryl; and “(meth)acryloyl” represents both or either of acryloyl and methacryloyl.

Furthermore, in the present specification, the “monomer” and “monomer” have the same meaning. A monomer according to the present specification is distinguished from an oligomer and a polymer, and means a compound having a weight average molecular weight of 2,000 or less.

In the present specification, a polymerizable compound is a compound having a polymerizable functional group, and may be a monomer, an oligomer or a polymer. A polymerizable functional group refers to a group which participates in a polymerization reaction.

The term “process” in the present specification does not merely mean an independent process, and even if a process cannot be clearly distinguished from other processes, the process is intended to be included in this term as long as a predetermined effect of the process is achieved.

The “radiation” according to the invention means radiation including visible light, ultraviolet radiation, far-ultraviolet radiation, electron beam, X-radiation, or the like.

### <<Colored Composition>>

The colored composition of the invention contains at least one selected from a metal complex compound represented by formula (I) or a tautomer compound thereof (hereinafter, appropriately referred to as “particular metal complex compound”), and preferably, the colored composition further contains a polymerizable compound and a photopolymerization initiator to be photosensitive.

Furthermore, the colored composition of the invention preferably further contains a binder such as an alkali-soluble resin, and an organic solvent, and if necessary, may contain various additives.

The colored composition of the invention contains, among dipyrromethene metal complex compounds, particularly a dipyrromethene metal complex compound having a heteroaryl group as a pyrrole ring substituent, or a tautomer compound thereof. When the colored composition contains, as a colorant, a particular metal complex compound having a heteroaryl group as a substituent, a colored composition having excellent heat resistance, light resistance, voltage retention rate, contrast and brightness can be provided. Furthermore, a colored cured film formed by using the colored composition, and a color filter including the colored cured film can be provided.

It is known that when a dye is used, a phenomenon of a decrease in fastness properties (particularly, heat resistance and light resistance) occurs. The mechanism of occurrence is not clearly known; however, it is contemplated that the cause of the phenomenon is that when the dye molecule has a substituent or bonding site that is labile to heat or light, the substituent or bonding site is decomposed by heat or light, and the dye is converted to a coloring component having an unexpected color that is different from the original color developed by the dye.

On the other hand, in the dipyrromethene metal complex compound and tautomer compound thereof according to the invention, a heteroaryl group that is resistant to heat or light is substituted so as to be conjugated to a pyrrole ring. Furthermore, it is speculated that the particular metal complex compound represented by formula (I) has a heteroaryl group in at least one of R² or R⁵ and can therefore form an intramolecular hydrogen bond with neighboring Y¹ or Y².

That is, it is speculated that by substituting a heteroaryl group at a particular position in the particular metal complex compound represented by formula (I), a dye having high stability to heat or light can be obtained, and a color filter which does not undergo a decrease in brightness caused by heat or light and exhibits reduced color change can be obtained.

<Metal Complex Compound Represented by Formula (I) and Tautomer Compound Thereof>

The colored composition of the invention contains at least one kind of a metal complex compound represented by the following formula (I) or a tautomer thereof (particular metal complex compound).

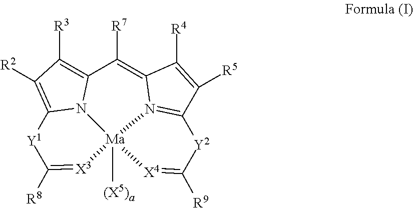

Hereinafter, formula (I) will be explained in detail.

In formula (I), R² to R⁵ each independently represent a hydrogen atom or a monovalent substituent.

In formula (I), examples of the monovalent substituent represented by R² to R⁵ include a halogen atom (examples include a fluorine atom, a chlorine atom, and a bromine atom), an alkyl group (preferably a linear, branched or cyclic alkyl group having 1 to 48 carbon atoms, and more preferably 1 to 24 carbon atoms, and examples include a methyl group, an ethyl group, a propyl group, an n-propyl group, an isopropyl group, a butyl group, an n-butyl group, an i-butyl group, a t-butyl group, a pentyl group, a hexyl group, a heptyl group, an octyl group, a 2-ethylhexyl group, a dodecyl group, a hexadecyl group, a cyclopropyl group, a cyclopentyl group, a cyclohexyl group, a cyclobutyl group, a benzyl group, a 1-norbornyl group, and a 1-adamantyl group),

an alkenyl group (preferably an alkenyl group having 2 to 48 carbon atoms, and more preferably 2 to 18 carbon atoms, and examples include a vinyl group, an allyl group, and a 3-buten-1-yl group), an aryl group (preferably an aryl group having 6 to 48 carbon atoms, and more preferably 6 to 24 carbon atoms, and examples include a substituted or unsubstituted phenyl group, and a substituted or unsubstituted naphthyl group), a heterocyclic group (preferably a heterocyclic group having 1 to 32 carbon atoms, and more preferably 1 to 18 carbon atoms, and examples include a 2-thienyl group, a 4-pyridyl group, a 3-pyridyl group, a 2-pyridyl group, a 1-pyridyl group, a 2-furyl group, a 2-pyrimidinyl group, a 2-benzothiazolyl group, a 1-imidazolyl group, a 1-pyrazolyl group, and a benzotriazol-1-yl group),

a silyl group (preferably a silyl group having 3 to 38 carbon atoms, and more preferably 3 to 18 carbon atoms, and examples include a trimethylsilyl group, a triethylsilyl group, a tributylsilyl group, a t-butyldimethylsilyl group, and a t-hexyldimethylsilyl group), a hydroxyl group, a cyano group, a nitro group, an alkoxy group (preferably an alkoxy group having 1 to 48 carbon atoms, and more preferably 1 to 24 carbon atoms, and examples include a methoxy group, an ethoxy group, a 1-butoxy group, a 2-butoxy group, an isopropoxy group, a t-butoxy group, a dodecyloxy group, and a cycloalkyloxy group (for example, a cyclopentyloxy group or a cyclohexyloxy group)), an aryloxy group (preferably an aryloxy group having 6 to 48 carbon atoms, and more preferably 6 to 24 carbon atoms, and examples include a phenoxy group and a 1-naphthoxy group),

a heterocyclic oxy group (preferably a heterocyclic oxy group having 1 to 32 carbon atoms, and more preferably 1 to 18 carbon atoms, and examples include a 1-phenyltetrazole-5-oxy group and a 2-tetrahydropyranyloxy group), a silyloxy group (preferably a silyloxy group having 1 to 32 carbon atoms, and more preferably 1 to 18 carbon atoms, and examples include a trimethylsilyloxy group, a t-butyldimethylsilyloxy group, and a diphenylmethylsilyloxy group), an acyloxy group (preferably an acyloxy group having 2 to 48 carbon atoms, and more preferably 2 to 24 carbon atoms, and examples include an acetoxy group, a pivaloyloxy group, a benzoyloxy group, and a dodecanoyloxy group), an alkoxycarbonyloxy group (preferably an alkoxycarbonyloxy group having 2 to 48 carbon atoms, and more preferably 2 to 24 carbon atoms, and examples include an ethoxycarbonyloxy group, a t-butoxycarbonyloxy group, and a cycloalkyloxycarbonyloxy group (for example, a cyclohexyloxycarbonyloxy group)),

an aryloxycarbonyloxy group (preferably an aryloxycarbonyloxy group having 7 to 32 carbon atoms, and more preferably 7 to 24 carbon atoms, and examples include a phenoxycarbonyloxy group), a carbamoyloxy group (preferably a carbamoyloxy group having 1 to 48 carbon atoms, and more preferably 1 to 24 carbon atoms, and examples include N,N-dimethylcarbamoyloxy group, an N-butylcarbamoyloxy group, an N-phenylcarbamoyloxy group, and N-ethyl-N-phenylcarbamoyloxy group), a sulfamoyloxy group (preferably a sulfamoyloxy group having 1 to 32 carbon atoms, and more preferably 1 to 24 carbon atoms, and examples include an N,N-diethylsulfamoyloxy group, and an N-propylsulfamoyloxy group),

an alkylsulfonyloxy group (preferably an alkylsulfonyloxy group having 1 to 38 carbon atoms, and more preferably 1 to 24 carbon atoms, and examples include a methylsulfonyloxy group, a hexadecylsulfonyloxy group, and a cyclohexylsulfonyloxy group), an arylsulfonyloxy group (preferably an arylsulfonyloxy group having 6 to 32 carbon atoms, and more preferably 6 to 24 carbon atoms, and examples include a phenylsulfonyloxy group), an acyl group (preferably an acyl group having 1 to 48 carbon atoms, and more preferably 1 to 24 carbon atoms, and examples include a formyl group, an acetyl group, a pivaloyl group, a benzoyl group, a tetradecanoyl group, and a cyclohexanoyl group), an alkoxycarbonyl group (preferably an alkoxycarbonyl group having 2 to 48 carbon atoms, and more preferably 2 to 24 carbon atoms, and examples include a methoxycarbonyl group, an ethoxycarbonyl group, an octadecyloxycarbonyl group, a cyclohexyloxycarbonyl group, and a 2,6-di-tert-butyl-4-methylcyclohexyloxycarbonyl group), an aryloxycarbonyl group (preferably an aryloxycarbonyl group having 7 to 32 carbon atoms, and more preferably 7 to 24 carbon atoms, and examples include a phenoxycarbonyl group), a carbamoyl group (preferably a carbamoyl group having 1 to 48 carbon atoms, and more preferably 1 to 24 carbon atoms, and examples include a carbamoyl group, an N,N-diethylcarbamoyl group, an N-ethyl-N-octylcarbamoyl group, an N,N-dibutylcarbamoyl group, an N-propylcarbamoyl group, an N-phenylcarbamoyl group, an N-methyl-N-phenylcarbamoyl group, and an N,N-dicyclohexylcarbamoyl group), an amino group (preferably an amino group having 32 or fewer carbon atoms, and more preferably 24 or fewer carbon atoms, and examples include an amino group, a methylamino group, an N,N-dibutylamino group, a tetradecylamino group, a 2-ethylhexylamino group, and a cyclohexylamino group), an anilino group (preferably an anilino group having 6 to 32 carbon atoms, and more preferably 6 to 24 carbon atoms, and examples include an anilino group and an N-methylanilino group),

a heterocyclic amino group (preferably a heterocyclic amino group having 1 to 32 carbon atoms, and more preferably 1 to 18 carbon atoms, and examples include a 4-pyridylamino group), a carbonamide group (preferably a carbonamide group having 2 to 48 carbon atoms, and more preferably 2 to 24 carbon atoms, and examples include an acetamide group, a benzamide group, a tetradecanamide group, a pivaloylamide group, and a cyclohexanamide group), a ureido group (preferably a ureido group having 1 to 32 carbon atoms, and more preferably 1 to 24 carbon atoms, and examples include a ureido group, an N,N-dimethylureido group, and an N-phenylureido group), an imide group (preferably an imide group having 36 or fewer carbon atoms, and more preferably 24 or fewer carbon atoms, and examples include an N-succinimide group and an N-phthalimide group), an alkoxycarbonylamino group (preferably an alkoxycarbonylamino group having 2 to 48 carbon atoms, and more preferably 2 to 24 carbon atoms, and examples include a methoxycarbonylamino group, an ethoxycarbonylamino group, a t-butoxycarbonylamino group, an octadecyloxycarbonylamino group, and a cyclohexyloxycarbonylamino group), an aryloxycarbonylamino group (preferably an aryloxycarbonylamino group having 7 to 32 carbon atoms, and more preferably 7 to 24 carbon atoms, and examples include a phenoxycarbonylamino group), a sulfonamide group (preferably a sulfonamide group having 1 to 48 carbon atoms, and more preferably 1 to 24 carbon atoms, and examples include a methanesulfonamide group, a butanesulfonamide group, a benzenesulfonamide group, a hexadecanesulfonamide group, and a cyclohexanesulfonamide group), a sulfamoylamino group (preferably a sulfamoylamino group having 1 to 48 carbon atoms, and more preferably 1 to 24 carbon atoms, and examples include an N,N-dipropylsulfamoylamino group, and an N-ethyl-N-dodecylsulfamoylamino group), an azo group (preferably an azo group having 1 to 32 carbon atoms, and more preferably 1 to 24 carbon atoms, and examples include a phenylazo group and a 3-pyrazolylazo group), an alkylthio group (preferably an alkylthio group having 1 to 48 carbon atoms, and more preferably 1 to 24 carbon atoms, and examples include a methylthio group, an ethylthio group, an octylthio group, and a cyclohexylthio group), an arylthio group (preferably an arylthio group having 6 to 48 carbon atoms, and more preferably 6 to 24 carbon atoms, and examples include a phenylthio group), a heterocyclic thio group (preferably a heterocyclic thio group having 1 to 32 carbon atoms, and more preferably 1 to 18 carbon atoms, and examples include a 2-benzothiazolylthio group, a 2-pyridylthio group, a 1-phenyltetrazolylthio group), an alkylsulfinyl group (preferably an alkylsulfinyl group having 1 to 32 carbon atoms, and more preferably 1 to 24 carbon atoms, and examples include a dodecanesulfinyl group),

an arylsulfinyl group (preferably an arylsulfinyl group having 6 to 32 carbon atoms, and more preferably 6 to 24 carbon atoms, and examples include a phenylsulfinyl group), an alkylsulfonyl group (preferably an alkylsulfonyl group having 1 to 48 carbon atoms, and more preferably 1 to 24 carbon atoms, and examples include a methylsulfonyl group, an ethylsulfonyl group, a propylsulfonyl group, a butylsulfonyl group, an isopropylsulfonyl group, a 2-ethylhexylsulfonyl group, a hexadecylsulfonyl group, an octylsulfonyl group, and a cyclohexylsulfonyl group), an arylsulfonyl group (preferably an arylsulfonyl group having 6 to 48 carbon atoms, and more preferably 6 to 24 carbon atoms, and examples include a phenylsulfonyl group and a 1-naphthylsulfonyl group),

a sulfamoyl group (preferably a sulfamoyl group having 32 or fewer carbon atoms, and more preferably 24 or fewer carbon atoms, and examples include a sulfamoyl group, an N,N-dipropylsulfamoyl group, an N-ethyl-N-dodecylsulfamoyl group, an N-ethyl-N-phenylsulfamoyl group, and an N-cyclohexylsulfamoyl group), a sulfo group, a phosphonyl group (preferably a phosphonyl group having 1 to 32 carbon atoms, and more preferably 1 to 24 carbon atoms, and examples include a phenoxyphosphonyl group, an octyloxyphosphonyl group, and a phenylphosphonyl group), and a phosphinoylamino group (preferably a phosphinoylamino group having 1 to 32 carbon atoms, and more preferably 1 to 24 carbon atoms, and examples include a diethoxyphosphinoylamino group and a dioctyloxyphosphinoylamino group).

When the monovalent substituent represented by R² to R⁵ in formula (I) is a group that can be further substituted, the monovalent substituent represented by R² to R⁵ may further have the substituent(s) described above in relation to R² to R⁵. When the monovalent substituent represented by R² to R⁵ has two or more monovalent substituents, those substituents may be identical to or different from each other.

In regard to formula (I), R³ and R⁴ described above are each preferably, among those described above, an alkyl group, an aryl group or a heterocyclic group; and more preferably an alkyl group or an aryl group.

In regard to formula (I), R² and R⁵ described above are each preferably, among those described above, an alkoxycarbonyl group, an aryloxycarbonyl group, a carbamoyl group, an alkylsulfonyl group, an arylsulfonyl group, a nitrile group, an imide group, a carbamoylsulfonyl group, or a heterocyclic group; and more preferably an alkoxycarbonyl group, an aryloxycarbonyl group, a carbamoyl group, a nitrile group, an imide group, a carbamoylsulfonyl group, or a heterocyclic group. However, at least one of R² or R⁵ represents a heteroaryl group that will be described below.

The various groups disclosed in the preferred embodiments described above may be unsubstituted, or may have the substituent(s) mentioned above.

In regard to formula (I), when R³ and R⁴ each represent an alkyl group, the alkyl group is preferably a linear, branched or cyclic alkyl group having 1 to 12 carbon atoms, and more specifically, examples thereof include a methyl group, an ethyl group, an n-propyl group, an isopropyl group, a cyclopropyl group, an n-butyl group, an i-butyl group, a t-butyl group, a cyclobutyl group, a cyclopentyl group, a cyclohexyl group, and a benzyl group. The alkyl group is more preferably a branched or cyclic alkyl group having 1 to 12 carbon atoms, and more specifically, examples thereof include an isopropyl group, a cyclopropyl group, an i-butyl group, a t-butyl group, a cyclobutyl group, a cyclopentyl group, and a cyclohexyl group. The alkyl group is even more preferably a secondary alkyl group or tertiary alkyl group having 1 to 12 carbon atoms, and more specifically, examples thereof include an isopropyl group, a cyclopropyl group, an i-butyl group, a t-butyl group, a cyclobutyl group, and a cyclohexyl group.

The various alkyl groups disclosed in the preferred embodiments described above may be unsubstituted, or may have the substituent(s) mentioned above.

In regard to formula (I), when R³ and R⁴ each represent an aryl group, the aryl group is preferably a substituted or unsubstituted phenyl group, or a substituted or unsubstituted naphthyl group, and more preferably a substituted or unsubstituted phenyl group.

In regard to formula (I), when R³ and R⁴ each represent an aryl group, the aryl group is preferably a phenyl group or a naphthyl group, and more preferably a phenyl group.

The various aryl groups disclosed in the preferred embodiments described above may be unsubstituted, or may have the substituent(s) mentioned above.

In regard to formula (I), when R³ and R⁴ each represent a heterocyclic group, the heterocyclic group is preferably a 2-thienyl group, a 4-pyridyl group, a 3-pyridyl group, a 2-pyridyl group, a 1-pyridyl group, a 2-furyl group, a 2-pyrimidinyl group, a 2-benzothiazolyl group, a 1-imidazolyl group, a 1-pyrazolyl group, or a benzotriazol-1-yl group; and more preferably a 2-thienyl group, a 4-pyridyl group, a 2-furyl group, a 2-pyrimidinyl group, or a 1-pyridyl group.

The various heterocyclic groups disclosed in the preferred embodiments described above may be unsubstituted, or may have the substituent(s) mentioned above.

In formula (I), R² and R⁵ each independently represent a hydrogen atom or a monovalent substituent, as described above. However, at least one of R² or R⁵ represents a heteroaryl group. The heteroaryl group may have a substituent. Regarding the substituent, the monovalent substituent(s) mentioned for R² to R⁵ may be used. When the heteroaryl group represented by R² or R⁵ is substituted with two or more substituents, those substituents may be identical to or different from each other.

From the viewpoint of fastness properties, R² and R⁵ are each preferably a heteroaryl group. Furthermore, when R² and R⁵ are both heteroaryl groups, the structures of the heteroaryl groups may be identical to or different from each other, but it is more preferable that the structures be identical, from the viewpoint of synthesis suitability.

There are no particular limitations on the heteroaryl group, as long as the heteroaryl group contains one or more heteroatoms in the ring. Examples thereof include a pyrrole ring, a furan ring, a thiophene ring, a pyrazole ring, an imidazole ring, a triazole ring, an oxazole ring, a thiazole ring, a pyrrolidine ring, a piperidine ring, a pyridine ring, a pyrimidine ring, a triazine ring, a pyrazine ring, and a pyridazine ring, but among them, a structure represented by the following formula (II) is preferred:

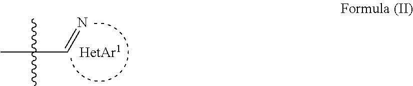 [SMILES: *C=N]

HetAr¹ represents a heteroaryl ring. The heteroaryl ring may have one or more substituents. In a case in which the heteroaryl ring has a substituent, the substituent may be bonded to at least one of the carbon atoms included in the heteroaryl ring to form a condensed ring together with the heteroaryl ring.

The heteroaryl ring represented by HetAr¹ is a heteroaryl ring containing at least one nitrogen atom. The heteroaryl ring may further contain, in addition to the nitrogen atom, a heteroatom selected from the group consisting of a nitrogen atom, an oxygen atom, and a sulfur atom.

The heteroaryl ring represented by HetAr¹ may be a 5-membered, 6-membered or 7-membered heteroaryl ring, and the heteroaryl ring may be any of a saturated ring or an unsaturated ring.

Examples of the heteroaryl ring represented by HetAr¹ include a pyrrole ring, a pyrazole ring, an imidazole ring, a triazole ring, an oxazole ring, a thiazole ring, a pyrrolidine ring, a piperidine ring, a pyridine ring, a pyrimidine ring, a triazine ring, a pyrazine ring, and a pyridazine ring, and preferred examples include a pyridine ring, a pyrimidine ring, a triazine ring, a thiazole ring, an oxazole ring, an oxadiazole ring, and a thiadiazole ring.

Examples of the substituent carried by the heteroaryl ring include the monovalent substituents described above for R² to R⁵.

When the heteroaryl group represented by R² or R⁵ is substituted with two or more substituents, those substituents may be identical to or different from each other.

In a case in which the heteroaryl ring has a substituent, the substituent may be bonded to at least one of the carbon atoms included in the heteroaryl ring to form a 5-membered, 6-membered or 7-membered ring.

Meanwhile, the ring thus formed may be a saturated ring or an unsaturated ring. Examples of this 5-membered, 6-membered or 7-membered saturated ring or unsaturated ring include a pyrrole ring, a furan ring, a thiophene ring, a pyrazole ring, an imidazole ring, a triazole ring, an oxazole ring, a thiazole ring, a pyrrolidine ring, a piperidine ring, a cyclopentene ring, a cyclohexene ring, a benzene ring, a pyridine ring, a pyrazine ring, and a pyridazine ring, and preferred examples include a benzene ring and a pyridine ring.

In addition, when the 5-membered, 6-membered or 7-membered ring thus formed is a group that can be further substituted, the monovalent substituent(s) described above for R² to R⁵ may be used.

From the viewpoints of synthesis suitability and heat resistance, formula (II) is preferably a structural formula represented by any one of the following formula (III):

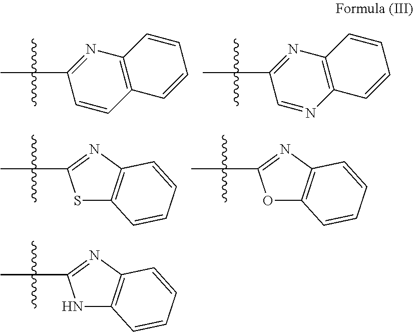

Meanwhile, the heteroaryl ring represented by formula (III) may be substituted with the substituent(s) described as the monovalent substituent represented by R² to R⁵. When the heteroaryl ring is substituted with two or more substituents on the ring, those substituents may be identical to or different from each other.

Furthermore, in a case in which the heteroaryl ring has a substituent, the substituent may be bonded to at least one of the carbon atoms included in the heteroaryl ring to further form a 5-membered, 6-membered or 7-membered ring.

Meanwhile, the ring formed herein may be a saturated ring or an unsaturated ring. Examples of this 5-membered, 6-membered or 7-membered saturated ring or unsaturated ring include a pyrrole ring, a furan ring, a thiophene ring, a pyrazole ring, an imidazole ring, a triazole ring, an oxazole ring, a thiazole ring, a pyrrolidine ring, a piperidine ring, a cyclopentene ring, a cyclohexene ring, a benzene ring, a pyridine ring, a pyrazine ring, and a pyridazine ring, and preferred examples include a benzene ring and a pyridine ring.

Meanwhile, when the 5-membered, 6-membered or 7-membered ring thus formed is a group that can be further substituted, examples of the substituent include the monovalent substituents described for R² to R⁵.

In formula (I), R⁷ represents a hydrogen atom, a halogen atom, an alkyl group, an aryl group or a heterocyclic group.

When R⁷ represents a halogen atom, an alkyl group, an aryl group or a heterocyclic group, R⁷ represents the same group as the halogen atom, alkyl group, aryl group or heterocyclic group described for the substituents represented by R² to R⁵, and preferred examples thereof are also the same.

In regard to formula (I), when the alkyl group, aryl group or heterocyclic group represented by R⁷ is a group that can be further substituted, the group may be substituted with the substituent(s) described as the monovalent substituent(s) represented by R² to R⁵. When the alkyl group, aryl group or heterocyclic group represented by R⁷ is substituted with two or more substituents, those substituents may be identical to or different from each other.

Ma in formula (I) represents a metal or a metal compound.

Ma may be any of a metal atom or metal compound that is capable of forming a complex, and examples include divalent metal atoms, divalent metal oxides, divalent metal hydroxides, and divalent metal chlorides.

Examples of the metal represented by Ma include Zn, Mg, Si, Sn, Rh, Pt, Pd, Mo, Mn, Pb, Cu, Ni, Co, Fe, and B.

Examples of the metal compound represented by Ma include metal chlorides such as AlCl, InCl, FeCl, TiCl₂, SnCl₂, SiCl₂, and GeCl₂; metal oxides such as TiO and VO; and metal hydroxides such as Si(OH)₂.

Among these, from the viewpoints of stability, spectral characteristics, heat resistance, light resistance and production suitability of the complex, and the like, Fe, Zn, Mg, Si, Pt, Pd, Mo, Mn, Cu, Ni, Co, TiO, B and VO are preferred; Fe, Zn, Mg, Si, Pt, Pd, Cu, Ni, Co, B and VO are more preferred; and Fe, Zn, Cu, Co, B and VO (V═O) are most preferred. Among these, Ma is particularly preferably Zn.

In formula (I), R⁸ and R⁹ each independently represent an alkyl group (preferably a linear, branched or cyclic alkyl group having 1 to 36 carbon atoms, and more preferably 1 to 12 carbon atoms, and examples include methyl, ethyl, propyl, isopropyl, butyl, isobutyl, t-butyl, 1,1-dimethylpropyl, hexyl, octyl, 2-ethylhexyl, dodecyl, cyclopropyl, cyclopentyl, cyclohexyl, and 1-adamantyl groups), an alkenyl group (preferably an alkenyl group having 2 to 24 carbon atoms, and more preferably 2 to 12 carbon atoms, and examples include vinyl, allyl, and 3-buten-1-yl groups), an aryl group (preferably an aryl group having 6 to 36 carbon atoms, and more preferably 6 to 18 carbon atoms, and examples include phenyl, naphthyl, and tolyl groups), a heterocyclic group (preferably a heterocyclic group having 1 to 24 carbon atoms, and more preferably 1 to 12 carbon atoms, and examples include 2-thienyl, 4-pyridyl, 2-furyl, 2-pyrimidinyl, 1-pyridyl, 2-benzothiazolyl, 1-imidazolyl, 1-pyrazolyl, and benzotriazol-1-yl groups),

an alkoxy group (preferably an alkoxy group having 1 to 36 carbon atoms, and more preferably 1 to 18 carbon atoms, and examples include methoxy, ethoxy, propyloxy, butoxy, hexyloxy, 2-ethylhexyloxy, dodecyloxy, and cyclohexyloxy groups), an aryloxy group (preferably an aryloxy group having 6 to 24 carbon atoms, and more preferably 6 to 18 carbon atoms, and examples include phenoxy and naphthyloxy groups), an alkylamino group (preferably an alkylamino group having 1 to 36 carbon atoms, and more preferably 1 to 18 carbon atoms, and examples include methylamino, ethylamino, propylamino, butylamino, hexylamino, 2-ethylhexylamino, isopropylamino, t-butylamino, t-octylamino, cyclohexylamino, N,N-diethylamino, N,N-dipropylamino, N,N-dibutylamino, and N-methyl-N-ethylamino groups), an arylamino group (preferably an arylamino group having 6 to 36 carbon atoms, and more preferably 6 to 18 carbon atoms, and examples include phenylamino, naphthylamino, N,N-diphenylamino, and N-ethyl-N-phenylamino groups), or a heterocyclic amino group (preferably a heterocyclic amino group having 1 to 24 carbon atoms, and more preferably 1 to 12 carbon atoms, and examples include 2-aminopyrrole, 3-aminopyrazole, 2-aminopyridine, and 3-aminopyridine groups).

In formula (I), when the alkyl group, alkenyl group, aryl group, heterocyclic group, alkoxy group, aryloxy group, alkylamino group, arylamino group or heterocyclic amino group represented by R⁸ or R⁹ is a group that can be further substituted, R⁸ or R⁹ may be substituted with the monovalent substituent(s) described above for R² to R⁵, and when R⁸ or R⁹ is substituted with two or more monovalent substituents, those substituents may be identical to or different from each other.

In formula (I), X³ and X⁴ each independently represent NR, a nitrogen atom, an oxygen atom or a sulfur atom.

R represents a hydrogen atom, an alkyl group (preferably a linear, branched or cyclic alkyl group having 1 to 36 carbon atoms, and more preferably 1 to 12 carbon atoms, and examples include a methyl group, an ethyl group, a propyl group, an isopropyl group, a butyl group, an isobutyl group, a t-butyl group, a hexyl group, a 2-ethylhexyl group, a dodecyl group, a cyclopropyl group, a cyclopentyl group, a cyclohexyl group, and a 1-adamantyl group), an alkenyl group (preferably an alkenyl group having 2 to 24 carbon atoms, and more preferably 2 to 12 carbon atoms, and examples include a vinyl group, an allyl group, and a 3-buten-1-yl group), an aryl group (preferably an aryl group having 6 to 36 carbon atoms, and more preferably 6 to 18 carbon atoms, and examples include a phenyl group and a naphthyl group), a heterocyclic group (preferably a heterocyclic group having 1 to 24 carbon atoms, and more preferably 1 to 12 carbon atoms, and examples include a 2-thienyl group, a 4-pyridyl group, a 2-furyl group, a 2-pyrimidinyl group, a 1-pyridyl group, a 2-benzothiazolyl group, a 1-imidazolyl group, a 1-pyrazolyl group, and a benzotriazol-1-yl group), an acyl group (preferably an acyl group having 1 to 24 carbon atoms, and more preferably 2 to 18 carbon atoms, and examples include an acetyl group, a pivaloyl group, a 2-ethylhexanoyl group, a benzoyl group, and a cyclohexanoyl group), an alkylsulfonyl group (preferably an alkylsulfonyl group having 1 to 24 carbon atoms, and more preferably 1 to 18 carbon atoms, and examples include a methylsulfonyl group, an ethylsulfonyl group, an isopropylsulfonyl group, and a cyclohexylsulfonyl group), or an arylsulfonyl group (preferably an arylsulfonyl group having 6 to 24 carbon atoms, and more preferably 6 to 18 carbon atoms, and examples include a phenylsulfonyl group and a naphthylsulfonyl group).

When the alkyl group, alkenyl group, aryl group, heterocyclic group, acyl group, alkylsulfonyl group or arylsulfonyl group represented by R is substitutable, the group may be substituted with the monovalent substituent(s) described above for the substituents R² to R⁵, and when the group is substituted with plural monovalent substituents, those substituents may be identical to or different from each other.

X³ and X⁴ are preferably each independently an oxygen atom or a sulfur atom, and X³ and X⁴ are particularly preferably oxygen atoms together.

In formula (I), Y¹ and Y² each independently represent NR^{C}, a nitrogen atom or a carbon atom, and R^{c} has the same definition as R of NR represented by X³ or X⁴ as described above.

Y¹ and Y² are preferably each independently NR^{C} (wherein R^{c} is preferably a hydrogen atom or an alkyl group having 1 to 8 carbon atoms), and Y¹ and Y² are particularly preferably NH together.

In formula (I), R⁸ and Y¹ may also be bonded to each other, so that R⁸ and Y¹, together with the carbon atom to which these are bonded, may form a 5-membered ring (examples include a cyclopentane ring, a pyrrolidine ring, a tetrahydrofuran ring, a dioxolane ring, a tetrahydrothiophene ring, a pyrrole ring, a furan ring, a thiophene ring, an indole ring, a benzofuran ring, and a benzothiophene ring), a 6-membered ring (examples include a cyclohexane ring, a piperidine ring, a piperazine ring, a morpholine ring, a tetrahydropyran ring, a dioxane ring, a pentamethylene sulfide ring, a dithiane ring, a benzene ring, a piperidine ring, a piperazine ring, a pyridazine ring, a quinoline ring, and a quinazoline ring), or a 7-membered ring (examples include a cycloheptane ring and a hexamethyleneimine ring).

In formula (I), R⁹ and Y² may be bonded to each other, so that R⁹, Y² and the carbon atom together may form a 5-membered, 6-membered or 7-membered ring. The 5-membered, 6-membered and 7-membered rings thus formed may be the same as the rings formed by R⁸, Y¹ and the carbon atom as described above.

In formula (I), when the 5-membered, 6-membered or 7-membered ring that is formed by bonding of R⁸ with Y¹ or R⁹ with Y² is a ring that can be further substituted, the ring may be substituted with the monovalent substituent(s) described above for the substituents R² to R⁵, and when the ring is substituted with two or more substituents, those monovalent substituents may be identical to or different from each other.

In formula (I), X⁵ represents a group capable of bonding to Ma, and particularly represents a group that is necessary in order to neutralize the charge of Ma. Examples thereof include a halogen atom (for example, a fluorine atom, a chlorine atom, and a bromine atom), a hydroxyl group, a monovalent group derived from an aliphatic imide (examples include succinic acid imide, maleimide, glutarimide and diacetamide, and preferred examples include succinic acid imide and maleimide), a monovalent group derived from an aromatic imide group or a heterocyclic imide (examples include phthalimide, naphthalimide, 4-bromophthalimide, 4-methylphthalimide, 4-nitrophthalimide, naphthalenecarboximide, and tetrabromophthalimide, and preferred examples include phthalimide, 4-bromophthalimide, and 4-methylphthalimide), a monovalent group derived from an aromatic carboxylic acid (examples include benzoic acid, 2-methoxybenzoic acid, 3-methoxybenzoic acid, 4-methoxybenzoic acid, 4-chlorobenzoic acid, 2-naphthoic acid, salicylic acid, 3,4,5-trimethoxybenzoic acid, 4-heptyloxybenzoic acid, and 4-t-butylbenzoic acid, and preferred examples include benzoic acid, 4-methoxybenzoic acid, and salicylic acid),

a monovalent group derived from an aliphatic carboxylic acid (examples include formic acid, acetic acid, acrylic acid, methacrylic acid, ethanoic acid, propanoic acid, lactic acid, pivalic acid, hexanoic acid, octanoic acid, 2-ethylhexanoic acid, neodecanoic acid, lauric acid, myristic acid, palmitic acid, stearic acid, oleic acid, isostearic acid, 2-hexadecyloctadecanoic acid, 2-hexyldecanoic acid, cyclopentanecarboxylic acid, cyclohexanecarboxylic acid, 5-norbornene-2-carboxylic acid, and 1-adamantanecarboxylic acid, and preferred examples include acetic acid, methacrylic acid, lactic acid, pivalic acid, 2-ethylhexanoic acid, and stearic acid), a monovalent group derived from dithiocarbamic acid (examples include dimethyldithiocarbamic acid, diethyldithiocarbamic acid, and dibenzyldithiocarbamic acid),

a monovalent group derived from sulfonamide (examples include benzenesulfonamide, 4-chlorobenzenesulfonamide, 4-methoxybenzenesulfonamide, 4-methylbenzenesulfonamide, 2-methylbenzenesulfonamide, and methanesulfonamide, and preferred examples include benzenesulfonamide and methanesulfonamide), a monovalent group derived from hydroxamic acid (examples include acetohydroxamic acid, octanohydroxamic acid, and benzohydroxamic acid), and a monovalent group derived from a nitrogen-containing ring compound (examples include hydantoin, 1-benzyl-5-ethoxyhydantoin, 1-allylhydantoin, 5,5-diphenylhydantoin, 5,5-dimethyl-2,4-oxazolidinedione, barbituric acid, imidazole, pyrazole, 4,5-dicyanoimidazole, 4,5-dimethylimidazole, benzimidazole, and diethyl 1H-imidazole-4,5-dicarboxylate, and preferred examples include 1-benzyl-5-ethoxyhydantoin, 5,5-dimethyl-2,4-oxazolidinedione, 4,5-dicyanoimidazole, and diethyl 1H-imidazole-4,5-dicarboxylate).

Among them, a halogen atom, an aliphatic carboxylic acid group, an aromatic carboxylic acid group, an aliphatic imide group, an aromatic imide group, a sulfonic acid group and a nitrogen-containing ring compound are preferred, and a hydroxyl group, an aliphatic carboxylic acid group, an aromatic imide group and a nitrogen-containing ring compound are more preferred.

In formula (I), a represents 0, 1 or 2.

When a is 2, X⁵'s may be identical or may be different.

The dipyrromethene metal complex compound represented by formula (I) may be a tautomer compound. The tautomer compound according to the invention may be any compound having a structure that can be formed as a result of transfer of one hydrogen atom in the molecule, and may be a structure represented by, for example, any one of the following formula (a) to formula (f).

Meanwhile, R², R³, R⁴, R⁵, R⁷, R⁸, R⁹, X³, X⁴, X¹, Y¹, Y² and Ma in formula (a) to formula (f) correspond to R², R³, R⁴, R⁵, R⁷, R⁸, R⁹, X³, X⁴, X⁵, Y¹, Y² and Ma in formula (I), respectively.

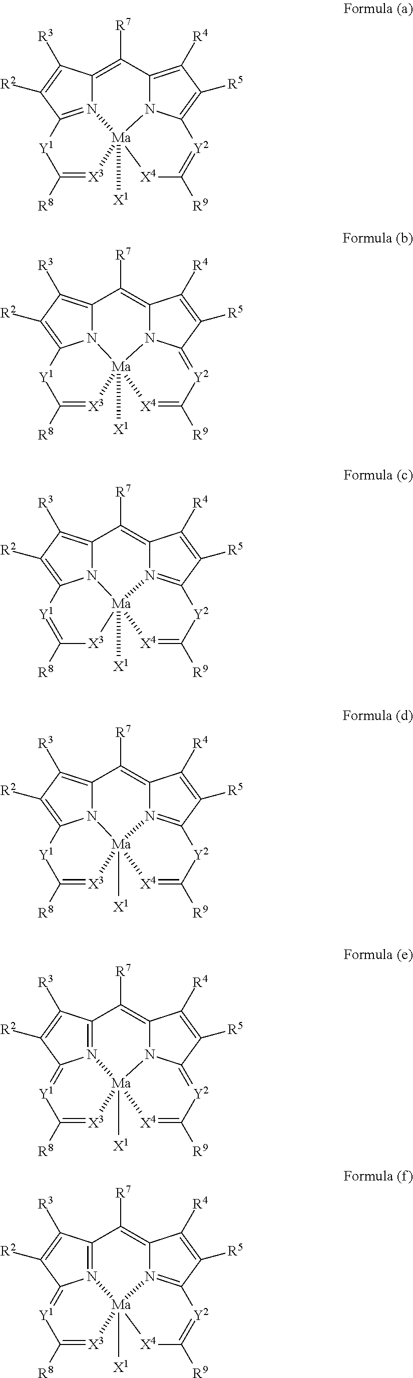

Exemplary compounds of the particular metal complex compound will be shown below, but the invention is not intended to be limited to these.

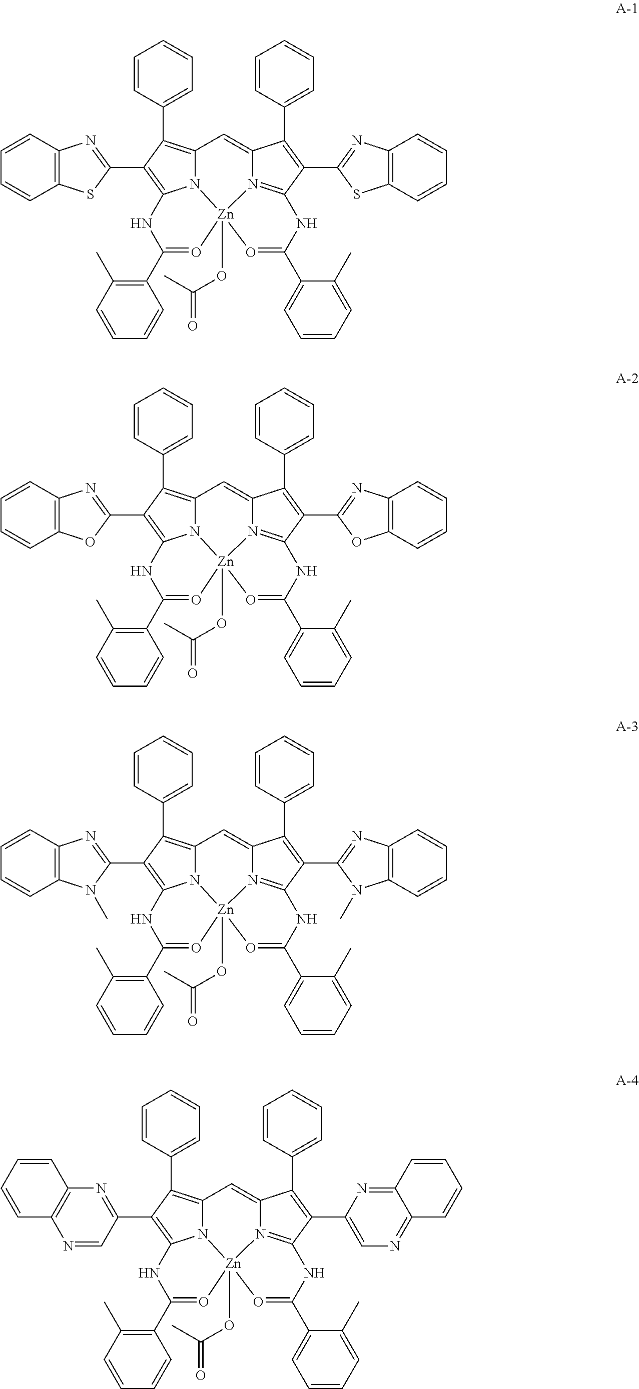

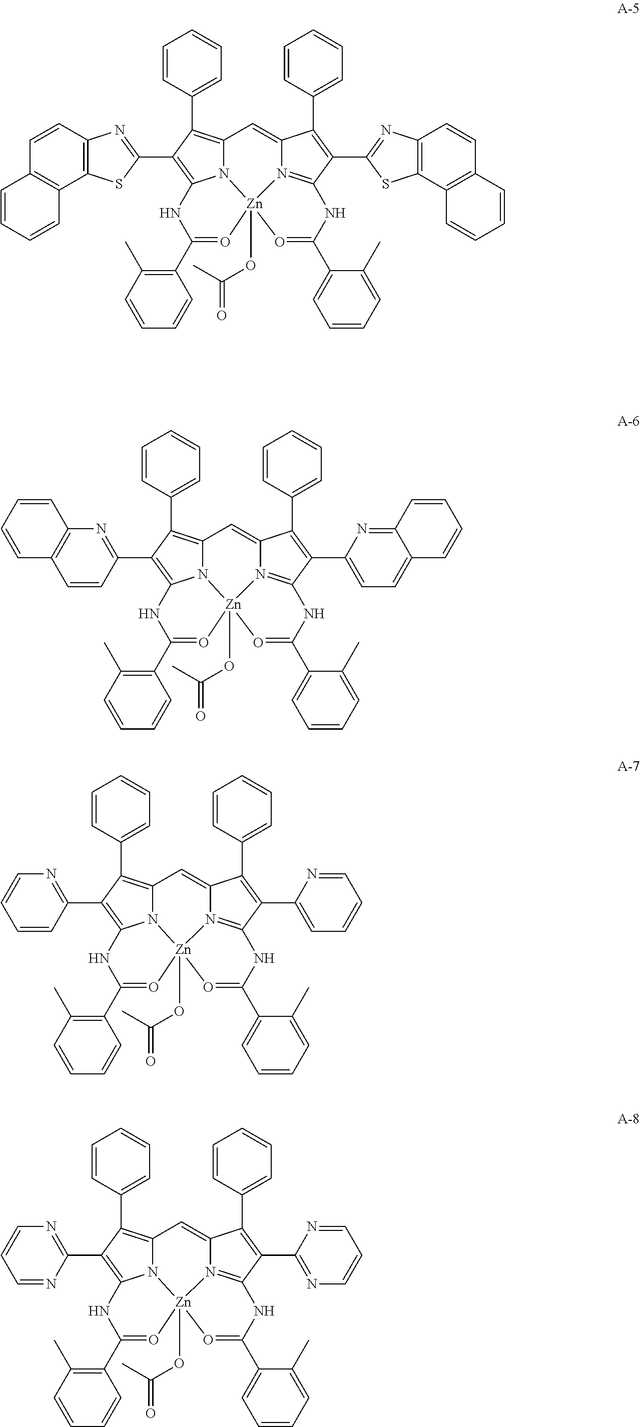

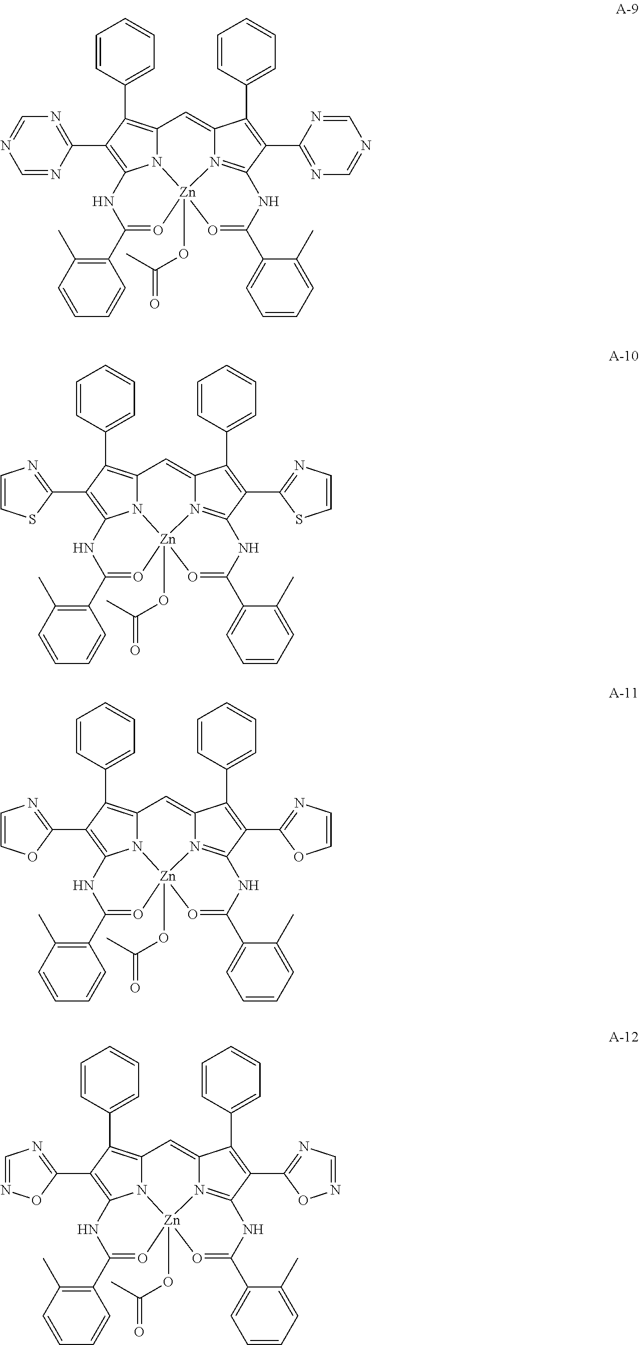

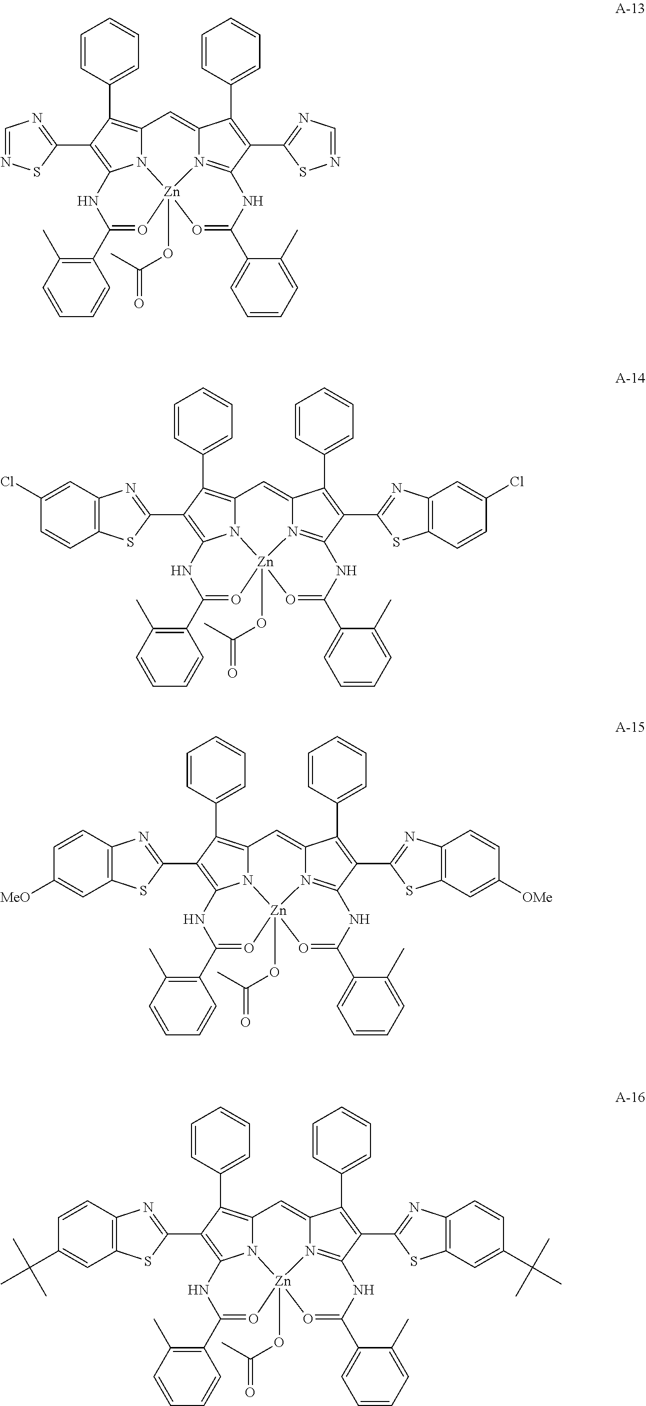

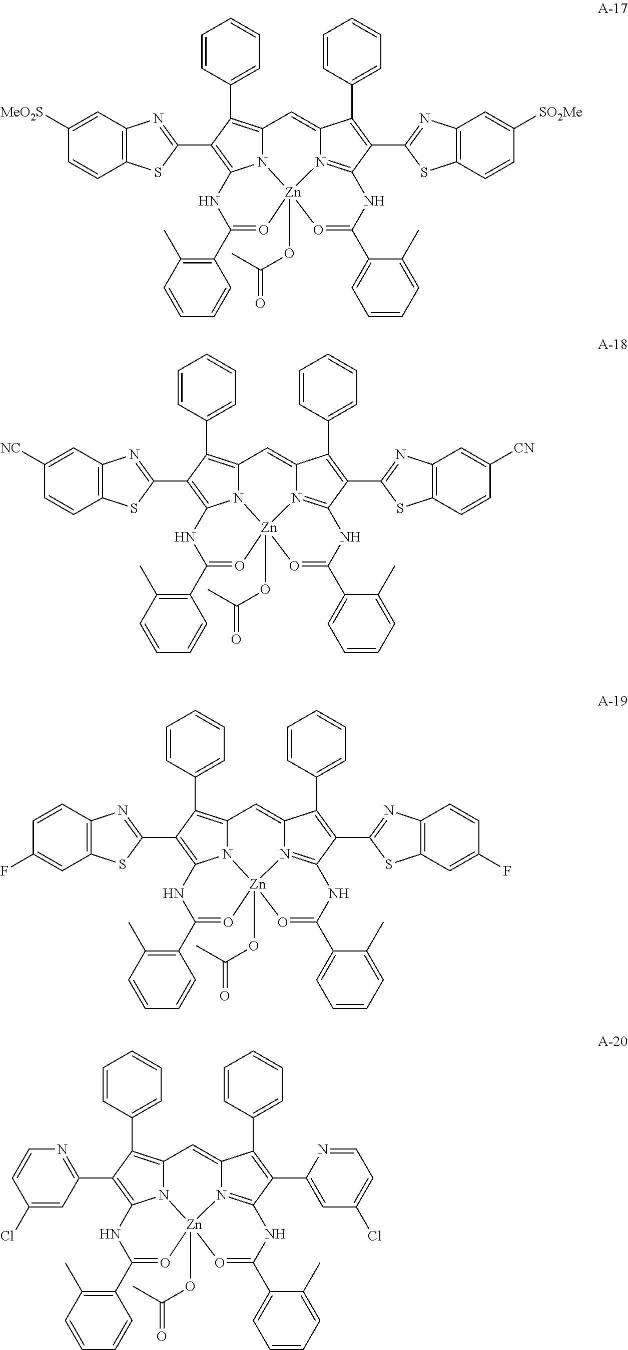

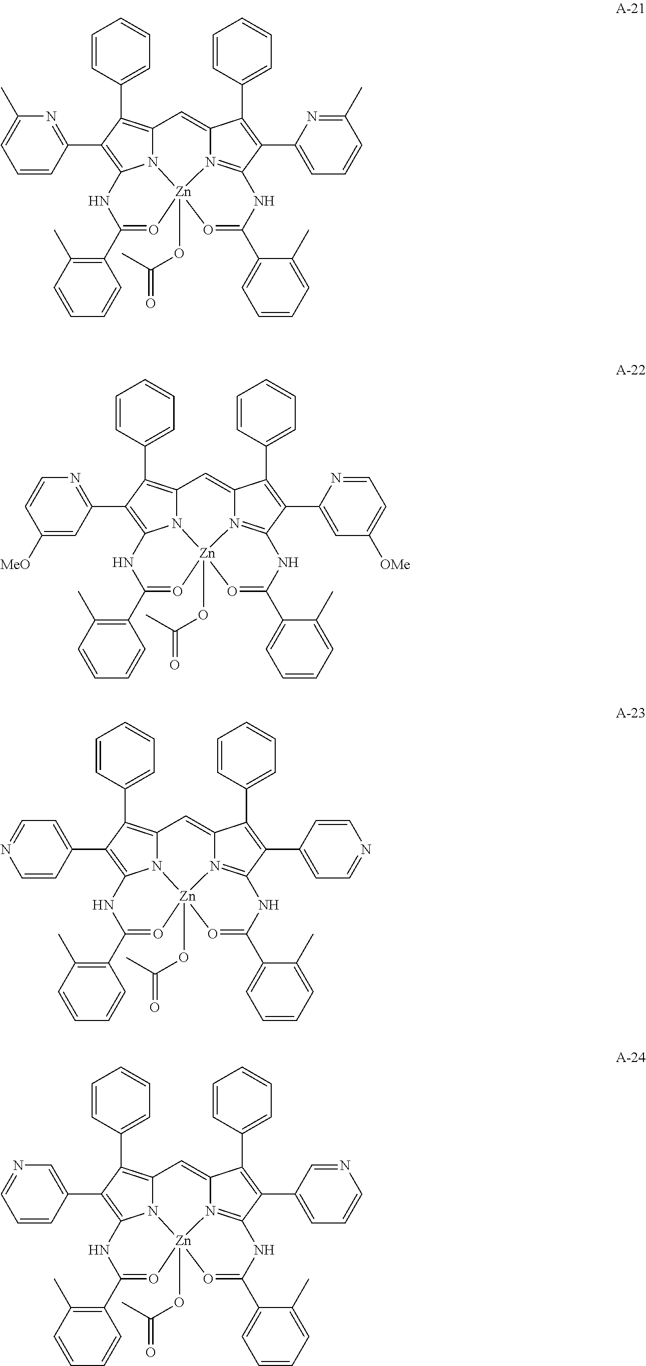

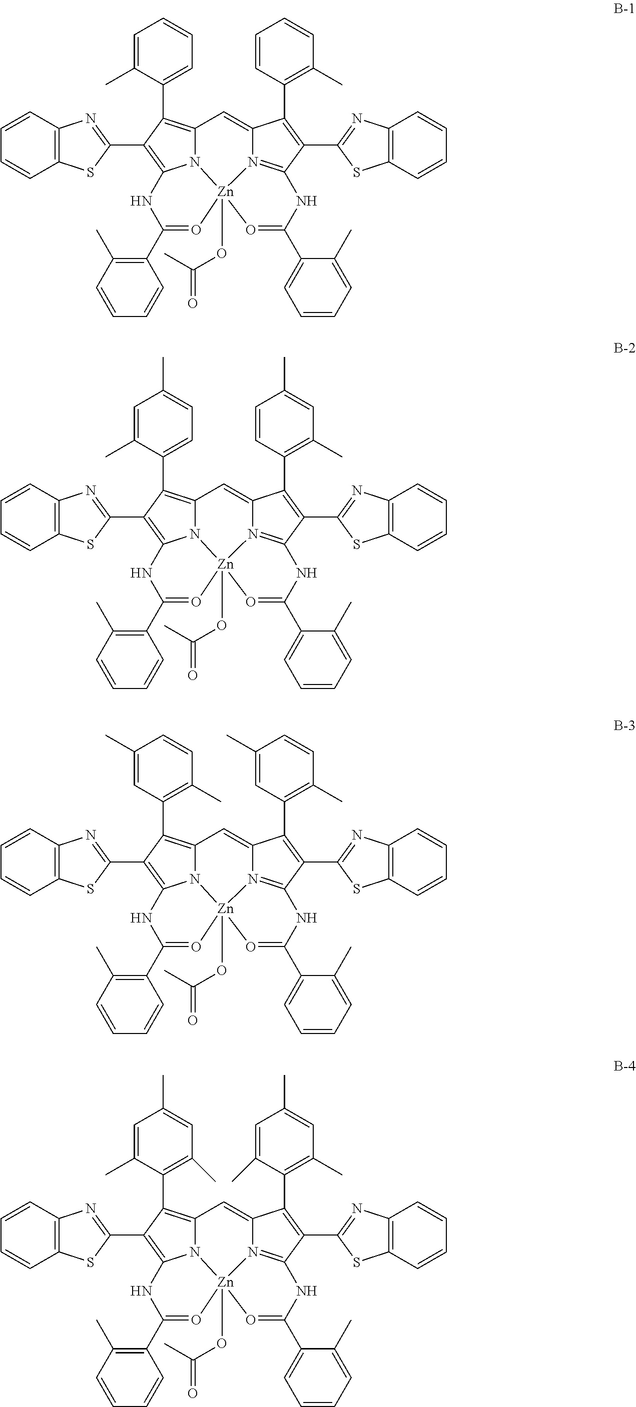

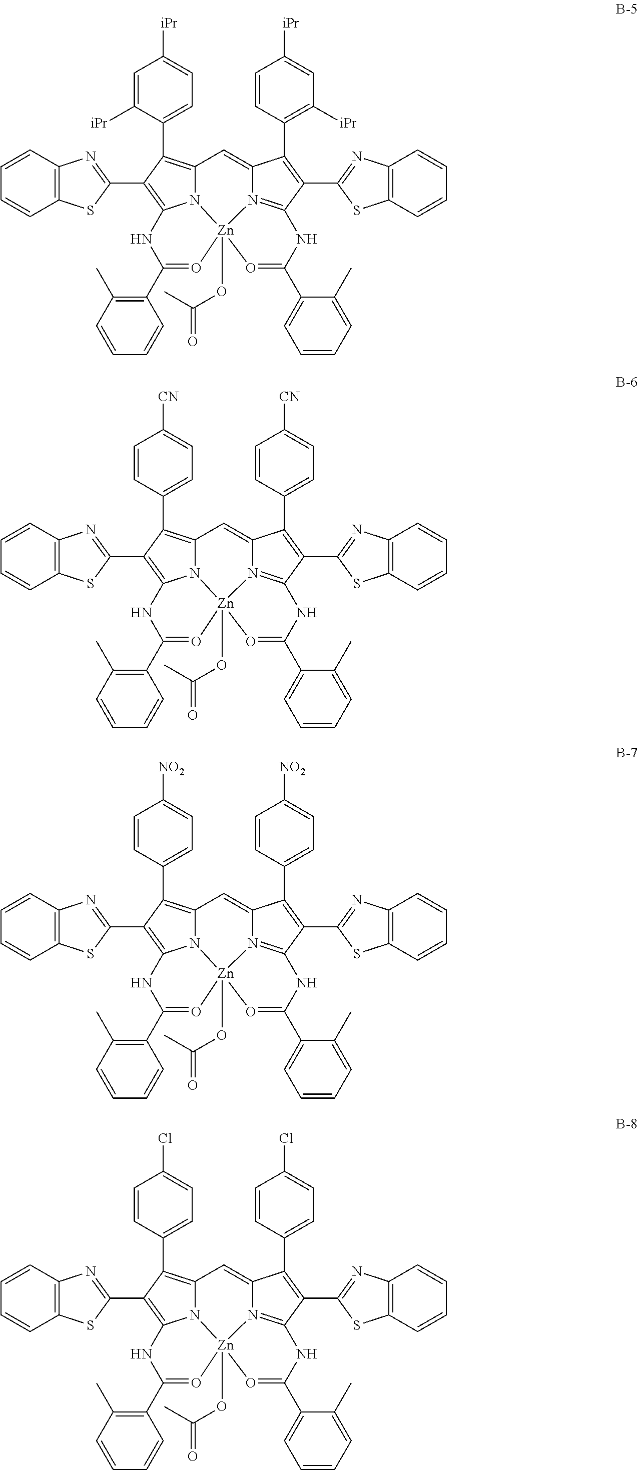

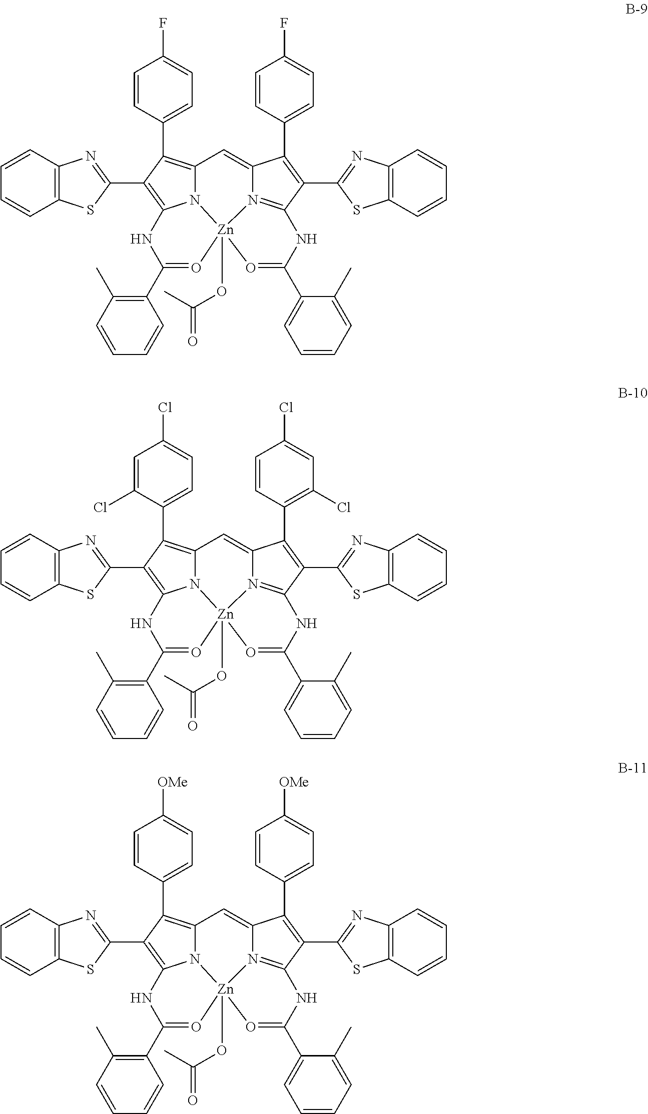

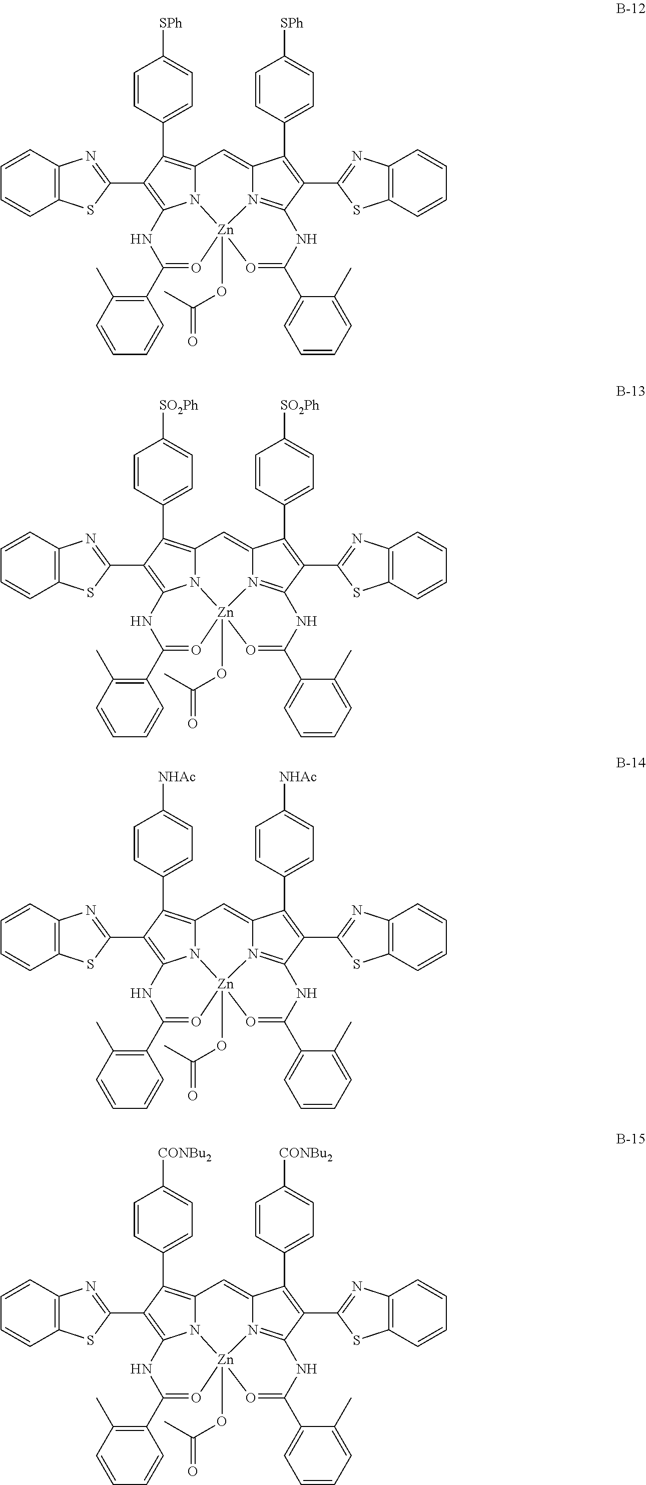

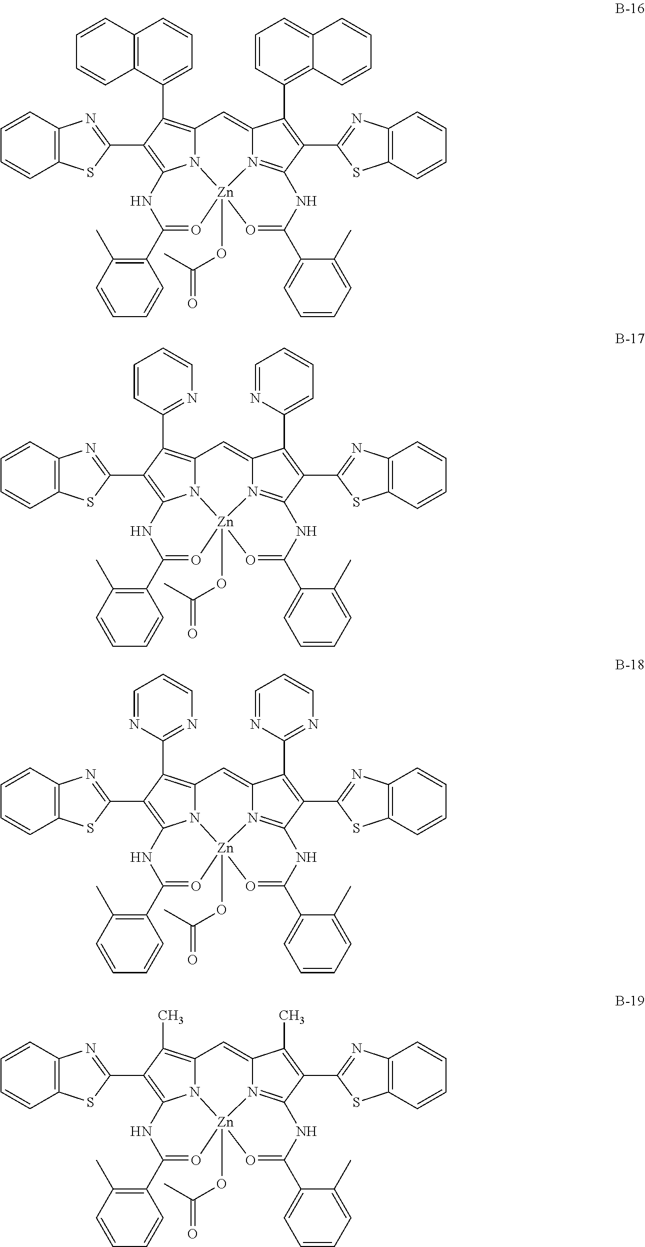

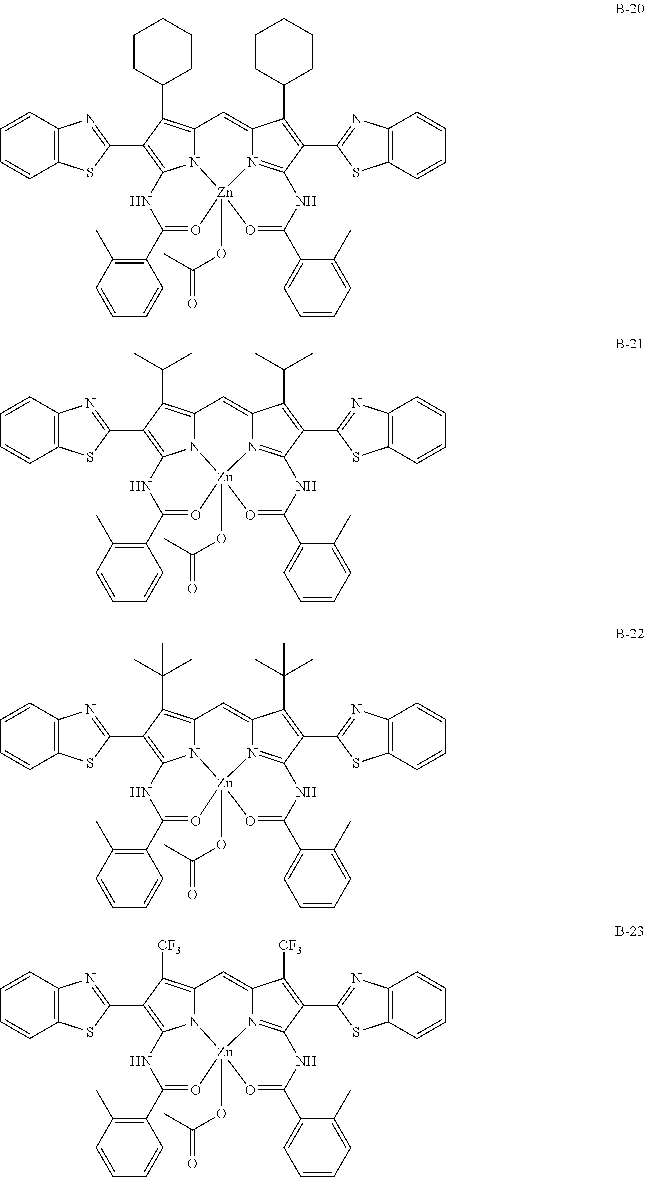

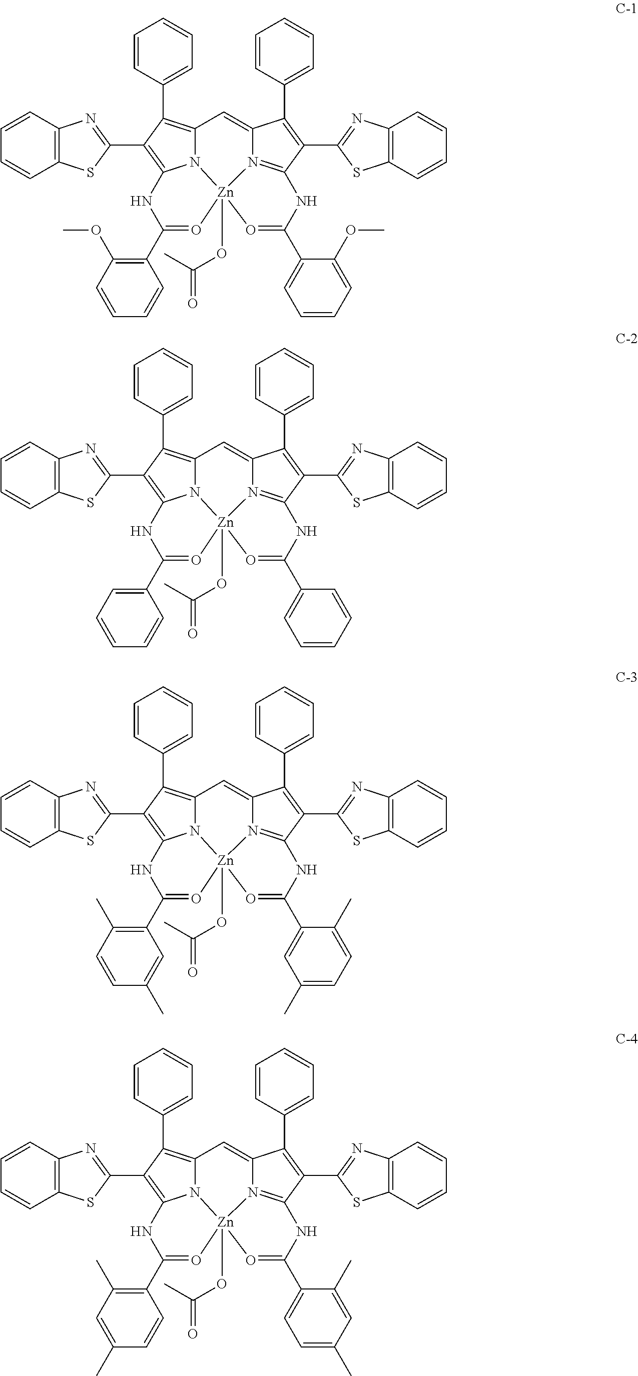

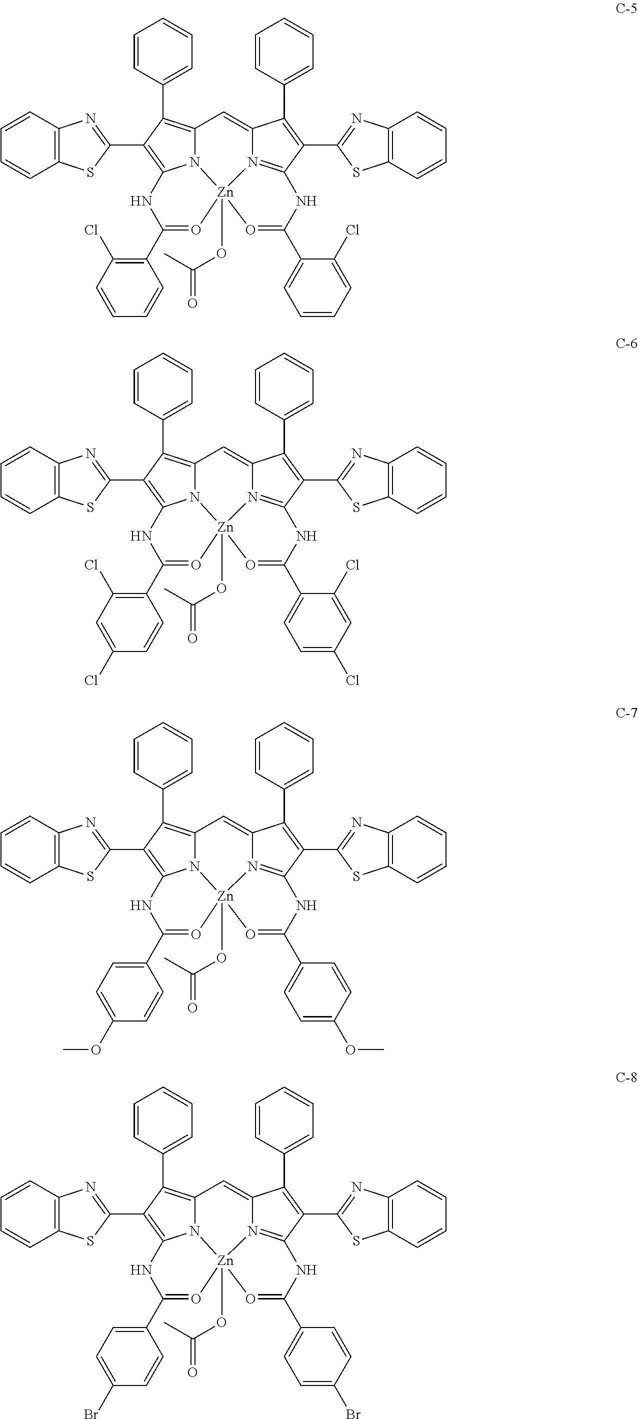

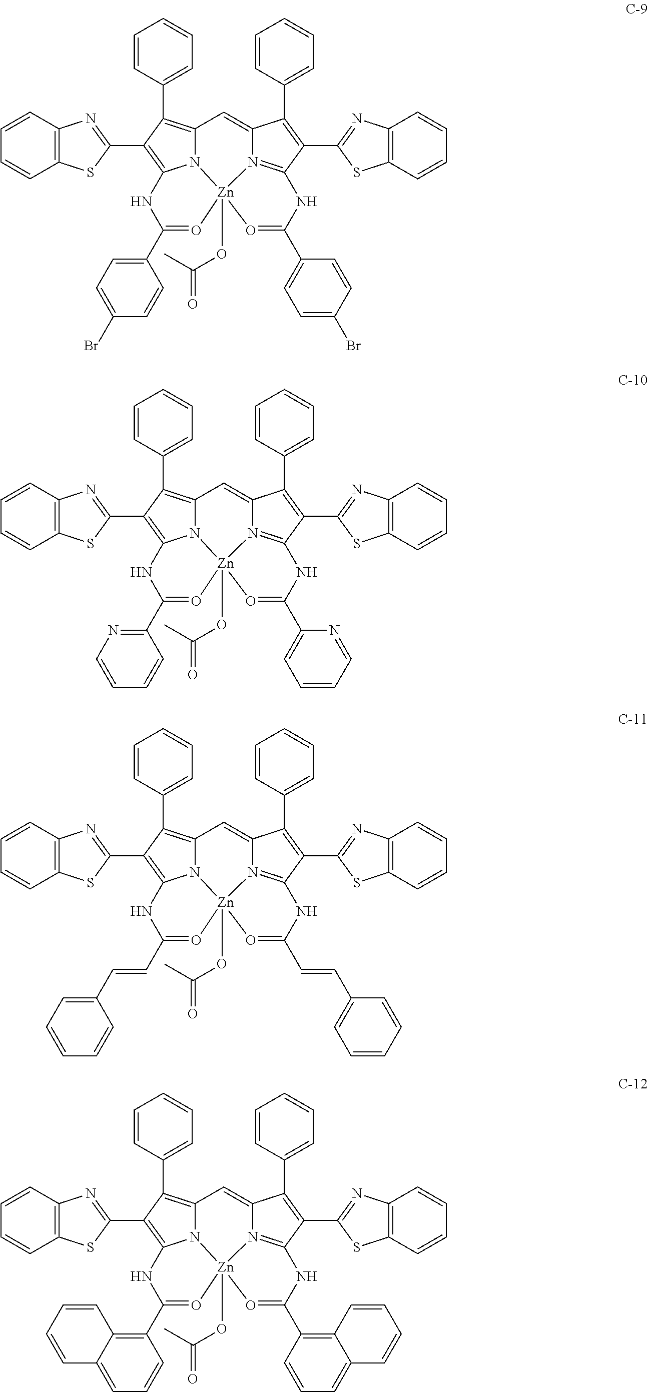

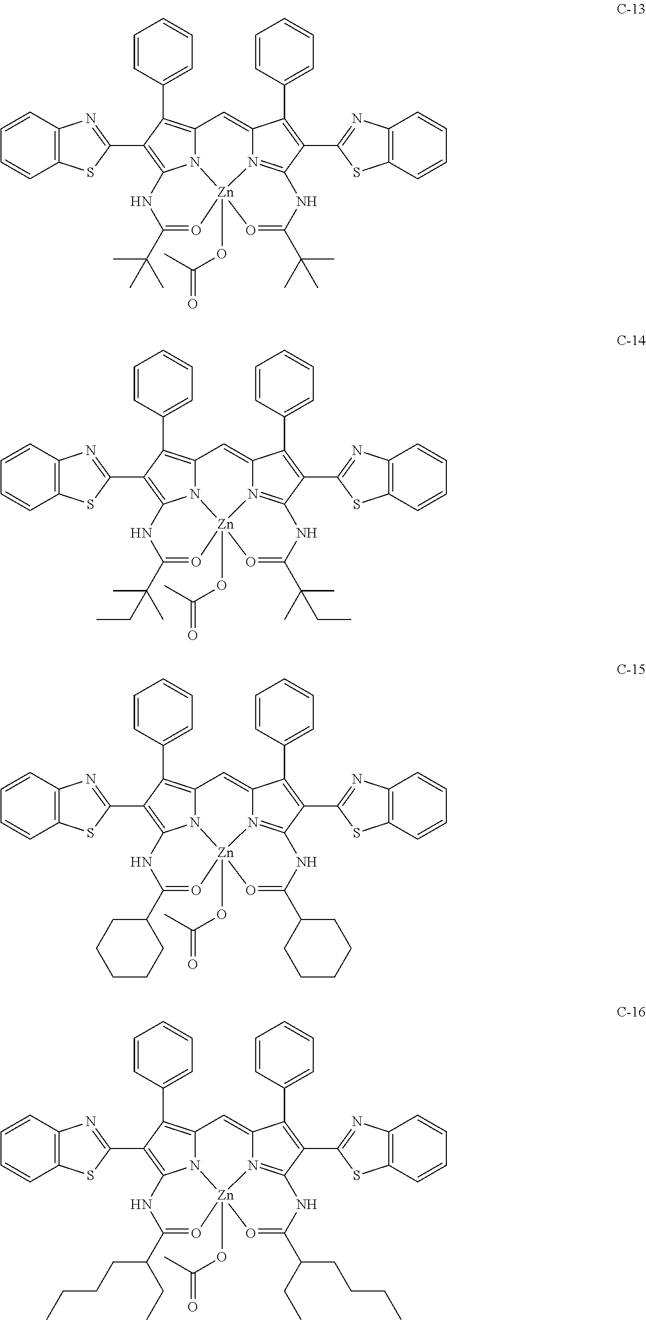

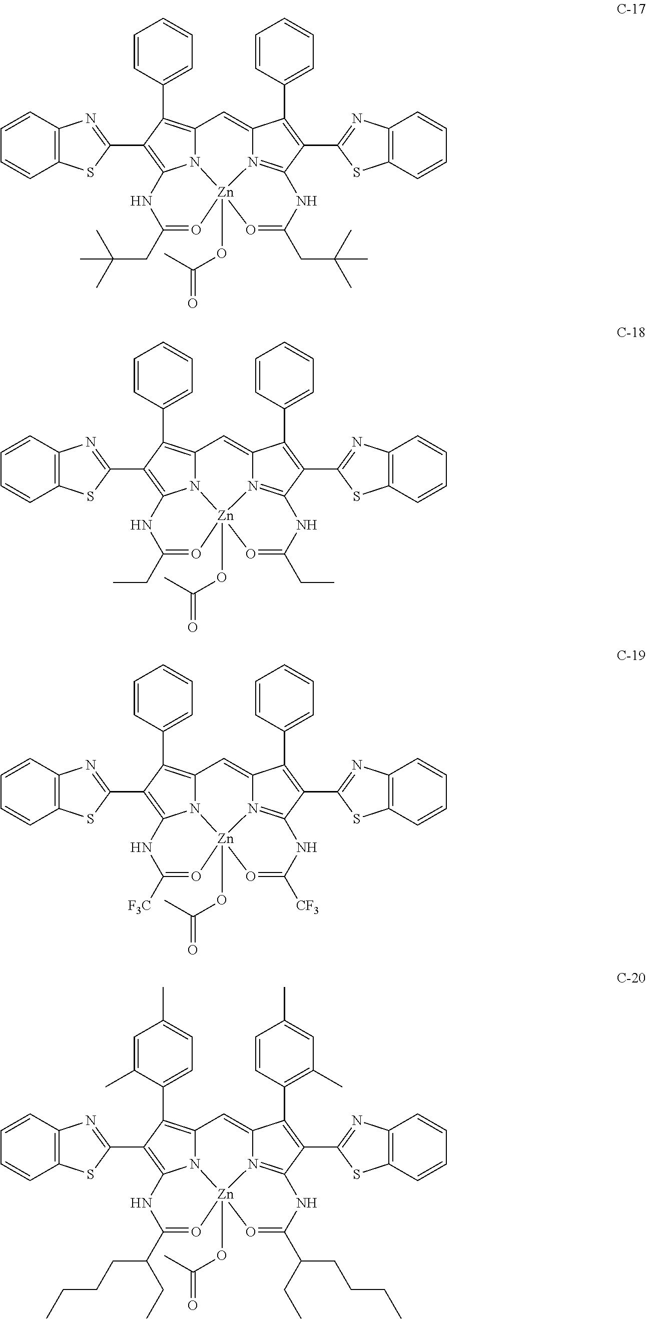

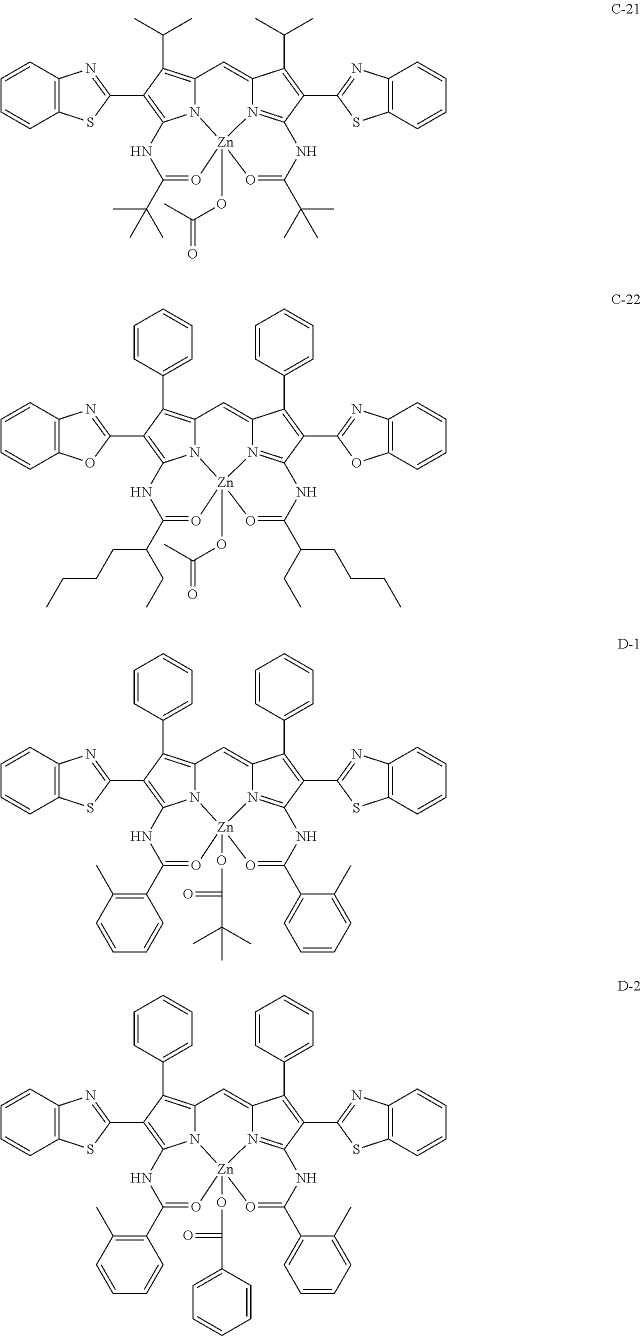

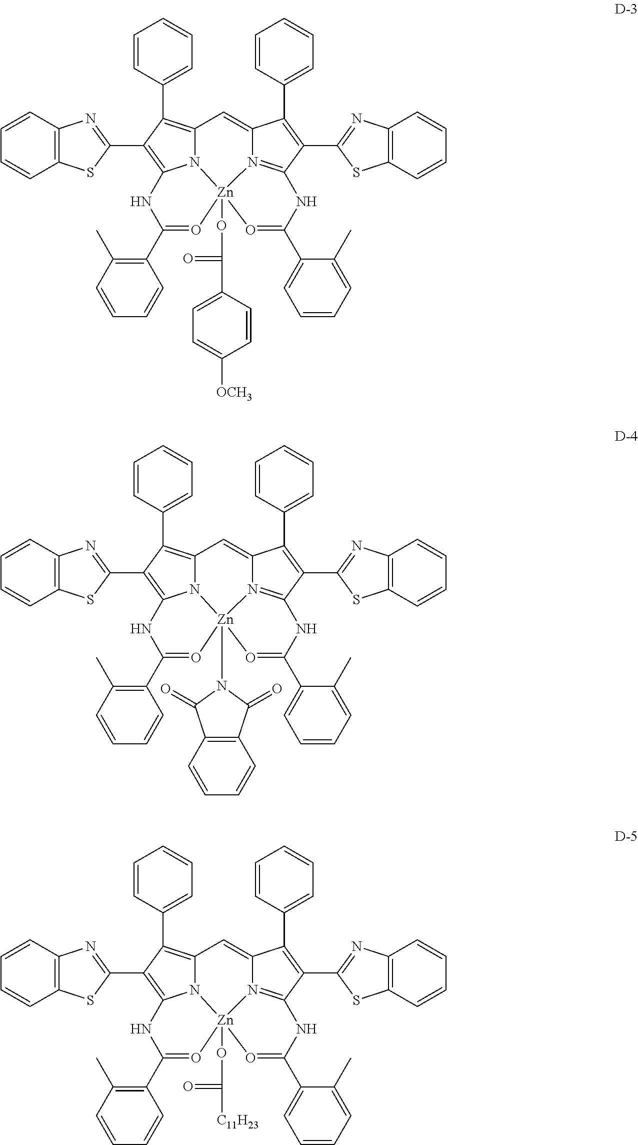

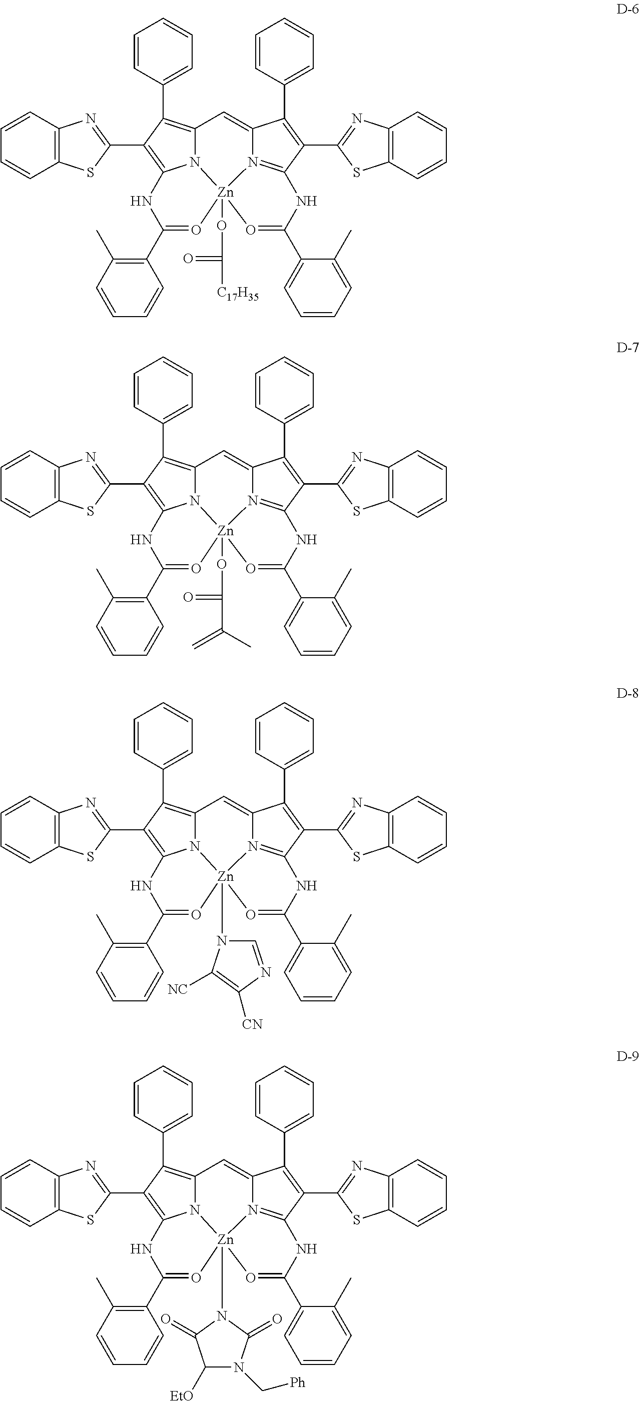

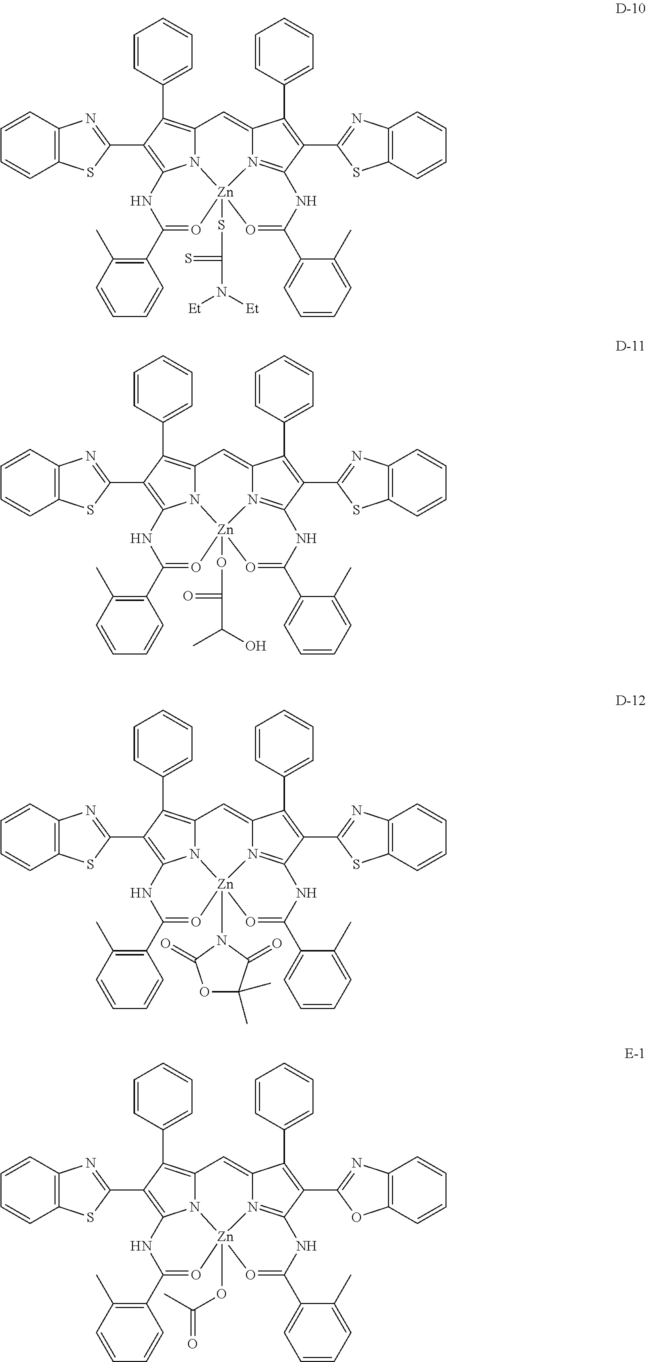

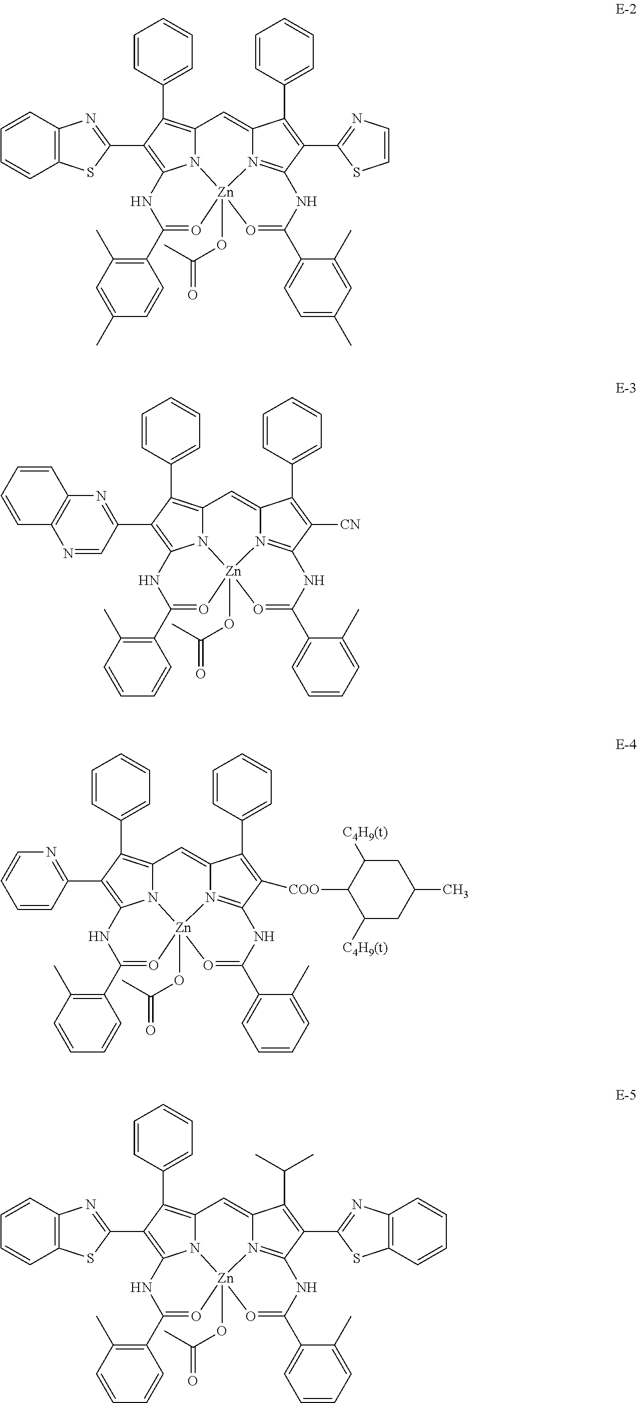

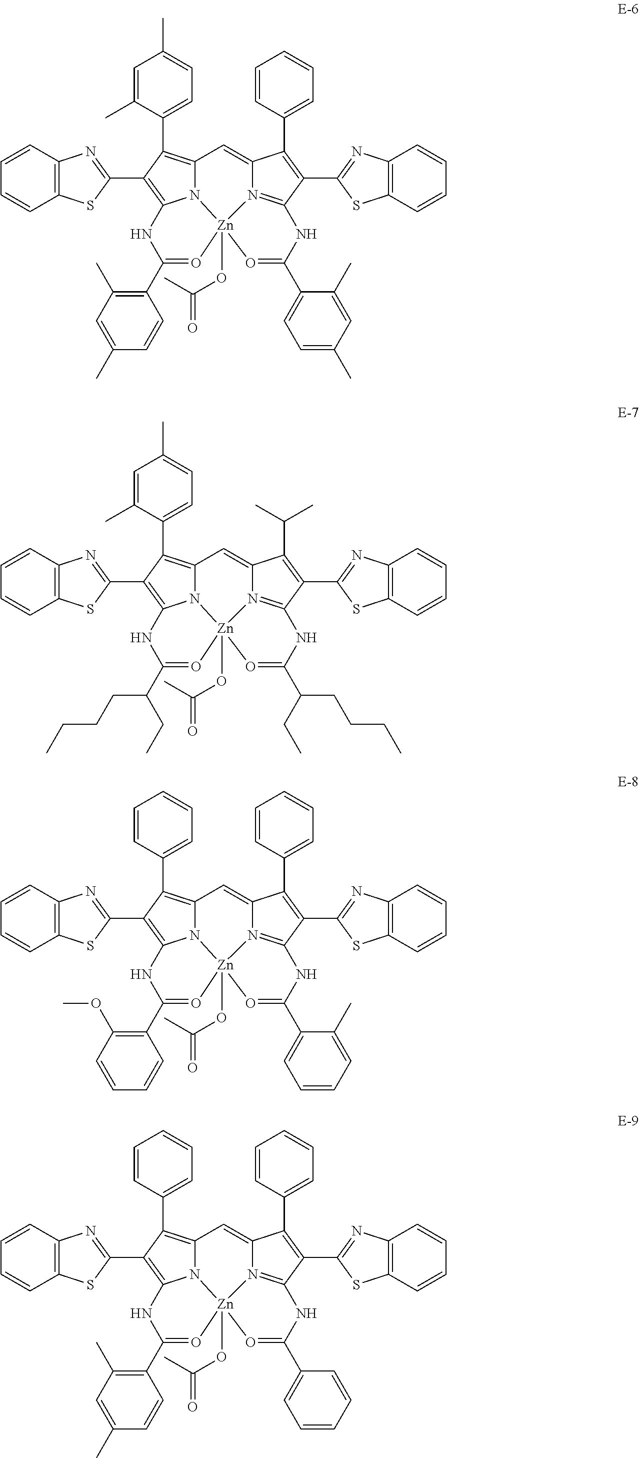

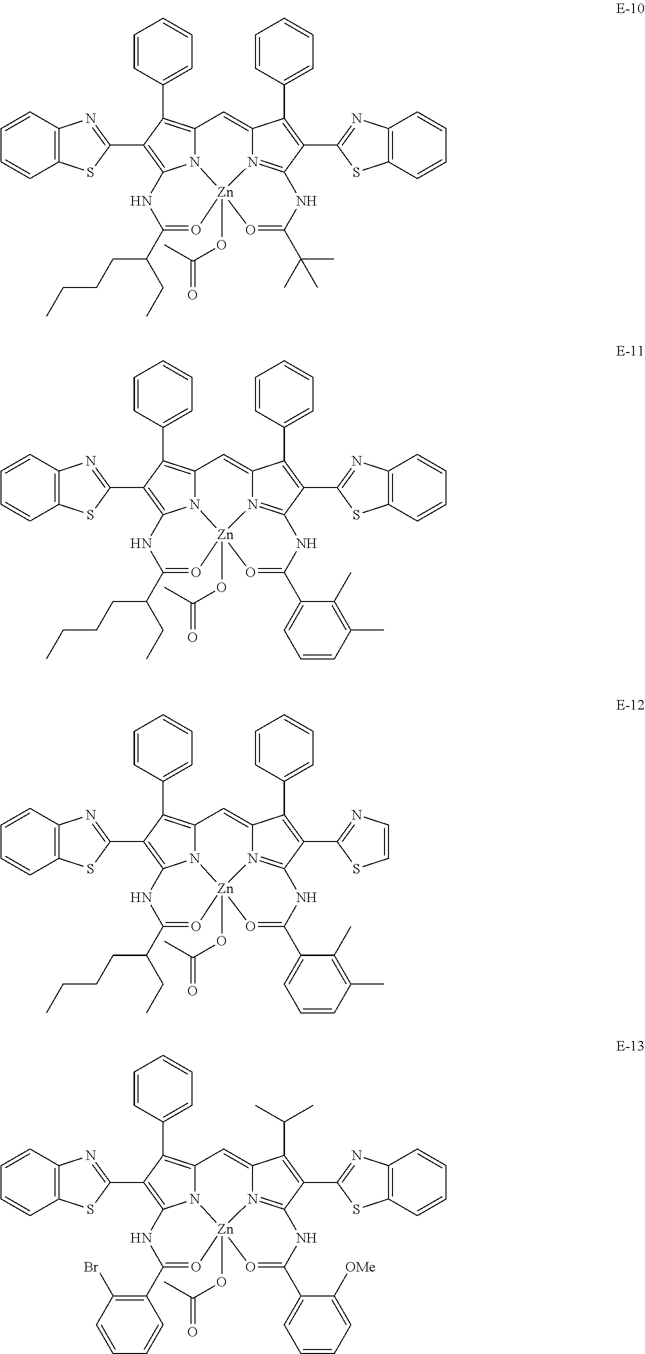

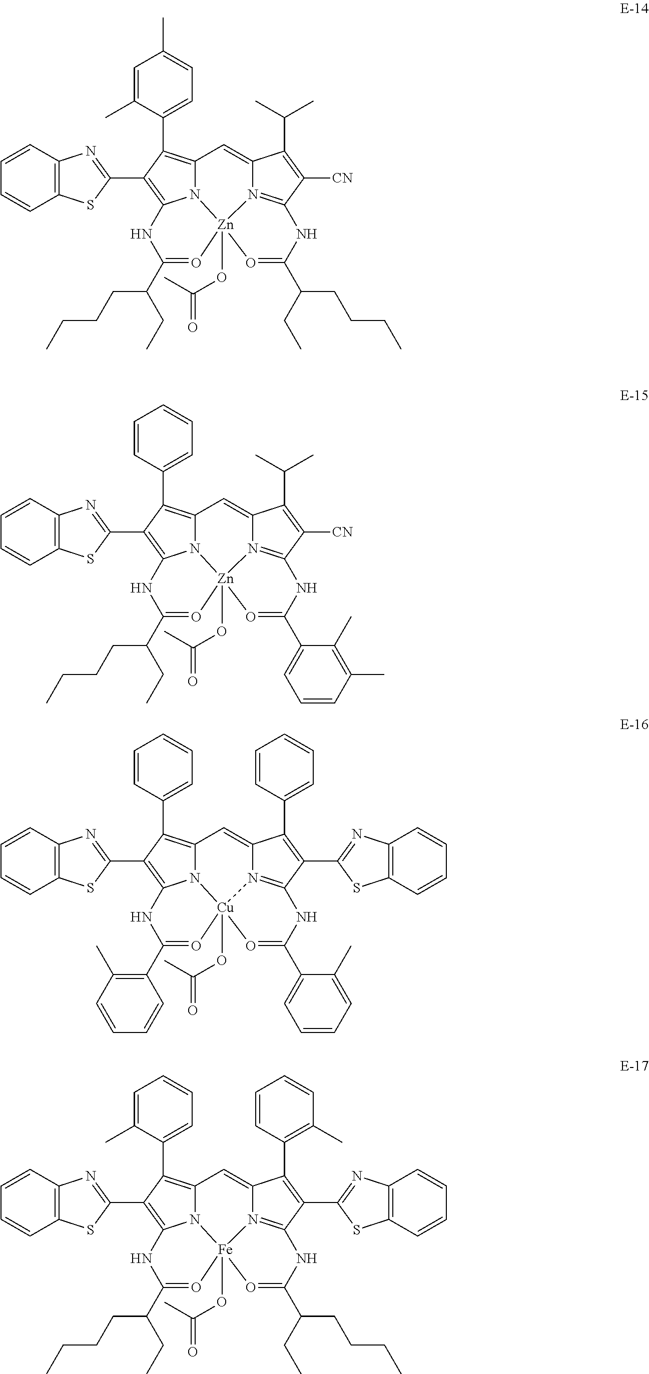

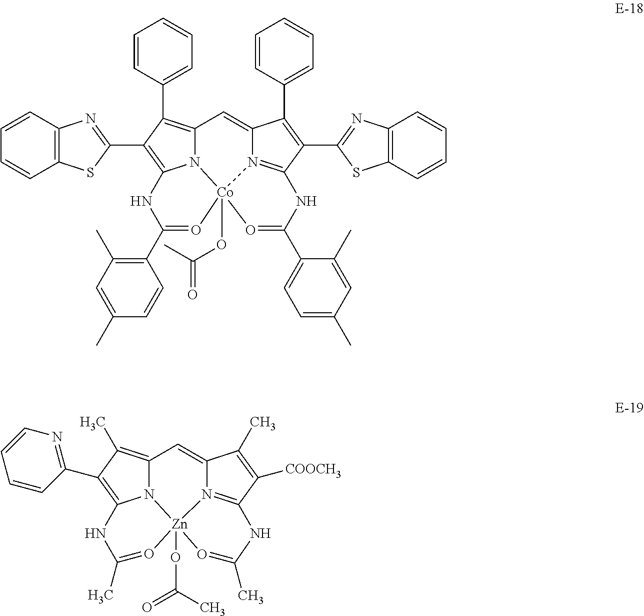

The particular metal complex compound can be synthesized by the methods described in U.S. Pat. Nos. 4,774,339 and 5,433,896; JP-A Nos. 2001-240761, 2002-155052, and 2008-0076044; Japanese Patent No. 3614586; Aust. J. Chem., 1965, 11, 1835-1845; J. H. Boger et al, Heteroatom Chemistry, Vol. 1, No. 5, 389 (1990), and the like.

Furthermore, according to a different method, the particular metal complex compound applied to the colored composition of the invention can also be obtained from a dipyrromethene compound represented by the following formula and a metal or a metal compound.

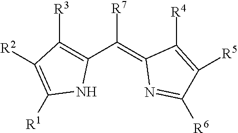

wherein R¹ to R⁶ each independently represent a hydrogen atom or a monovalent substituent, provided that at least one of R² or R⁵ represents a heteroaryl group; and R⁷ represents a hydrogen atom, a halogen atom, an alkyl group, an aryl group, or a heterocyclic group.

Meanwhile, in the above formula, R² to R⁵ and R⁷ have the same definitions, the same preferable definitions, and the like as R² to R⁵ and R⁷ described in the above formula (I), respectively.

Furthermore, R¹ and R⁶ each represent a hydrogen atom or a monovalent substituent. The monovalent substituent has the same definition, the same preferable definition, and the like as the monovalent substituent for R² to R⁵ described in connection with the formula (I).

The metal or metal compound has the same definition, the same preferable definition, and the like as Ma described in the above formula (I).

There are no particular limitations on the method for obtaining the particular metal complex compound applied to the colored composition of the invention from a dipyrromethene compound represented by the formula described above and a metal or a metal compound, and any known method can be used. For example, the compound can be synthesized by the methods described in U.S. Pat. Nos. 4,774,339 and 5,433,896; JP-A Nos. 2001-240761, 2002-155052 and 2008-0076044; Japanese Patent No. 3614586; Aust. J. Chem., 1965, 11, 1835-1845; J. H. Boger et al, Heteroatom Chemistry, Vol. 1, No. 5, 389 (1990), and the like.

The colored composition of the invention may contain one kind of the particular metal complex compound alone, and two or more kinds may be used in combination.

The content of the particular metal complex compound in the colored composition may vary depending on the molecular weight and the extinction coefficient, but the content is preferably 1% by mass to 70% by mass, and more preferably 10% by mass to 50% by mass, relative to the total solid content of the colored composition. Meanwhile, when the content is 10% by mass or more, a more satisfactory color density (for example, a color density suitable for liquid crystal display) is obtained, and when the content is 50% by mass or less, it is more preferable from the viewpoint that patterning of the pixels is achieved more satisfactorily.

In the colored composition of the invention, a dye having another structure or a pigment may also be used in addition to the particular metal complex compound, to the extent that the effect of the invention is not impaired.

(Dye Having Other Structure)

In the colored composition of the invention, a dye having a structure other than that of the particular metal complex compound (hereinafter, also referred to as “other dye”) can be used. There are no particular limitations on the dye having another structure, and any known dye can be used. Examples include coloring materials described in JP-A Nos. S64-90403, S64-91102, H01-94301, and H06-11614; Japanese Patent No. 2592207, U.S. Pat. Nos. 4,808,501, 5,667,920, and 5,059,500; JP-A Nos. H05-333207, H06-35183, H06-51115, H06-194828, H08-211599, H04-249549, H10-123316, H11-302283, H07-286107, 2001-4823, H08-15522, H08-29771, H08-146215, H11-343437, H08-62416, 2002-14220, 2002-14221, 2002-14222, 2002-14223, H08-302224, H08-73758, H08-179120, H08-151531, and H06-230210.

Examples of the chemical structure of the other dye include pyrazole azo-based dyes, anilino azo-based dyes, triphenylmethane-based dyes, anthraquinone-based dyes, anthrapyridone-based dyes, benzylidene-based dyes, oxonol-based dyes, pyrazolotriazole azo-based dyes, pyridone azo-based dyes, cyanine-based dyes, phenothiazine-based dyes, pyrrolopyrazole azomethine-based dyes, xanthenes-based dyes, squarylium-based dyes, phthalocyanine-based dyes, benzopyran-based dyes, and indigo-based dyes. Among them, xanthenes-based dyes or squarylium-based dyes are preferred from the viewpoint of hue.

The colored composition of the invention may contain one kind of the other dye alone, or two or more kinds of dyes may be used in combination.

The total content of all the dyes of the particular metal complex compound and the other dyes in the colored composition is preferably 1% by mass to 70% by mass, and more preferably 10% by mass to 50% by mass, relative to the total solid content of the colored composition. When the content of all the dyes is 10% by mass or more, a satisfactory color density (for example, a color density suitable for liquid crystal display) is obtained, and when the content is 50% by mass or less, it is advantageous in that patterning of the pixels is achieved satisfactorily.

(Pigment)

In the colored composition of the invention, a pigment can be used in combination with the particular metal complex compound mentioned above.

Regarding the pigment, a pigment having an average primary particle size of from 10 nm to 30 nm is preferred. When the average primary particle size is in this range, a colored composition having excellent hue and contrast is obtained.

Meanwhile, unless particularly stated otherwise, the average primary particle size as used in the present specification represents the volume average primary particle size, and can be measured by a dynamic light scattering method (Microtrac Nanotrac UPA-EX150 (manufactured by Nikkiso Co., Ltd.)) or the like.

Regarding the pigment, various inorganic pigments or organic pigments that are conventionally known can be used, but it is preferable to use an organic pigment from the viewpoint of reliability. Examples of the organic pigment that can be additionally used in the invention include the organic pigments described in paragraph [0093] of JP-A No. 2009-256572.

Furthermore, particularly C.I. Pigment Red 177, 224, 242, 254, 255, 264; C.I. Pigment Yellow 138, 139, 150, 180, 185; C.I. Pigment Orange 36, 38, 71; C.I. Pigment Green 7, 36, 58; C.I. Pigment Blue 15:6; and C.I. Pigment Violet 23 are suitable from the viewpoint of color reproducibility, but the invention is not intended to be limited to these. These organic pigments can be used singly, or in various combinations in order to increase color purity.

When a pigment is used, the content thereof in the colored composition of the invention is preferably 1% by mass to 55% by mass, and more preferably 5% by mass to 45% by mass, relative to the total solid content of the colored composition. When the content of the pigment is in the range described above, it is effective for securing excellent color characteristics.

—Pigment Dispersant—

The colored composition of the invention can contain, in the case in which the colored composition contains a pigment together with the particular metal complex compound, a pigment dispersant.

Examples of the pigment dispersant that can be used in the invention include polymeric dispersants [for example, polyamidoamine and salts thereof, polycarboxylic acids and salts thereof, high molecular weight unsaturated acid esters, modified polyurethanes, modified polyesters, modified poly(meth)acrylates, (meth)acrylic copolymers, and naphthalenesulfonic acid-formalin condensates], surfactants such as polyoxyethylene alkyl phosphoric acid esters, polyoxyethylene alkylamines, and alkanolamines, and pigment derivatives.

The polymeric dispersants can be further classified, in view of the structure, into linear polymers, terminal-modified type polymers, graft type polymers, and block type polymers.

Examples of the terminal-modified type polymers having anchor sites to the pigment surface include the polymers having phosphoric acid groups at the terminals as described in JP-A No. H03-112992, Japanese Patent Application National Publication (Laid-Open) No. 2003-533455, and the like; polymers having sulfonic acid groups at the terminals as described in JP-A No. 2002-273191 and the like; and polymers having partial skeletons of organic dyes or heterocyclic rings as described in JP-A No. H09-77994, and the like. Furthermore, polymers in which two or more anchor sites (acid groups, basic groups, partial skeletons of organic dyes, or heterocyclic rings) to the pigment surface have been introduced at the polymer ends as described in JP-A No. 2007-277514 are also preferable due to their excellent dispersion stability.

Examples of the graft type polymers having anchor sites to the pigment surface include polyester-based dispersants, and specific examples include reaction products of poly(lower alkyleneimines) and polyesters as described in JP-A No. S54-37082, Japanese Patent Application National Publication (Laid-Open) No. H08-507960, JP-A No. 2009-258668, and the like; reaction products of polyallylamines and polyesters as described in JP-A No. H09-169821 and the like; copolymers of macromonomers and nitrogen atom monomers as described in JP-A Nos. H10-339949 and 2004-37986, and the like; graft type polymers having partial skeletons of organic dyes or heterocyclic rings as described in JP-A Nos. 2003-238837, 2008-9426 and 2008-81732, and the like; and copolymers of macromonomers and acid group-containing monomers as described in JP-A No. 2010-106268, and the like. Particularly, the amphoteric dispersing resins having basic groups and acid groups as described in JP-A No. 2009-203462 are particularly preferred from the viewpoints of the dispersibility and dispersion stability of the pigment dispersions, and the developability exhibited by a colored composition using the pigment dispersion.

Regarding the macromonomers that are used when graft type polymers having anchor sites to the pigment surface are produced by radical polymerization, any known macromonomers can be used, and examples include macromonomers AA-6 (polymethyl methacrylate having a methacryloyl group as a terminal group), AS-6 (polystyrene having a methacryloyl group as a terminal group), AN-6S (copolymer of styrene and acrylonitrile having a methacryloyl group as a terminal group), and AB-6 (polybutyl acrylate having a methacryloyl group as a terminal group), all manufactured by Toagosei Co., Ltd.; PLACCEL FM5 (adduct of 5 mol equivalents of ε-caprolactone to 2-hydroxyethyl methacrylate) and FA10L (adduct of 10 mol equivalents of ε-caprolactone to 2-hydroxyethyl acrylate) manufactured by Daicel Corp.; and polyester-based macromonomers described in JP-A No. H02-272009. Among these, particularly polyester-based macromonomers having excellent flexibility and solvophilicity are particularly preferred from the viewpoints of the dispersibility and dispersion stability of the pigment dispersion, and the developability exhibited by a colored composition using the pigment dispersion, and the polyester-based macromonomers described in JP-A No. H02-272009 are most preferred.

Regarding the block type polymers having anchor sites to the pigment surface, the block type polymers described in JP-A Nos. 2003-49110 and 2009-52010, and the like are preferable.

The pigment dispersants that can be used in the invention are also available as commercially marketed products, and specific examples thereof include “DA-7301” manufactured by Kusumoto Chemicals, Ltd.; “DISPERBYK-101 (polyamidoamine phosphate), 107 (carboxylic acid ester), 110 (copolymer containing acid groups), 130 (polyamide), 161, 162, 163, 164, 165, 166 and 170 (high molecular weight copolymers)”, “BYK-P104 and P105 (high molecular weight unsaturated polycarboxylic acids)” manufactured by BYK Chemie GmbH; “EFKA 4047, 4050 to 4010 to 4165 (polyurethanes), EFKA 4330 to 4340 (block copolymers), 4400 to 4402 (modified polyacrylates), 5010 (polyester amide), 5765 (high molecular weight polycarboxylate), 6220 (fatty acid polyester), 6745 (phthalocyanine derivative), and 6750 (azo pigment derivative)” manufactured by BASF Corp.; “AJISPER PB821, PB822, PB880 and PB881” manufactured by Ajinomoto Fine-Techno Co., Inc.; “FLOWLEN TG-710 (urethane oligomer)” “POLYFLOW No. 50E, No. 300 (acrylic copolymers)” manufactured by Kyoeisha Chemical Co., Ltd.; “DISPARLON KS-860, 873SN, 874, and #2150 (aliphatic polyvalent carboxylic acids), #7004 (polyether ester), DA-703-50, DA-705, and DA-725” manufactured by Kusumoto Chemicals, Ltd.; “DEMOL RN and N (naphthalenesulfonic acid-formalin polycondensate), MS, C and SN-B (aromatic sulfonic acid-formalin polycondensates)”, “HOMOGENOL L-18 (high molecular weight polycarboxylic acid)”, “EMULGEN 920, 930, 935 and 985 (polyoxyethylene nonyl phenyl ether)”, “ACETAMIN 86 (stearylamine acetate)” manufactured by Kao Corp.; “SOLSPERSE 5000 (phthalocyanine derivative), 22000 (azo pigment derivative), 13240 (polyester amine), 3000, 17000 and 27000 (polymers having functional moieties at the ends), 24000, 28000, 32000 and 38500 (graft type polymers)” manufactured by Lubrizol Japan, Ltd.; “NIKKOL T106 (polyoxyethylene sorbitan monooleate), MYS-IEX (polyoxyethylene monostearate)” manufactured by Nikko Chemicals, Co., Ltd.; HINOACT T-8000E manufactured by Kawaken Fine Chemicals Co., Ltd.; organosiloxane polymer KP341 manufactured by Shin-Etsu Chemical Co., Ltd.; “W001: cationic surfactant”, nonionic surfactants such as polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, and sorbitan fatty acid esters, and anionic surfactants such as “W004, W005 and W017”, all manufactured by Yusho Co., Ltd.; polymeric dispersants such as “EFKA-46, EFKA-47, EFKA-47 EA, EFKA POLYMER 100, EFKA POLYMER 400, EFKA POLYMER 401, and EFKA POLYMER 450” manufactured by Morishita Sangyo Co., Ltd., and “DISPERSE AID 6, DISPERSE AID 8, DISPERSE AID 15, and DISPERSE AID 9100” manufactured by San Nopco, Ltd.; “ADEKA PLURONIC L31, F38, L42, L44, L61, L64, F68, L72, P95, F77, P84, F87, P94, L101, P103, F108, L121, and P-123 manufactured by Adeka Corp.; and “IONET (trade name) S-20” manufactured by Sanyo Chemical Industries, Ltd.

These pigment dispersants may be used singly, or two or more kinds may be used in combination. In the invention, it is particularly preferable to use a pigment derivative and a polymeric dispersant in combination. Furthermore, regarding the pigment dispersant of the invention, the terminal-modified type polymer having anchor sites to the pigment surface, the graft type polymer or the block type polymer may be used in combination with an alkali-soluble resin. Examples of the alkali-soluble resin include (meth)acrylic acid copolymers, itaconic acid copolymers, crotonic acid copolymers, maleic acid copolymers, partially esterified maleic acid copolymers, acidic cellulose derivatives having carboxylic acids in side chains, and resins prepared by modifying a polymer having hydroxyl groups with an acid anhydride. However, (meth)acrylic acid copolymers are particularly preferred. Furthermore, the N-substituted maleimide monomer copolymers described in JP-A No. H10-300922, the ether dimer copolymers described in JP-A No. 2004-300204, and the alkali-soluble resins containing polymerizable groups described in JP-A No. H07-319161 are also preferable.

The content of the pigment dispersant in the colored composition is preferably 1 part by mass to 80 parts by mass, more preferably 5 parts by mass to 70 parts by mass, and even more preferably 10 parts by mass to 60 parts by mass, relative to 100 parts by mass of the pigment.

Specifically, when a polymeric dispersant is used, the amount of use thereof is preferably in the range of 5 parts by mass to 100 parts by mass, and more preferably in the range of 10 parts by mass to 80 parts by mass, relative to 100 parts by mass of the pigment.

Furthermore, when a pigment derivative is additionally used, the amount of use of the pigment derivative is, on a mass basis, preferably in the range of 1 part to 30 parts, more preferably in the range of 3 parts to 20 parts, and particularly preferably in the range of 5 parts to 15 parts, relative to 100 parts by mass of the pigment.

In regard to the colored composition, when a pigment is additionally used as a colorant, and a pigment dispersant is used as well, from the viewpoints of curing sensitivity and color density, the sum of the contents of the pigment agent and the pigment dispersant is preferably from 50% by mass to 90% by mass, more preferably 55% by mass to 85% by mass, and even more preferably 60% by mass to 80% by mass, relative to the total solid content of the colored composition.

<Other Components>

The colored composition of the invention may further contain other components that will be described below, to the extent that the effect of the invention is not impaired.

(Polymerizable Compound)

The colored composition of the invention preferably contains at least one polymerizable compound. The polymerizable compound is, for example, a polymerizable compound having at least one ethylenically unsaturated double bond, and can be selected for use from those components constituting known compositions. Examples include the components described in paragraphs [0010] to [0020] of JP-A No. 2006-23696, and the components described in paragraphs [0027] to [0053] of JP-A No. 2006-64921.

Furthermore, urethane addition polymerizable compounds that are produced using an addition reaction between an isocyanate and a hydroxyl group are also suitable, and the urethane acrylates described in JP-A No. S51-37193, and Japanese Patent Application Publication (JP-B) Nos. H02-32293 and H02-16765; and the urethane compounds having an ethylene oxide skeleton described in JP-B Nos. S58-49860, S56-17654, S62-39417, and S62-39418 are also suitable.

Other examples include polyfunctional acrylates or methacrylates, such as the polyester acrylates described in JP-A No. S48-64183, and JP-B Nos. S49-43191 and S52-30490, and epoxy acrylates obtained by allowing epoxy resins to react with (meth)acrylic acid. Furthermore, those introduced as photocurable monomers and oligomers in Journal of Adhesion Society of Japan, Vol. 20, No. 7, p. 300-308 (1984).

Specific examples thereof include pentaerythritol tri(meth)acrylate, pentaerythritol tetra(meth)acrylate, dipentaerythritol penta(meth)acrylate, dipentaerythritol hexa(meth)acrylate, tri((meth)acryloyloxyethyl) isocyanurate, pentaerythritol tetra(meth)acrylate EO-modification products, and dipentaerythritol hexa(meth)acrylate EO-modification products. Preferred examples of commercially available products include NK ESTER A-TMMT, NK ESTER A-TMM-3, NK OLIGO UA-32P, NK OLIGO UA-7200 (all manufactured by Shin Nakamura Chemical Co., Ltd.); ARONIX M-305, ARONIX M-306, ARONIX M-309, ARONIX M-450, ARONIX M-402, TO-1382 (all manufactured by Toagosei Co., Ltd.), V#802 (manufactured by Osaka Organic Chemical Industry, Ltd.), KAYARAD D-330, KAYARAD D-320, KAYARAD D-310, and KAYARAD DPHA (all manufactured by Nippon Kayaku Co., Ltd.).

These polymerizable compounds can be used singly, or two or more kinds can be used in combination.

The content (in the case of two or more kinds, the total content) of the polymerizable compound in the total solid content of the colored composition is preferably 10% by mass to 80% by mass, more preferably 15% by mass to 75% by mass, and particularly preferably 20% by mass to 60% by mass.

(Photopolymerization Initiator)

It is preferable that the colored composition of the invention contain at least one photopolymerization initiator. The photopolymerization initiator is not particularly limited as long as it is capable of polymerizing the polymerizable compound, and is preferably selected from the viewpoints of characteristics, initiation efficiency, absorption wavelength, availability, cost, and the like.

The photopolymerization initiator is a compound which is photosensitive to exposure light and initiates and accelerates the polymerization of a polymerizable compound. A compound which is sensitive to actinic light having a wavelength of 300 nm or longer and initiates and accelerates the polymerization of a polymerizable compound, is preferred. Also, a photopolymerization initiator which is not directly sensitive to actinic light having a wavelength of 300 nm or longer can also be preferably used in combination with a sensitizer.

Specific examples include an oxime ester compound, an organic halogenated compound, an oxydiazole compound, a carbonyl compound, a ketal compound, a benzoin compound, an acridine compound, an organic peroxide, an azo compound, a coumarin compound, an azide compound, a metallocene compound, a hexaarylbiimidazole compound, an organic boric acid compound, a disulfonic acid compound, an onium salt compound, an acylphosphine (oxide), a benzophenone compound, an acetophenone compound, and derivatives thereof.

Among these, from the viewpoint of sensitivity, a benzophenone compound, an oxime ester compound, and a hexaarylbiimidazole compound are preferred.

Examples of the benzophenone compound include benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonylbenzophenone, benzophenonetetracarboxylic acid or tetramethyl ester thereof, 4,4′-bis(dialkylamino)benzophenones (for example, 4,4′-bis(dimethylamino)benzophenone, 4,4′-bis(dicyclohexylamino)benzophenone, 4,4′-bis(diethylamino)benzophenone, 4,4′-bis(dihydroxyethylamino)benzophenone, 4-methoxy-4′-dimethylaminobenzophenone, 4,4′-dimethoxybenzophenone, 4-dimethylaminobenzophenone, and 4-dimethylaminoacetophenone. However, from the viewpoint of sensitivity, 4,4′-bis(diethylamino)benzophenone is preferred.

Regarding the oxime ester compound, the compounds described in JP-A Nos. 2000-80068 and 2001-233842, Japanese Patent Application National Publication (Laid-Open) No. 2004-534797, WO 2005/080337, WO 2006/018973, JP-A Nos. 2007-210991, 2007-231000, 2007-269779 and 2009-191061, and WO 2009/131189 can be used.

Specific examples include
2-(O-benzoyloxime)-1-[4-(phenylthio)phenyl]-1,2-butanedione,
2-(O-benzoyloxime)-1-[4-(phenylthio)phenyl]-1,2-pentanedione,
2-(O-benzoyloxime)-1-[4-(phenylthio)phenyl]-1,2-hexanedione,
2-(O-benzoyloxime)-1-[4-(phenylthio)phenyl]-1,2-heptanedione,
2-(O-benzoyloxime)-1-[4-(phenylthio)phenyl]-1,2-octanedione,
2-(O-benzoyloxime)-1-[4-(methylphenylthio)phenyl]-1,2-butanedione,
2-(O-benzoyloxime)-1-[4-(ethylphenylthio)phenyl]-1,2-butanedione,
2-(O-benzoyloxime)-1-[4-(butylphenylthio)phenyl]-1,2-butanedione,
1-(O-acetyloxime)-1-[9-ethyl-6-(2-methylbenzoyl)-9H-carbazol-3-yl]ethanone,
1-(O-acetyloxime)-1-[9-methyl-6-(2-methylbenzoyl)-9H-carbazol-3-yl]ethanone,
1-(O-acetyloxime)-1-[9-propyl-6-(2-methylbenzoyl)-9H-carbazol-3-yl]ethanone,
1-(O-acetyloxime)-1-[9-ethyl-6-(2-ethylbenzoyl)-9H-carbazol-3-yl]ethanone,
1-(O-acetyloxime)-1-[9-ethyl-6-(2-butylbenzoyl)-9H-carbazol-3-yl]ethanone,
2-(benzoyloxyimino)-1-[4-(phenylthio)phenyl]-1-octanone, and
2-(acetoxyimino)-4-(4-chlorophenylthio)-1-[9-ethyl-6-(2-methylbenzoyl)-9H-carbazol-3-yl]-1-butanone. However, the examples are not limited to these.

Furthermore, in regard to the invention, from the viewpoints of sensitivity, stability over time, and coloration at the time of post-heating, a compound represented by the following formula (1) is also suitable as the oxime-based compound.

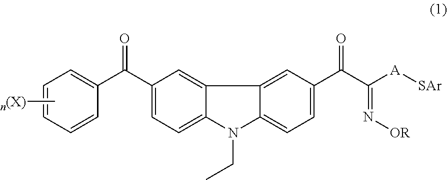

In the above formula (1), R and X each independently represent a monovalent substituent; A represents a divalent organic group; Ar represents an aryl group; and n represents an integer from 0 to 5.

In formula (1), R is preferably an acyl group from the viewpoint of acquiring high sensitivity, and specifically, an acetyl group, a propionyl group, a benzoyl group, and a toluoyl group are preferred.

In formula (1), from the viewpoint of increasing sensitivity and suppressing coloration caused by passage of the heating time, A is preferably an unsubstituted alkylene group, an alkylene group substituted with an alkyl group (for example, a methyl group, an ethyl group, a tert-butyl group, or a dodecyl group), an alkylene group substituted with an alkenyl group (for example, a vinyl group or an allyl group), or an alkylene group substituted with an aryl group (for example, a phenyl group, a p-tolyl group, a xylyl group, an cumenyl group, a naphthyl group, an anthryl group, a phenanthryl group, or a styryl group).

In formula (1), Ar is preferably a substituted or unsubstituted phenyl group, from the viewpoint of increasing sensitivity and suppressing coloration caused by passage of the heating time. In the case of a substituted phenyl group, the substituent thereof is preferably, for example, a halogen group such as a fluorine atom, a chlorine atom, a bromine atom, or an iodine atom.

In formula (1), from the viewpoint of increasing the solvent solubility and the absorption efficiency in the longer wavelength region, X is preferably an alkyl group which may be substituted, an aryl group which may be substituted, an alkenyl group which may be substituted, an alkynyl group which may be substituted, an alkoxy group which may be substituted, an aryloxy group which may be substituted, an alkylthioxy group which may be substituted, an arylthioxy group which may be substituted, or an amino group which may be substituted.

n in formula (1) is preferably an integer of 1 or 2.

Examples of the organic halogenated compound include, specifically, the compounds described in Wakabayashi et al., “Bull. Chem. Soc. Japan”, 42, 2924 (1969); U.S. Pat. No. 3,905,815; JP-B No. S46-4605, JP-A Nos. S48-36281, S55-32070, S60-239736, S61-169835, S61-169837, S62-58241, S62-212401, S63-70243, and S63-298339; M. P. Hutt, “Journal of Heterocyclic Chemistry”, 1 (No. 3), (1970), and the like. Particularly, an oxazole compound and an s-triazine compound substituted with a trihalomethyl group may be used.

Examples of the hexaarylbiimidazole compound include, for example, various compounds described in JP-B No. H06-29285; U.S. Pat. Nos. 3,479,185, 4,311,783, and 4,622,286; and the like, and specific examples include
2,2′-bis(o-chlorophenyl)-4,4′,5,5′-tetraphenylbiimidazole,
2,2′-bis(o-bromophenyl)-4,4′,5,5′-tetraphenylbiimidazole,
2,2′-bis(o,p-dichlorophenyl)-4,4′,5,5′-tetraphenylbiimidazole,
2,2′-bis(o-chlorophenyl)-4,4′,5,5′-tetra(m-methoxyphenyl)biimidazole,
2,2′-bis(o,o′-dichlorophenyl)-4,4′,5,5′-tetraphenylbiimidazole,
2,2′-bis(o-nitrophenyl)-4,4′,5,5′-tetraphenylbiimidazole,
2,2′-bis(o-methylphenyl)-4,4′,5,5′-tetraphenylbiimidazole, and
2,2′-bis(o-trifluorophenyl)-4,4′,5,5′-tetraphenylbiimidazole.

The photopolymerization initiator can be used singly, or in combination of two or more kinds Also, in a case in which an initiator which does not have absorption at the exposure wavelength is used, it is necessary to use a sensitizer.

The total content of the photopolymerization initiator is preferably 0.5% by mass to 30% by mass, more preferably 2% by mass to 20% by mass, and most preferably 5% by mass to 18% by mass, relative to the total solid content in the colored composition. When the total content is in this range, high sensitivity is obtained at the time of light exposure, and also, satisfactory color characteristics are obtained.

(Alkali-Soluble Binder)

The alkali-soluble binder is not particularly limited as long as it exhibits alkali-solubility, and preferably, selection thereof can be made from the viewpoints of heat resistance, developability, and availability.

The alkali-soluble binder is preferably a linear organic high molecular weight polymer which is soluble in an organic solvent and is developable with an aqueous solution of weak alkali. Examples of such a linear organic high molecular weight polymer include polymers having carboxylic acids in side chains, for example, the methacrylic acid copolymers, acrylic acid copolymers, itaconic acid copolymers, crotonic acid copolymers, maleic acid copolymers, and partially esterified maleic acid copolymers described in JP-A No. S59-44615; JP-B Nos. S54-34327, S58-12577 and S54-25957; JP-A Nos. S59-53836 and S59-71048. Similarly, acidic cellulose derivatives having carboxylic acids in side chains are useful.

In addition to those mentioned above, regarding the alkali-soluble binder according to the invention, a product obtained by adding an acid anhydride to a polymer having hydroxyl groups, or a polyhydroxystyrene-based resin, a polysiloxane-based resin, poly(2-hydroxyethyl (meth)acrylate), polyvinylpyrrolidone, polyethylene oxide, polyvinyl alcohol, and the like are also useful. Furthermore, the linear organic high molecular weight polymer may also be a product obtained by copolymerizing hydrophilic monomers. Examples thereof include an alkoxyalkyl (meth)acrylate, a hydroxyalkyl (meth)acrylate, glycerol (meth)acrylate, (meth)acrylamide, N-methylolacrylamide, a secondary or tertiary alkylacrylamide, a dialkylaminoalkyl (meth)acrylate, morpholine (meth)acrylate, N-vinylpyrrolidone, N-vinylcaprolactam, vinylimidazole, vinyltriazole, methyl (meth)acrylate, ethyl (meth)acrylate, a branched or linear propyl (meth)acrylate, a branched or linear butyl (meth)acrylate, and phenoxyhydroxypropyl (meth)acrylate. In addition to those, examples of the hydrophilic monomers that are useful include monomers containing a tetrahydrofurfuryl group, a phosphoric acid group, a phosphoric acid ester group, a quaternary ammonium salt group, an ethyleneoxy chain, a propyleneoxy chain, a sulfonic acid group and a group derived from a salt thereof, and a morpholinoethyl group.

Furthermore, the alkali-soluble binder may have a polymerizable group in a side chain in order to increase the crosslinking efficiency, and for example, polymers containing an allyl group, a (meth)acryl group, an allyloxyalkyl group or the like in a side chain are also useful. Examples of the polymers containing the above-mentioned polymerizable groups include commercially available products such as DIANAL NR series (manufactured by Mitsubishi Rayon Co., Ltd.); PHOTOMER 6173 (COOH group-containing polyurethane acrylic oligomer, manufactured by Diamond Shamrock Co., Ltd.); VISCOAT R-264, KS RESIST 106 (all manufactured by Osaka Organic Chemical Industry, Ltd.); CYCLOMER P series, PLACCEL CF200 series (all manufactured by Daicel Corp.); and EBECRYL 3800 (manufactured by Daicel Cytec Co., Ltd.). Furthermore, in order to increase the strength of the cured coating films, alcohol-soluble nylon, polyether of 2,2-bis(4-hydroxyphenyl)propane and epichlorohydrin, and the like are also useful.

Among these various alkali-soluble binders, from the viewpoint of heat resistance, a polyhydroxystyrene resin, a polysiloxane-based resin, an acrylic resin, an acrylamide-based resin, and an acryl/acrylamide copolymer resin are preferred, and from the viewpoint of the control of developability, an acrylic resin, an acrylamide-based resin, and an acryl/acrylamide copolymer resin are preferred.

Preferred examples of the acrylic resin include copolymers formed from monomers selected from benzyl (meth)acrylate, (meth)acrylic acid, hydroxyethyl (meth)acrylate, (meth)acrylamide, and the like; and commercially available products such as DIANAL NR series (manufactured by Mitsubishi Rayon Co., Ltd.), KS RESIST-106 (manufactured by Osaka Organic Chemical Industry, Ltd.), CYCLOMER P series, and PLACCEL CF200 series (manufactured by Daicel Corp.).

From the viewpoints of developability, liquid viscosity and the like, the alkali-soluble binder is preferably a polymer having a weight average molecular weight (value measured by a GPC method and calculated relative to polystyrene standards) of 1000 to 2×10⁵, more preferably a polymer having a weight average molecular weight of 2000 to 1×10⁵, and particularly preferably a polymer having a weight average molecular weight of 5000 to 5×10⁴. The alkali-soluble binders can be used singly, or two or more kinds can be used in combination.

(Organic Solvent)

The colored composition of the invention can contain an organic solvent.

Basically, there are no particular limitations on the organic solvent as long as the solvent can satisfy the conditions of dissolvability of various components that co-exist, or coatability when the organic solvent is used in a colored composition, and particularly, it is preferable to select the organic solvent in consideration of dissolvability of solid components, coatability and safety.

Regarding the organic solvent, examples of esters include ethyl acetate, n-butyl acetate, isobutyl acetate, amyl formate, isoamyl acetate, isobutyl acetate, butyl propionate, isopropyl butyrate, ethyl butyrate, butyl butyrate, methyl lactate, ethyl lactate, oxyacetic acid alkyl esters (for example, methyl oxyacetate, ethyl oxyacetate, butyl oxyacetate (specifically, methyl methoxyacetate, ethyl methoxyacetate, butyl methoxyacetate, methyl ethoxyacetate, and ethyl ethoxyacetate)), 3-oxypropionic acid alkyl esters, 2-oxypropionic acid alkyl esters, methyl 2-oxy-2-methylpropionate, ethyl 2-oxy-2-methylpropionate, methyl pyruvate, ethyl pyruvate, propyl pyruvate, methyl acetoacetate, ethyl acetoacetate, methyl 2-oxobutanoate, and ethyl 2-oxobutanoate.

Furthermore, examples of ethers include diethylene glycol dimethyl ether, tetrahydrofuran, ethylene glycol monomethyl ether, ethylene glycol monoethyl ether, methyl cellosolve acetate, ethyl cellosolve acetate, diethylene glycol monomethyl ether, diethylene glycol monoethyl ether, diethylene glycol monobutyl ether, propylene glycol monomethyl ether, propylene glycol monomethyl ether acetate, propylene glycol monoethyl ether acetate, propylene glycol monopropyl ether acetate, methyl 3-ethoxypropionate, and ethyl 3-ethoxypropionate.

Examples of ketones include methyl ether ketone, cyclohexanone, 2-heptanone, and 3-heptanone.

Suitable examples of aromatic hydrocarbons include toluene and xylene.

Regarding these organic solvents, from the viewpoints of solubility of the various components described above, and in the case of containing an alkali-soluble binder, solubility thereof, improvement of the coated surface state, and the like, it is also preferable to mix two or more kinds In this case, the organic solvent is particularly preferably a mixed solution composed of two or more kinds selected from methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-heptanone, cyclohexanone, ethyl carbitol acetate, butyl carbitol acetate, propylene glycol methyl ether, and propylene glycol methyl ether acetate.

The content of the organic solvent in the colored composition is preferably an amount which makes the total solid content concentration in the composition 5% by mass to 80% by mass, more preferably 5% by mass to 60% by mass, and particularly preferably 10% by mass to 60% by mass.

(Sensitizer)

The colored composition of the invention can also contain a sensitizer. Typical examples of the sensitizer that can be used in the invention include the compounds disclosed by Crivello [J. V. Crivello, Adv. in Polymer Sci., 62, 1 (1984)], and specific examples include pyrene, perylene, acridine, thioxanthone, 2-chlorothioxanthone, benzoflavin, N-vinylcarbazole, 9,10-dibutoxyanthracene, anthraquinone, benzophenone, coumarin, ketocoumarin, phenanthrene, camphor-quinone, and phenothiazine derivatives. The sensitizer is preferably added at a proportion of 50% by mass to 200% by mass, based on the photopolymerization initiator.

(Chain Transfer Agent)

The colored composition of the invention may also contain a chain transfer agent.

Examples of the chain transfer agent that can be used in the invention include N,N-dialkylaminobenzoic acid alkyl esters such as N,N-dimethylaminobenzoic acid ethyl ester; mercapto compounds having heterocyclic rings, such as 2-mercaptobenzothiazole, 2-mercaptobenzoxazole, 2-mercaptobenzimidazole, N-phenylmercaptobenzimidazole, 1,3,5-tris(3-mercaptobutyloxyethyl)-1,3,5-triazine-2,4,6-(1H,3H,5H)-trione; and polyfunctional aliphatic mercapto compounds such as pentaerythritol tetrakis(3-mercaptobutyrate) and 1,4-bis(3-mercaptobutyryloxy)butane.

The chain transfer agent may be used singly, or two or more kinds may be used in combination.

The amount of addition of the chain transfer agent is preferably in the range of 0.01% by mass to 15% by mass relative to the total solid content of the composition of the invention, from the viewpoint of reducing the fluctuation of sensitivity, and the amount of addition is more preferably 0.1% by mass to 10% by mass, and particularly preferably 0.5% by mass to 5% by mass.

(Polymerization Inhibitor)

The colored composition of the invention may contain a polymerization inhibitor.

The polymerization inhibitor is a substance which subjects a polymerization initiating species such as a radical generated in a colored photosensitive resin composition by light or heat, to hydrogen donation (or hydrogen reception), energy donation (or energy reception), electron donation (or electron reception) or the like, deactivates the polymerization initiating species, and suppresses unintended initiation of polymerization. The polymerization inhibitors described in paragraphs [0154] to [0173] of JP-A No. 2007-334322, and the like can be used.

Among these, a preferred example of the polymerization inhibitor may be p-methoxyphenol.

The content of the polymerization inhibitor in the colored composition of the invention is preferably 0.0001% by mass to 5% by mass, more preferably 0.001% by mass to 5% by mass, and particularly preferably 0.001% by mass to 1% by mass, relative to the total mass of the polymerizable compound.

(Surfactant)

The colored photosensitive resin composition of the invention may contain a surfactant.

Regarding the surfactant, any of anionic surfactants, cationic surfactants, nonionic surfactants or amphoteric surfactants can be used, but a preferred surfactant is a nonionic surfactant. Specific examples include the nonionic surfactants described in paragraph [0058] of JP-A No. 2009-098616, and among others, fluorine-containing surfactants are preferred.

Examples of other surfactants that can be used in the invention include commercially available products such as MEGAFACE F142D, MEGAFACE F172, MEGAFACE F173, MEGAFACE F176, MEGAFACE F177, MEGAFACE F183, MEGAFACE F479, MEGAFACE F482, MEGAFACE F554, MEGAFACE F780, MEGAFACE F781, MEGAFACE F781-F, MEGAFACE R30, MEGAFACE R08, MEGAFACE F-472SF, MEGAFACE BL20, MEGAFACE R-61, MEGAFACE R-90 (manufactured by DIC Corp.); FLUORAD FC-135, FLUORAD FC-170C, FLUORAD FC-430, FLUORAD FC-431, NOVEC FC-4430 (manufactured by Sumitomo 3M, Ltd.); ASAHIGUARD AG7105, 7000, 950, 7600, SURFLON S-112, SURFLON S-113, SURFLON S-131, SURFLON S-141, SURFLON S-145, SURFLON S-382, SURFLON SC-101, SURFLON SC-102, SURFLON SC-103, SURFLON SC-104, SURFLON SC-105, SURFLON SC-106 (manufactured by Asahi Glass Co., Ltd.); EFTOP EF351, EFTOP 352, EFTOP 801, EFTOP 802 (manufactured by Mitsubishi Materials Electronic Chemicals Co., Ltd.); and PHTHAGENT 250 (manufactured by Neos Co., Ltd.).

Furthermore, a preferred example of the surfactant may be a copolymer containing a constituent unit A and a constituent unit B represented by the following formula (1), and having a weight average molecular weight (Mw), which is measured by gel permeation chromatography using tetrahydrofuran as a solvent and calculated relative to polystyrene standards, of from 1,000 to 10,000.

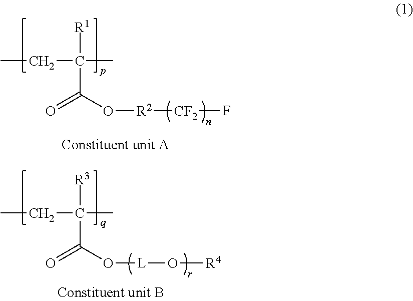

wherein in formula (1), R¹ and R³ each independently represent a hydrogen atom or a methyl group; R² represents a linear alkylene group having from 1 to 4 carbon atoms; R⁴ represents a hydrogen atom or an alkyl group having from 1 to 4 carbon atoms; L represents an alkylene group having from 3 to 6 carbon atoms; p and q each represent a percentage by weight that represents the polymerization ratio, while p represents a value of from 10% by mass to 80% by mass, and q represents a value of from 20% by mass to 90% by mass; r represents an integer from 1 to 18; and n represents an integer from 1 to 10.

L is preferably a branched alkylene group represented by the following formula (2). R⁵ in formula (2) represents an alkyl group having from 1 to 4 carbon atoms, and in view of compatibility and wettability to the surface to be coated, an alkyl group having from 1 to 3 carbon atoms is preferred, and an alkyl group having 2 or 3 carbon atoms is more preferred. The sum of p and q (p+q) is preferably such that p+q=100, that is, 100% by mass.

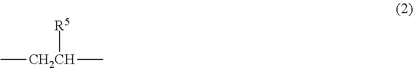

The weight average molecular weight (Mw) of the copolymer is more preferably from 1,500 to 5,000.

These surfactants can be used singly, or as mixtures of two or more kinds The amount of addition of the surfactant in the colored composition of the invention is preferably 0.01% by mass to 2.0% by mass, and particularly preferably 0.02% by mass to 1.0% by mass, relative to the solid content. When the amount of addition is in this range, satisfactory coatability and uniformity of the cured film are obtained.

(Adhesion Improving Agent)

The colored composition of the invention may contain an adhesion improving agent.

The adhesion improving agent is a compound which enhances adhesiveness between a cured film and an inorganic substance that forms the base material, for example, glass, a silicon compound such as silicon, silicon oxide or silicon nitride, gold, copper, or aluminum. Specific examples include a silane coupling agent and a thiol-based compound. The silane coupling agent as the adhesion improving agent is intended for the modification of an interface, and any known compound can be used without any particular limitations.

Regarding the silane coupling agent, the silane coupling agents described in paragraph [0048] of JP-A No. 2009-98616 are preferred, and among them, γ-glycidoxypropyltrialkoxysilane and γ-methacryloxypropyltrialkoxysilane are more preferred. These can be used singly, or two or more kinds can be used in combination.

The content of the adhesion improving agent in the colored composition of the invention is preferably 0.1% by mass to 20% by mass, and more preferably 0.2% by mass to 5% by mass, relative to the total solid content.

(Crosslinking Agent)

When a crosslinking agent is complementarily used in the colored composition of the invention, the hardness of a colored cured film that is obtained by curing the colored composition may be further increased.

There are no particular limitations on the crosslinking agent as long as the compound is capable of inducing film curing by a crosslinking reaction, and examples include (a) an epoxy resin; (b) a melamine compound, a guanamine compound, a glycoluryl compound or a urea compound, all of which are substituted with at least one selected from a methylol group, an alkoxymethyl group, and an acyloxymethyl group; and (c) a phenol compound, a naphthol compound or a hydroxyanthracene compound, all of which are substituted with at least one selected from a methylol group, an alkoxymethyl group and an acyloxymethyl group. Among them, a polyfunctional epoxy resin is preferred.

Reference can be made concerning the details of the specific examples of the crosslinking agent and the like, to the description of paragraphs [0134] to [0147] of JP-A No. 2004-295116.

(Development Accelerating Agent)

In the case of accelerating the alkali-solubility of unexposed regions and promoting a further enhancement in the developability of the colored composition, a development accelerating agent may be added. The development accelerating agent is preferably a low molecular weight organic carboxylic acid compound having a molecular weight of 1000 or less, or a low molecular weight phenol compound having a molecular weight of 1000 or less.

Specific examples include aliphatic monocarboxylic acids such as formic acid, acetic acid, propionic acid, butyric acid, valeric acid, pivalic acid, caproic acid, diethylacetic acid, enanthic acid, and caprylic acid; aliphatic dicarboxylic acids such as oxalic acid malonic acid, succinic acid, glutaric acid, adipic acid, pimelic acid, suberic acid, azelaic acid, sebacic acid, brassylic acid, methylmalonic acid, ethylmalonic acid, dimethylmalonic acid, methylsuccinic acid, tetramethylsuccinic acid, and citraconic acid; aliphatic tricarboxylic acids such as tricarballylic acid, aconitic acid, and camphoronic acid; aromatic monocarboxylic acids such as benzoic acid, toluic acid, cuminic acid, hemellitic acid, and mesitylenic acid; aromatic polycarboxylic acids such as phthalic acid, isophthalic acid, terephthalic acid, trimellitic acid, trimesic acid, melophanic acid, and pyromellitic acid; phenylacetic acid, hydroatropic acid, hydrocinnamic acid, mandelic acid, phenylsuccinic acid, atropic acid, cinnamic acid, methyl cinnamate, benzyl cinnamate, cinnamylideneacetic acid, coumaric acid, and umbellic acid.

(Other Additives)

In the colored composition of the invention, if necessary, various other additives, for example, a filler, a polymer compound other than those described above, an ultraviolet absorber, an oxidation inhibitor, and an aggregation preventing agent, can be incorporated. Examples of these additives include those described in paragraphs [0155] to [0156] of JP-A No. 2004-295116.

The colored composition of the invention can contain the photostabilizer described in paragraph [0078] of JP-A No. 2004-295116, and the thermal polymerization inhibitor described in paragraph [0081] of JP-A No. 2004-295116.

<Method for Preparing Colored Composition>

There are no particular limitations on the embodiment for preparing the colored composition of the invention, but for example, the colored composition can be prepared by mixing the various components described above, such as a particular metal complex compound, a polymerizable compound and a photopolymerization initiator, with optional components as necessary.

Meanwhile, on the occasion of preparing the colored composition, the various components contained in the colored composition may be incorporated all at once, or the various components may be dissolved or dispersed in solvents and then incorporated in sequence. Furthermore, there are no particular restrictions on the feeding order or the operation conditions at the time of incorporating the components. For example, the composition may be prepared by dissolving or dispersing all the components simultaneously in a solvent, or if necessary, the composition may be prepared by appropriately preparing two or more solutions or dispersion liquids of the various components, and mixing these at the time of use (at the time of application).

Meanwhile, on the occasion of preparing the colored composition of the invention, it is preferable to mix the various components and then filtering the mixture using a filter, for the purpose of eliminating foreign materials or reducing defects. Any filter that is conventionally used for filtering applications and the like may be used without any particular limitations. Specific examples include filters made from fluororesins such as PTFE (polytetrafluoroethylene); polyamide-based resins such as nylon-6 and nylon-6,6; and polyolefin resins (including high density and ultrahigh molecular weight resins) such as polyethylene and polypropylene (PP). Among these filter materials, polyamide-based resins such as nylon-6 and nylon-6,6; and polypropylenes (including high density polypropylene) are preferred.

The pore size of the filter is suitably about 0.01 μm to 7.0 μm, preferably about 0.01 μm to 2.5 μm, and more preferably about 0.01 μm to 2.0 μm. When the pore size is in this range, fine foreign materials that inhibit the preparation of a uniform colored composition in the subsequent processes are securely eliminated, and a uniform and smooth colored composition can be formed.

When a filter is put to use, the filter may be combined with other filters. At that time, filtering using a first filter may be carried out only once, or may be carried out two or more times. First filtering may be carried out such that the first filter may be composed of plural filters by combining filters having different pore sizes within the range mentioned above. Regarding the pore size as used herein, reference may be made to the nominal values provided by filter manufacturers. Commercially available filters can be selected from the various filters provided by, for example, Pall Corp., Advantec Toyo Kaisha, Ltd., Nihon Entegris K.K. (formerly Nippon Microlith Co., Ltd.), or Kitz Micro Filter Corp.

Regarding a second filter, filters formed from the same materials as those of the first filter and the like can be used.

Furthermore, for example, it is also acceptable to perform filtering with the first filter only on a pigment dispersion, prepare a colored composition by mixing the pigment dispersion with other components, and then perform second filtering.

The colored composition of the invention can be applied to various applications such as a color filter for solid-state imaging devices, a color filter for liquid crystal display devices, a printing ink, and an inkjet ink.

Particularly, since a colored cured film obtained by curing the colored composition of the invention has high color purity, can give a high extinction coefficient even in a thin layer, and has excellent fastness properties (particularly, heat resistance and light resistance), the colored cured film is useful for the formation of colored pixels in a color filter for liquid crystal display devices and a color filter for solid state imaging devices. Furthermore, when the colored cured film is applied to a liquid crystal display device, an excellent voltage retention rate may be obtained when a voltage is applied.

<<Color Filter and Method for Producing the Same>>

The color filter of the invention is configured by providing colored regions (colored cured film) that are formed by the colored composition of the invention, on an arbitrary support.

The colored regions on the support are composed of colored films of red (R), green (G), blue (B) and the like constituting various pixels of the color filter.

The color filter of the invention may be formed by any method as long as the method is capable of forming a patterned colored region that contains a particular metal complex compound and has been cured (colored cured film). The color filter of the invention is preferably produced by using the method for producing a color filter of the invention.

The method for producing a color filter of the invention includes a colored composition layer forming process of applying the colored composition of the invention onto a support to form a colored composition layer (hereinafter, also referred to as process (A)); and a patterned colored cured film forming process of patternwise exposing (preferably via a mask) and developing the formed colored composition layer to form a patterned colored region (colored cured film) (hereinafter, also referred to as process (B)).

By repeating these processes several times, a colored pattern composed of pixels of various colors (three colors or four colors) is formed. Thus, a color filter can be obtained.

Furthermore, in regard to the method for producing a color filter of the invention, particularly an embodiment further provided with a process of irradiating ultraviolet radiation to the patterned colored cured film formed in process (B) (hereinafter, also referred to as process (C)); and a process of subjecting the colored cured film that has been irradiated with ultraviolet radiation, to a heating treatment (hereinafter, also referred to as process (D)).

When such a method is used, a color filter that is used in a liquid crystal display device or a solid-state imaging device can be produced with high product quality and at low cost, with reduced difficulties in the process.

Hereinafter, the method for producing a color filter of the invention will be described more specifically.

—Process (A)—

In the method for producing a color filter of the invention, first, the colored composition of the invention described above is applied directly or via another layer onto a support, by a desired method, to form a coating film of the colored composition (colored composition layer), and thereafter, if necessary, a preliminary curing (prebaking) is carried out to dry the colored composition layer.

Examples of the support include the alkali-free glass, soda glass, PYREX (registered trademark) glass and quartz glass, which are used in liquid crystal display devices, these glasses with transparent conductive films attached thereon, and photoelectric conversion device substrates that are used in solid-state imaging devices and the like, for example, silicon substrates and plastic substrates. Furthermore, on these supports, a black matrix that partitions the respective pixels may be formed, or a transparent resin layer for promoting adhesion may be provided. Also, an undercoat layer may be provided on the support, if necessary, for an improvement in adhesion with upper layers, prevention of the diffusion of substances, or smoothening of the surface.

Furthermore, it is preferable that the plastic substrate have, on its surface, a gas barrier layer and/or a solvent resistant layer.

In addition to this, a color filter may also be produced by using a driving substrate on which a thin film transistor (TFT) of a thin film transistor (TFT) type color liquid crystal display device is disposed (hereinafter, referred to as “TFT type liquid crystal driving substrate”), and forming a colored pattern obtained using the colored composition of the invention on this driving substrate.

Examples of the substrate for the TFT type liquid crystal driving substrate include glass, silicon, a polycarbonate, a polyester, an aromatic polyamide, a polyamideimide, and a polyimide. If desired, these substrates may also be subjected to an appropriate pretreatment such as a chemical treatment using a silane coupling agent or the like, a plasma treatment, ion plating, sputtering, a vapor phase reaction method, or vacuum vapor deposition. For example, a substrate having a passivation film such as a silicon nitride film formed on the surface of a TFT type liquid crystal driving substrate can be used.

Regarding the method for applying the colored composition of the invention onto a support, coating methods such as spin coating, slit coating, flow cast coating, roll coating, bar coating, and inkjetting may be used.

In regard to the process (A), there are no particular limitations on the method for applying the colored composition of the invention onto a support, but a method of using slit nozzles such as a slit and spin method or a spinless coating method (hereinafter, referred to as slit nozzle coating method) is preferred.

In regard to the slit nozzle coating method, the slit and spin coating method and the spinless coating method are such that although the conditions may vary with the size of the coated substrate, for example, in the case of coating a fifth generation glass substrate (1100 mm×1250 mm) by the spinless coating method, the amount of ejection of the colored composition through slit nozzles is usually 500 microliters/second to 2000 microliters/second, and preferably 800 microliters/second to 1500 microliters/second. Also, the coating speed is usually 50 mm/second to 300 mm/second, and preferably 100 mm/second to 200 mm/second.

Furthermore, the solid content of the colored composition used in the process (A) is usually 10% by mass to 20% by mass, and preferably 13% by mass to 18% by mass.

In the process (A), usually, a prebaking treatment is applied after the colored composition layer is formed. According to necessity, a vacuum treatment may be applied before the prebaking. The conditions for vacuum drying are such that the degree of vacuum is usually about 0.1 torr to 1.0 torr, and preferably about 0.2 torr to 0.5 torr.

Furthermore, the prebaking treatment can be carried out using a hot plate, an oven or the like, under the conditions of a temperature range of 50° C. to 140° C., and preferably about 70° C. to 110° C., for 10 seconds to 300 seconds. Meanwhile, the prebaking treatment may be performed in combination with a high frequency treatment or the like. The high frequency treatment can be performed alone.

Regarding the conditions for the prebaking, conditions of heating at 70° C. to 130° C. for about 0.5 minutes to 15 minutes using a hot plate or an oven may be employed.

Furthermore, the thickness of the colored composition layer formed by the colored composition is appropriately selected according to the purpose. In a color filter for liquid crystal display devices, the thickness is preferably in the range of 0.2 μm to 5.0 μm, more preferably in the range of 1.0 μm to 4.0 μm, and most preferably in the range of 1.5 μm to 3.5 μm. Furthermore, in a color filter for solid-state imaging device, the thickness is preferably in the range of 0.2 μm to 5.0 μm, more preferably in the range of 0.3 μm to 2.5 μm, and most preferably in the range of 0.3 μm to 1.5 μm.

Meanwhile, the thickness of the colored composition layer mentioned above is the film thickness after the prebaking

—Process (B)—

Subsequently, in the method for producing a color filter of the invention, the coating film (colored composition layer) formed from the colored composition on a support as described above is subjected to light exposure through, for example, a photomask. The light or radiation that can be applied to light exposure is preferably g-line, h-line, i-line, j-line, KrF light, or ArF light, and particularly, i-line is preferred. In the case of using i-line as the irradiation light, it is preferable to irradiate at an amount of exposure of 100 mJ/cm² to 10,000 mJ/cm².

Furthermore, regarding the exposure light other than those, various mercury lamps of ultrahigh pressure, high pressure, medium pressure and low pressure, a chemical lamp, a carbon arc lamp, a xenon lamp, a metal halide lamp, various laser light sources of visible light and ultraviolet radiation, a fluorescent lamp, a tungsten lamp, sunlight and the like can also be used.

—Exposure Process Using a Laser Light Source—

Regarding the exposure method using a laser light source, it is preferable to use ultraviolet light laser as the light source.

The irradiation light is preferably ultraviolet laser light having a wavelength in the range of 300 nm to 380 nm, and more preferably, ultraviolet laser light having a wavelength in the range of 300 nm to 360 nm is preferred from the viewpoint of having a wavelength coincident with the wavelength in which a resist is photosensitive. Specifically, the third harmonic wave of Nd:YAG laser (355 nm), which is a relatively inexpensive solid laser with a particularly high power output, or XeCl (308 nm) or XeF (353 nm) of excimer lasers can be suitably used.

The amount of exposure for the object to be exposed (pattern) is in the range of 1 mJ/cm² to 100 mJ/cm², and more preferably in the range of 1 mJ/cm² to 50 mJ/cm². When the amount of exposure is in this range, it is preferable from the viewpoint of the productivity of pattern formation.

There are no particular limitations on the exposure apparatus, but commercially available apparatuses that can be used include CALLISTO (manufactured by V-Technology Co., Ltd.), EGIS (manufactured by V-Technology Co., Ltd.), and DF2200G (manufactured by Dainippon Screen Manufacturing Co., Ltd.). Further, apparatuses other than those described above are also suitably used.

When a color filter for liquid crystal display devices is produced, exposure using mainly the h-line or i-line by a proximity exposure machine or a mirror projection exposure machine is preferably used. Furthermore, when a color filter for solid-state imaging device is produced, it is preferable to use mainly the i-line by a stepper exposure machine. Meanwhile, regarding the photomask used when a color filter is produced using a TFT type liquid crystal driving substrate, a photomask provided with a pattern for forming pixels (colored pattern) as well as a pattern for forming through-holes or U-shaped depressions is used.

The colored composition layer exposed as described above can be heated.

Furthermore, in order to suppress oxidative discoloration of the coloring material in the colored composition layer, exposure can be carried out while nitrogen gas is passed into the chamber.

Subsequently, the colored composition layer after exposure is subjected to development with a developer liquid. Thereby, a negative type or positive type colored pattern (resist pattern) can be formed. In the development process, uncured areas of the coating film after exposure are dissolved into the developer liquid, and only the cured parts are allowed to remain on the substrate.

Any developer liquid that is capable of dissolving a coating film (colored composition layer) of a colored composition in uncured areas but does not dissolve cured areas, can be used. For example, combinations of various organic solvents or alkaline aqueous solutions can be used.

Examples of the organic solvent that is used in the development include those solvents described above that can be used when the colored composition of the invention is prepared.

Examples of the alkaline aqueous solutions include alkaline aqueous solutions prepared by dissolving alkaline compounds such as sodium hydroxide, potassium hydroxide, sodium carbonate, sodium hydrogen carbonate, sodium silicate, sodium metasillicate, aqueous ammonia, ethylamine, diethylamine, dimethylethanolamine, tetramethylammonium hydroxide, tetraethylammonium hydroxide, choline, pyrrole, piperidine, and 1,8-diazabicyclo[5,4,0]-7-undecene at a concentration of 0.001% by mass to 10% by mass, and preferably 0.01% by mass to 1% by mass. When the developer liquid is an alkaline aqueous solution, it is desirable to adjust the alkali concentration preferably to pH 11 to 13, and more preferably to pH 11.5 to 12.5.

In the alkaline aqueous solution, for example, a water-soluble organic solvent such as methanol or ethanol, a surfactant or the like can be added in an appropriate amount.

The development temperature is usually 20° C. to 30° C., and the development time is 20 seconds to 90 seconds.

Development may be carried out by a dipping method, a shower method, a spray method and the like, and this may be combined with a swing method, a spin method, an ultrasonic method or the like. Before being brought into contact with the developer liquid, the surface to be developed may be wetted in advance with water or the like so as to prevent uneven development. Also, the substrate may be developed in an inclined state.

Furthermore, in the case of producing a color filter for solid-state imaging devices, paddle development is also used.

After the development treatment, a rinsing treatment for washing and removing any excess developer liquid is carried out, drying is carried out, and then in order to complete curing, a heating treatment (post-baking) is carried out.

The rinsing treatment is usually carried out using pure water, but for liquid saving, a method of using pure water in the final washing and using used pure water in the early stage of washing, a method of washing the substrate in an inclined state, or a method of additionally using ultrasonic irradiation may be used.

After performing the rinsing treatment and then performing dehydration and drying, a heating treatment at about 200° C. to 250° C. is usually carried out. This heating treatment (post-baking) can be conducted on the coating film after development, in a continuous mode or a batch mode using a heating means such as a hot plate, a convection oven (hot air circulation type dryer), or a high frequency heater under the conditions described above.

When the various processes described above are carried out repeatedly in sequence for each color in accordance with the desired number of colors, a color filter in which a cured film colored in plural colors (colored pattern) is formed can be produced.

—Process (C)—

In the method for producing a color filter of the invention, particularly the patterned colored cured film (colored pixels) that has been formed by using the colored composition may be subjected to post-exposure by ultraviolet irradiation.

—Process (D)—

It is preferable to carry out a further heating treatment on the patterned colored cured film that has been subjected to post-exposure by ultraviolet irradiation such as described above. When the colored cured film thus formed is subjected to a heating treatment (so-called post-baking treatment), the colored cured film can be further cured. This heating treatment can be carried out by, for example, a hot plate, various heaters, ovens and the like.

The temperature at the time of heating treatment is preferably 100° C. to 300° C., and more preferably 150° to 250° C. Furthermore, the heating time is preferably about 10 minutes to 120 minutes.

The patterned colored cured film obtained as described above constitutes pixels in the color filter. In the production of a color filter having pixels of plural colors, the process (A), process (B) and if necessary, the process (C) or process (D) may be repeated according to the desired number of colors.

Meanwhile, the process (C) and/or process (D) may be carried out every time the formation, exposure, and development of a colored composition layer of a single color are completed (for each color), or the process (C) and/or process (D) may be carried out all at once after the formation, exposure and development of all the colored composition layers of the desired number of colors are completed.

Due to the use of the colored composition of the invention, the color filter obtained by the method for producing a color filter of the invention (color filter of the invention) exhibits clear coloring and high contrast when used in image display, and has excellent fastness properties (particularly, heat resistance and light resistance) and an excellent voltage retention rate.

The color filter of the invention can be used in liquid crystal display devices or solid state imaging devices, and is particularly suitable for the applications of liquid crystal display devices. When the color filter is used in a liquid crystal display device, satisfactory hues can be achieved by using dyes as colorants, while the display of images having excellent spectral characteristics and contrast is enabled. Furthermore, the color filter also provides an excellent voltage retention rate.

Regarding the use of the colored composition of the invention, explanation has been given above primarily on the use for the formation of the colored cured film of color filters; however, the colored composition can also be applied to the formation of the black matrix that partitions the colored cured film (pixels) that constitutes the color filter.

The black matrix on the substrate can be formed by using a colored composition containing a processed pigment of a black pigment such as carbon black or titanium black, performing the various processes of coating, exposure and development, and then performing post-baking as necessary.

<<Liquid Crystal Display Device>>

The liquid crystal display device of the invention includes the color filter of the invention described above.

When the color filter of the invention is used in a liquid crystal display device, the color filter contains a metal complex coloring material having excellent spectral characteristics and heat resistance, while the voltage retention rate when a voltage is applied is not decreased. Furthermore, fewer orientation defects of liquid crystal molecules resulting from a decrease in the specific resistance, satisfactory color tones of displayed images, and excellent display characteristics are provided.

Therefore, the liquid crystal display device including the color filter of the invention has satisfactory color tones of displayed images, and can display high quality images having excellent display characteristics.

The definition of the display device and the details of various display devices are described in, for example, “Electronic Display Devices (written by Akio Sasaki, Kogyo Chosakai Publishing Co., Ltd., published in 1990)”, “Display Devices (written by Ibuki Sumiaki, Sangyo Tosho Publishing Co., Ltd., published in 1988)”, and the like. Furthermore, liquid crystal display devices are described in, for example, “Jisedai Ekisho Disupurei Gijutsu (Next-Generation Liquid Crystal Display Technology) (edited by Tatsuo Uchida, Kogyo Chosakai Publishing Co., Ltd., published in 1994)”. There are no particular limitations on the liquid crystal display device to which the invention can be applied, and the invention can be applied to, for example, the liquid crystal display devices of various modes described in “Jisedai Ekisho Disupurei Gijutsu”.

The color filter according to the invention may be used in a liquid crystal display device of color TFT type. Color TFT type liquid crystal display devices are described in, for example, “Color TFT Liquid Crystal Displays (Kyoritsu Shuppan Co., Ltd., published in 1996)”. Furthermore, the invention can also be applied to liquid crystal display devices with extended viewing angles of the horizontal electric field drive mode such as IPS, the pixel division mode such as MVA, or the like, or to STN, TN, VA, OCS, FFS, R-OCB and the like.

Furthermore, the color filter according to the invention can also be applied to the bright high-definition COA (Color filter On Array) mode. In liquid crystal display devices of the COA mode, the characteristics required for the color filter layer may be, in addition to the conventional required characteristics such as described above, the characteristics required for interlayer insulating films, that is, low dielectric constant and resistance to stripper liquid. In the color filter of the invention, since dyes having excellent hues are used, satisfactory color purity, light transmissibility and the like are obtained, and the color tones of the colored pattern (pixels) are excellent. Therefore, a liquid crystal display device of the COA mode having high resolution and excellent long-term durability can be provided. Meanwhile, in order to satisfy the required characteristics of low dielectric constant, a resin coating film may be provided on the color filter layer.

These image display modes are described in, for example, page 43 of “EL, PDP, LCD Disupurei-Gijutsu to Shijo no Saishin Doko (EL, PDP and LCD Displays—Recent Trend of Technologies and Markets) (Investigation Research Department of Toray Research Center, Inc., published in 2001).

A liquid crystal display device equipped with the color filter according to the invention is composed of various members such as an electrode substrate, a polarizing film, a retardation film, a backlight, a spacer and a viewing angle compensation film, in addition to the color filter according to the invention. The color filter of the invention can be applied to a liquid crystal display device composed of these known members. These members are described in, for example, “'94 Ekisho Disupurei Shuhen Zairyo Kemikaruzu no Shijo ('94 Markets for Liquid Crystal Display Peripheral Materials and Chemicals) (Kentaro Shima, CMC Publishing, Inc., published in 1994), and “2003 Ekisho Ganren Shijo no Genjo to Shorai Tembo (2003 Current Status and Future Prospect of Liquid Crystal-Related Market) (2^{nd} Volume) (Ryokichi Omote, Fuji Chimera Research Institute, Inc., published in 2003)”.

Backlights are described in SID Meeting Digest 1380 (2005) (A. Konno et al.); Display Monthly, December 2005, p. 18 to 24 (Yasuhiro Shima); ibid., p. 25 to 30 (Takaaki Yagi), and the like.

When the color filter according to the invention is used in a liquid crystal display device, high contrast can be realized if combined with the three-wavelength tube of a conventionally known cold cathode tube. However, when LED light sources of red, green and blue (RGB-LED) are used as backlights, a liquid crystal display device having high luminance, high color purity and satisfactory color reproducibility can be provided.

<<Solid-State Imaging Device>>

The solid-state imaging device of the invention includes the color filter of the invention described above.

The configuration of the solid-state imaging device of the invention is not particularly limited as long as it is a configuration which includes the color filter of the invention and functions as a solid-state imaging device, but for example, a configuration such as described below may be used.

It is a configuration which includes, on a support, plural photodiodes that constitute the light-receiving area of a solid-state imaging device (a CCD image sensor, a CMOS image sensor, or the like) and a transfer electrode formed of polysilicon; includes, on the photodiodes and the transfer electrode, a light-shielding film formed of tungsten or the like having an opening only at the light-receiving area of the photodiodes; includes, on the light-shielding film, a device protecting film formed of silicon nitride or the like that is formed so as to cover the entire surface of the light-shielding film and the photodiode light-receiving area; and includes the color filter of the invention on the device protecting film.

Furthermore, a configuration including a light focusing means (for example, a microlens or the like; hereinafter, the same) above the device protecting layer and below the color filter (the side closer to the support), or a configuration including a light focusing means above the color filter may also be used.

### EXAMPLES

Hereinafter, the invention will be more specifically described by way of Examples, but the invention is not intended to be limited to the following Examples as long as the gist is maintained. Meanwhile, unless particularly stated otherwise, the units “parts” and “percent (%)” are on a mass basis.

<Synthesis of Particular Metal Complex Compound>

### Example 1

### Synthesis Examples of Exemplary Compounds A-1 and C-16

The Exemplary Compounds A-1 and C-16 described above as specific examples of the particular metal complex compound were synthesized according to the following reaction scheme.

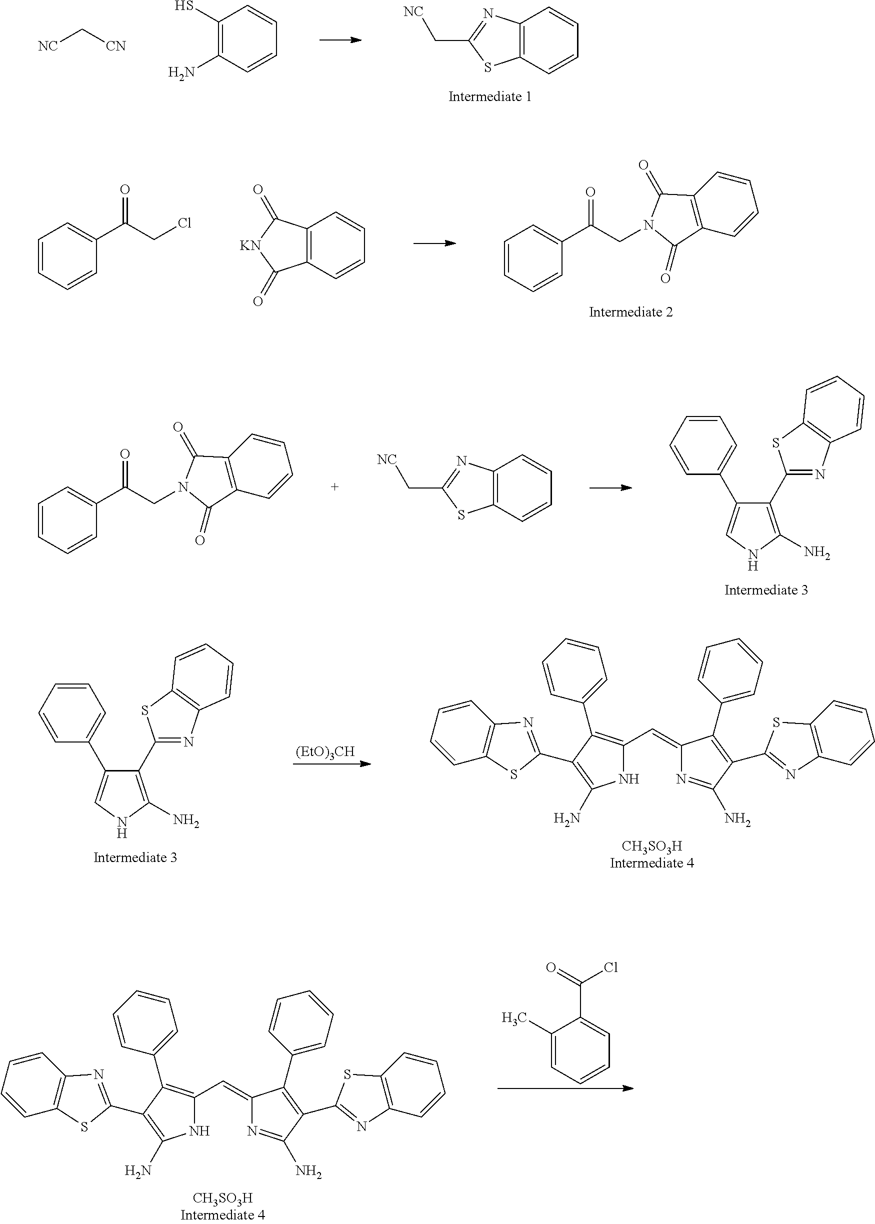

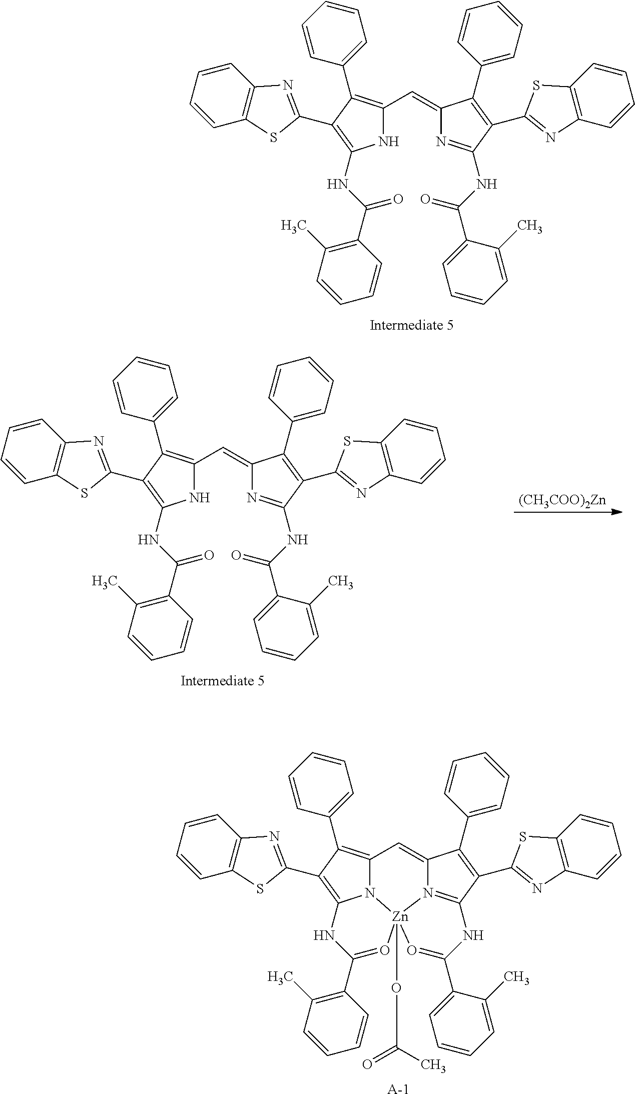

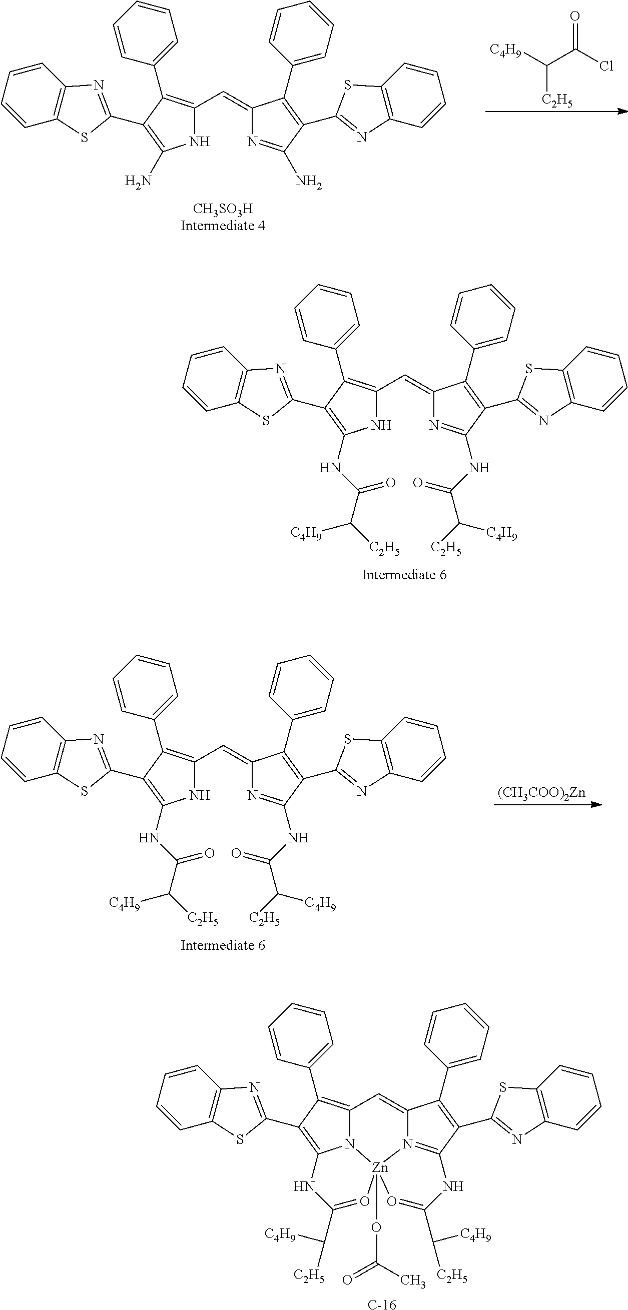

(Synthesis of Intermediate 1)

66.1 g (1 mol) of malononitrile, 600 ml of methanol, and 56 ml of acetic acid are mixed and stirred. 125 g (1 mol) of aminobenzenethiol is added dropwise thereto, and then the mixture is stirred for 10 hours at room temperature. After completion of the stirring, the mixture was filtered, washed with methanol, and dried. Thus, 134.6 g (77%) of Intermediate 1 was obtained.

Meanwhile, the data for ¹H-NMR (CDCl₃) were δ: 8.07-8.04 (m, 1H), 7.92-7.89 (m, 1H), 7.56-7.43 (m, 2H), 4.25 (s, 2H).

(Synthesis of Intermediate 2)

98.2 g (0.53 mol) of potassium phthalimide is added to 300 ml of NMP, and the mixture is stirred. 77.3 g (0.5 mol) of phenacyl chloride is slowly added thereto, and then the mixture is stirred for 3 hours at room temperature. After the stirring, 600 ml of water is added thereto, and the mixture is further stirred for one hour. After completion of the stirring, the mixture was filtered, washed with water, methanol and ethyl acetate, and dried. Thus, 122.6 g (62%) of Intermediate 2 was obtained.

Meanwhile, the data for ¹H-NMR (CDCl₃) were δ: 8.04-8.01 (m, 2H), 7.93-7.89 (m, 2H), 7.80-7.76 (m, 2H), 7.68-7.63 (m, 1H), 7.56-7.27 (m, 2H), 5.15 (s, 2H).

(Synthesis of Intermediate 3)

17.4 g (0.1 mol) of the Intermediate 1, 26.5 g (0.1 mol) of the Intermediate 2, and 40 g of a 20% aqueous solution of sodium hydroxide are added to 60 ml of butanol, and the mixture is subjected to heating and stirring for 5 hours at 100° C. After completion of the stirring, the mixture is slowly cooled to 0° C., and is left to stand for 2 hours. Crystals thus precipitated were filtered, washed with cold water and cold butanol, and dried. Thus, 16.9 g (58%) of Intermediate 3 was obtained.

Meanwhile, the data for ¹H-NMR (CDCl₃) were δ: 7.83-7.80 (m, 1H), 7.63-7.60 (m, 2H), 7.49-7.40 (m, 5H), 7.37-7.31 (m, 1H), 7.18-7.13 (m, 1H), 6.28 (d, 1H), 5.75 (br, 2H).

(Synthesis of Intermediate 4)

30 ml of toluene was added to 8.74 g (0.03 mol) of the Intermediate 3 and 2.7 g (0.018 mol) of triethyl ortho-formate, and the mixture was stirred at room temperature. 1.44 g (0.015 mol) of methanesulfonic acid was added dropwise to the solution, and then the mixture was heated and stirred for 8 hours at 100° C. After completion of the stirring, the mixture was returned to room temperature, and then 60 ml of methanol was added thereto. The mixture was stirred for 30 minutes. After the stirring, a solid thus precipitated was filtered, washed with methanol, and dried. Thus, 8.4 g (yield: 81%) of Intermediate 4 was obtained.

Meanwhile, the data for ¹H-NMR (CDCl₃) were δ: 11.73 (br, 2H), 8.27 (br, 4H), 7.88 (d, 2H), 7.59 (d, 2H), 7.47-7.13 (m, 14H), 5.97 (s, 1H), 3.08 (s, 3H).

(Synthesis of Intermediate 5)

30 ml of toluene and 2.1 g (3 mmol) of the Intermediate 4 were added to 12.5 g of a 25% aqueous solution of sodium hydroxide, and the mixture was stirred at room temperature. 3.7 g (24 mmol) of o-toluoyl chloride was added dropwise to the solution, and the mixture was stirred for 10 hours at room temperature. After completion of the reaction, the aqueous layer was removed, and the reaction liquid was washed three times with 20 ml of a 10% aqueous solution of sodium hydroxide and then washed once with 20 ml of a 5% aqueous acetic acid solution. Subsequently, 30 ml of methanol was added to this solution, and the mixture was stirred for 2 hours. Subsequently, a solid thus obtained was filtered and dried. Thus, 1.8 g (75%) of Intermediate 5 was obtained.

Meanwhile, the data for ¹H-NMR (CDCl₃) were δ: 12.58 (s, 2H), 7.97 (d, 2H), 7.77 (d, 2H), 7.65 (d, 2H), 7.47-7.23 (m, 20H), 6.39 (s, 1H), 2.85 (s, 6H).

(Synthesis of Exemplary Compound A-1)

1.24 g (1.5 mmol) of the Intermediate 5 was added to 20 ml of tetrahydrofuran, and the mixture was stirred. Subsequently, 0.4 g (1.8 mmol) of zinc acetate dihydrate was added thereto, and the mixture was stirred for one hour at room temperature. Subsequently, 50 ml of methanol was added to the liquid, and the mixture was stirred for 3 hours. After completion of the reaction, a solid thus precipitated was filtered, washed with methanol and dried. Thus, 1.16 g (81%) of Exemplary Compound A-1 was obtained.

Meanwhile, the data for ¹H-NMR (CDCl₃) were δ: 13.08 (s, 2H), 7.98 (d, 2H), 7.77 (d, 2H), 7.67 (d, 2H), 7.53-7.26 (m, 20H), 6.62 (s, 1H), 2.85 (s, 6H), 2.00 (s, 3H).

Meanwhile, the maximum absorption wavelength λmax in an ethyl acetate solution was 609 nm, and the molar extinction coefficient (∈) was 218,000. The maximum absorption wavelength λmax and the molar extinction coefficient (∈) were measured using a spectrophotometer UV-1800PC (manufactured by Shimadzu Corp.).

(Synthesis of Intermediate 6)

30 ml of toluene and 2.1 g (3 mmol) of the Intermediate 4 were added to 12.5 g of a 25% aqueous solution of sodium hydroxide, and the mixture was stirred at room temperature. 3.9 g (24 mmol) of 2-ethylhexanoyl chloride was added dropwise to the solution, and the mixture was stirred for 10 hours at room temperature. After completion of the reaction, the aqueous layer was removed, and then the reaction liquid was washed three times with 20 ml of a 10% aqueous solution of sodium hydroxide and washed once with 20 ml of a 5% aqueous acetic acid solution. Subsequently, 30 ml of methanol was added to this solution, and the mixture was stirred for 2 hours. A solid thus obtained was then filtered and purified by column chromatography. Thus, 0.7 g (28%) of Intermediate 6 was obtained.

Meanwhile, the data for ¹H-NMR (CDCl₃) were δ: 11.95 (s, 2H), 7.94 (d, 2H), 7.65 (d, 2H), 7.46-7.25 (m, 14H), 6.26 (s, 1H), 2.05-1.69 (m, 10H), 1.54-1.35 (m, 8H), 1.09 (t, 6H), 0.90 (t, 6H).

(Synthesis of Exemplary Compound C-16)

2.54 g (3 mmol) of the Intermediate 6 was added to 30 ml of tetrahydrofuran and stirred, and subsequently, 0.8 g (3.6 mmol) of zinc acetate dihydrate was added thereto. The mixture was stirred for one hour at room temperature. Subsequently, 70 ml of methanol was added to the liquid, and the mixture was stirred for 3 hours. After completion of the reaction, a solid thus precipitated was filtered, washed with methanol and dried. Thus, 1.48 g (51%) of Exemplary Compound C-16 was obtained.

Meanwhile, the data for ¹H-NMR (CDCl₃) were δ: 12.47 (s, 2H), 7.84 (d, 2H), 7.65 (d, 2H), 7.45-7.24 (m, 14H), 6.52 (s, 1H), 2.65-2.56 (m, 2H), 2.05-1.72 (m, 11H), 1.54-1.36 (m, 8H), 1.14 (t, 6H), 0.92 (t, 6H).

In addition, the maximum absorption wavelength λmax in an ethyl acetate solution was 600 nm, and the molar extinction coefficient (∈) was 215,000.

### Example 2

### Synthesis Example of Exemplary Compounds Other than Exemplary Compounds A-1 and C-16

Various exemplary compounds (particular metal complex compounds) indicated in the following Table 1 were further synthesized by methods similar to the reaction scheme used in Example 1, and also, identification and measurement of the maximum absorption wavelength λmax and the molar extinction coefficient (∈) were carried out by the same method as Example 1.

The measurement results will be shown in the following Table 1, together with the results of the exemplary compounds obtained in Example 1.

TABLE 1

| Exemplary | | |
|---|---|---|
| Compound | λmax (nm) | ε |
| A-1 | 609 | 218000 |
| A-2 | 600 | 192000 |
| A-6 | 603 | 201000 |
| A-14 | 609 | 212000 |
| A-15 | 620 | 221000 |
| B-1 | 608 | 216000 |
| B-2 | 608 | 213000 |
| B-19 | 597 | 196000 |
| B-21 | 605 | 209000 |
| C-1 | 620 | 221000 |
| C-2 | 616 | 189000 |
| C-3 | 607 | 219000 |
| C-4 | 610 | 218000 |
| C-5 | 609 | 208000 |
| C-12 | 611 | 205000 |
| C-13 | 599 | 210000 |
| C-14 | 599 | 217000 |
| C-16 | 600 | 215000 |
| C-22 | 591 | 190000 |
| D-1 | 609 | 211000 |
| D-2 | 609 | 209000 |
| D-4 | 609 | 206000 |
| D-5 | 609 | 207000 |
| D-6 | 609 | 203000 |
| D-7 | 609 | 221000 |
| D-9 | 609 | 205000 |
| D-11 | 609 | 216000 |
| E-4 | 574 | 154000 |

<Examples of Colored Composition and Color Filter>

Examples and Comparative Examples of colored compositions containing the various particular metal complex compounds synthesized as described above, and color filters obtained using the colored compositions will be described below.

### Example 3

The various components used in the preparation of various colored compositions will be described below.

(S-1) Pigment dispersion liquid: A pigment dispersion liquid obtained by mixing 12.8 parts of C.I. Pigment Blue 15:6 and 7.2 parts of an acrylic pigment dispersant with 80.0 parts of propylene glycol monomethyl ether acetate, and sufficiently dispersing the pigment using a bead mill.

(T-1) Polymerizable compound: KAYARAD DPHA (manufactured by Nippon Kayaku Co., Ltd.)

(U-1) Binder resin: Propylene glycol monomethyl ether acetate solution of benzyl methacrylate/methacrylic acid (75/25 [mass ratio] copolymer (weight average molecular weight: 12,000)) (solid content: 40.0% by mass)

(V-1) Photopolymerization initiator:
2-(Benzoyloxyimino)-1-[4-(phenylthio)phenyl]-1-octanone

(V-2) Photopolymerization initiator:
2-(Acetoxyimino)-4-(4-chlorophenylthio)-1-[9-ethyl-6-(2-methylbenzoyl)-9H-carbazol-3-yl]-1-butanone

(W-1) Photopolymerization initiation aid: 4,4′-Bis(diethylamino)benzophenone

(X-1) Solvent: Propylene glycol monomethyl ether acetate

(X-2) Solvent: Ethyl 3-ethoxypropionate

(Y-1) Surfactant: MEGAFACE F781-F (manufactured by DIC Corp.)

—1. Preparation of Colored Composition (Coating Liquid)—

The components described below were mixed, and thus Colored composition 1 was prepared.

<Composition>

| | | |
|---|---|---|
| Particular metal complex compound: | 6.9 | parts |
| Exemplary Compound A-1 | | |
| (Dipyrromethene metal complex compound) | | |
| Pigment Dispersion liquid: (S-1) | 43.0 | parts |
| Polymerizable compound: (T-1) | 103.4 | parts |
| Binder resin: (U-1) | 212.2 | parts |
| (value calculated relative to the | | |
| solid content: 84.9 parts) | | |
| Photopolymerization initiator: (V-1) | 21.2 | parts |
| Photosensitizer: (W-1) | 3.5 | parts |
| Organic solvent: (X-1) | 71.9 | parts |
| Organic solvent: (X-2) | 3.6 | parts |
| Surfactant: (Y-1) | 0.06 | parts |

—2. Production of Color Filter Using Colored Composition—

The Colored composition 1 (color resist liquid) obtained in the above section 1. was applied onto a glass substrate (1737, manufactured by Corning, Inc.) having a size of 100 mm×100 mm, such that the x value that serves as an index of color density would be 0.150, and the colored composition was dried in an oven at 90° C. for 60 seconds (prebaking)

Thereafter, the dried colored composition was exposed to a high pressure mercury lamp at a dose of 200 mJ/cm² (illuminance: 20 mW/cm²) through a photomask for resolution evaluation having a mask pore width of 10 μm to 100 μm, and the coating film after exposure was covered with a 1% aqueous solution of an alkali developer liquid CDK-1 (manufactured by Fujifilm Electronic Materials Co., Ltd.). Pure water was sprayed thereon in a shower form to wash away the developer liquid.

Then, the coating film that had been subjected to exposure and development as described above was heat treated in an oven at 220° C. for one hour (post-baking), a patterned colored cured film for color filters was formed on the glass substrate, and thus a color filter substrate 1 (Color Filter 1) was produced.

—3. Evaluation—

The following evaluation was carried out on the Color Filter 1 obtained as described above. The evaluation results will be presented in the following Table 2.

(1. Heat Resistance)

For a heat resistance test, the Color Filter 1 was heated at 240° C. for 10 minutes using a hot plate, and then the color difference between the values obtained before and after the heat resistance test, ΔE*ab value, was measured using a colorimeter MCPD-1000 (manufactured by Otsuka Electronics Co., Ltd.) and evaluated according to the criteria described below. A smaller value of ΔE*ab represents more satisfactory heat resistance.

<Determination Criteria>

5: ΔE*ab value<3

4: 3≦ΔE*ab value<5

3: 5≦ΔE*ab value<10

2: 10≦ΔE*ab value<20

1:20≦ΔE*ab value

(2. Light Resistance)

For a light resistance test, the Color Filter 1 was irradiated for 20 hours at 50,000 lux (equivalent to 1,000,000 lux·h) using a xenon lamp, and then the color difference between the values obtained before and after the light resistance test, ΔE*ab value, was measured. A smaller value of ΔE*ab represents more satisfactory light resistance.

<Determination Criteria>

5: ΔE*ab value<3

4: 3≦ΔE*ab value<5

3: 5≦ΔE*ab value<10

2: 10≦ΔE*ab value<20

1: 20≦ΔE*ab value

### Example 4 to Example 25 and Example 30

Color Filters 2 to 23 and Color Filter 28 were produced in the same manner as in Example 3, except that in Example 3, Colored composition 2 to Colored composition 23 and Colored composition 28 prepared by changing Exemplary Compound A-1 used in the preparation of the Colored composition 1 to each of the various compounds indicated in Table 2 (all of them are compounds described above as exemplary compounds of the particular metal complex compound), and adjusting the ratio of the exemplary compound and the pigment dispersion liquid (S-1) to match the chromaticity, were used.

Evaluations were performed in the same manner as in Example 3, using Colored composition 2 to Colored composition 23 and Colored composition 28, and Color Filter 2 to Color Filter 23 and Color Filter 28. The results are presented in Table 2.

### Example 26

Color Filter 24 was obtained in the same manner as in Example 3, except that in Example 3, Colored composition 24 was prepared by mixing the components in the composition described below, and the Colored composition 24 was used instead of the Colored composition 1.

<Composition>

| | | |
|---|---|---|
| Particular metal complex compound: | 6.9 | parts |
| Exemplary Compound A-1 | | |
| Pigment dispersion liquid: (S-1) | 43.0 | parts |
| Polymerizable compound: (T-1) | 103.4 | parts |
| Binder resin: (U-1) | 212.2 | parts |
| (value calculated relative to | | |
| solid content: 84.9 parts) | | |
| Photopolymerization initiator: (V-2) | 21.2 | parts |
| Photosensitizer: (W-1) | 3.5 | parts |
| Organic solvent: (X-1) | 71.9 | parts |
| Organic solvent: (X-2) | 3.6 | parts |
| Surfactant: (Y-1) | 0.06 | parts |

### Example 27 to Example 29

Color Filter 25 to Color Filter 27 were obtained in the same manner as in Example 26, except that in Example 26, Colored composition 25 to Colored composition 27 were prepared by changing the Exemplary Compound A-1 used in the preparation of the Colored composition 24 to each of the various compounds indicated in Table 2 (all of them are compounds described above as exemplary compounds of the particular metal complex compound), and adjusting the ratio of the exemplary compound and the pigment dispersion liquid (S-1) to match the chromaticity.

Evaluations were performed in the same manner as in Example 3, using Colored composition 25 to Colored composition 27, and Color Filter 25 to Color Filter 27. The results are presented in Table 2.

### Comparative Example 1 to Comparative Example 3

Color Filter C1 to Color Filter C3 were obtained in the same manner as in Example 3, except that Comparative Colored composition C1 to Comparative Colored composition C3 were prepared by changing the Exemplary Compound A-1 used in the preparation of the Colored composition 1 of Example 3 to each of the various comparative compounds indicated in Table 2, and adjusting the ratio of the comparative compound and the pigment dispersion liquid (S-1) to match the chromaticity.

Evaluations were performed in the same manner as in Example 3, using Comparative Colored composition C1 to Comparative Colored composition C3, and Color Filter C1 to Color Filter C3. The results are presented in Table 2.

Meanwhile, the details of the Comparative compounds 1 and 2 indicated in Table 2 are as follows.

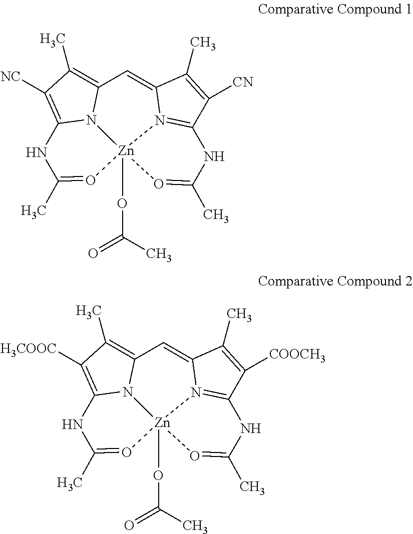

TABLE 2

| | | | Exemplary | Heat | Light |
|---|---|---|---|---|---|
| Example | Colored composition | Color Filter | Compound | resistance | resistance |
| Example 3 | Colored composition 1 | Color Filter 1 | A-1 | 5 | 5 |
| Example 4 | Colored composition 2 | Color Filter 2 | A-6 | 4 | 4 |
| Example 5 | Colored composition 3 | Color Filter 3 | A-14 | 5 | 5 |
| Example 6 | Colored composition 4 | Color Filter 4 | A-15 | 5 | 5 |
| Example 7 | Colored composition 5 | Color Filter 5 | B-1 | 5 | 5 |
| Example 8 | Colored composition 6 | Color Filter 6 | B-2 | 5 | 5 |
| Example 9 | Colored composition 7 | Color Filter 7 | B-21 | 4 | 4 |
| Example 10 | Colored composition 8 | Color Filter 8 | C-1 | 5 | 5 |
| Example 11 | Colored composition 9 | Color Filter 9 | C-3 | 5 | 5 |
| Example 12 | Colored composition 10 | Color Filter 10 | C-4 | 5 | 5 |
| Example 13 | Colored composition 11 | Color Filter 11 | C-5 | 5 | 5 |
| Example 14 | Colored composition 12 | Color Filter 12 | C-12 | 5 | 5 |
| Example 15 | Colored composition 13 | Color Filter 13 | C-13 | 5 | 5 |
| Example 16 | Colored composition 14 | Color Filter 14 | C-14 | 5 | 5 |
| Example 17 | Colored composition 15 | Color Filter 15 | C-16 | 5 | 5 |
| Example 18 | Colored composition 16 | Color Filter 16 | D-1 | 5 | 5 |
| Example 19 | Colored composition 17 | Color Filter 17 | D-2 | 5 | 5 |
| Example 20 | Colored composition 18 | Color Filter 18 | D-4 | 5 | 5 |
| Example 21 | Colored composition 19 | Color Filter 19 | D-5 | 5 | 5 |
| Example 22 | Colored composition 20 | Color Filter 20 | D-7 | 4 | 5 |
| Example 23 | Colored composition 21 | Color Filter 21 | D-9 | 5 | 5 |
| Example 24 | Colored composition 22 | Color Filter 22 | D-11 | 5 | 5 |
| Example 25 | Colored composition 23 | Color Filter 23 | E-4 | 4 | 4 |
| Example 26 | Colored composition 24 | Color Filter 24 | A-1 | 5 | 5 |
| Example 27 | Colored composition 25 | Color Filter 25 | B-2 | 5 | 5 |
| Example 28 | Colored composition 26 | Color Filter 26 | C-16 | 5 | 5 |
| Example 29 | Colored composition 27 | Color Filter 27 | D-2 | 5 | 5 |
| Example 30 | Colored composition 28 | Color Filter 28 | E-19 | 4 | 3 |
| Comparative | C1 | Comparative | C.I. Acid | 2 | 1 |
| Example 1 | | Color Filter 1 | Violet 49 | | |
| Comparative | C2 | Comparative | Comparative | 2 | 2 |
| Example 2 | | Color Filter 2 | Compound 1 | | |
| Comparative | C3 | Comparative | Comparative | 3 | 2 |
| Example 3 | | Color Filter 3 | Compound 2 | | |

As shown in Table 2, the color filters of the various Examples using the particular metal complex compounds were excellent in both heat resistance and light resistance, as compared with the color filter of Comparative Example 1 using a conventionally known compound. Furthermore, the various Examples using the particular metal complex compounds were capable of maintaining high fastness properties (particularly, heat resistance and light resistance), even when compared with Comparative Example 2 and Comparative Example 3 using conventionally known dipyrromethene metal complex compounds.

From the results described above, since a color filter produced using a particular metal complex compound has high fastness properties (heat resistance and light resistance), the particular metal complex compound according to the invention can be said to be a dye with high general-purpose usability.

All publications, patent applications, and technical standards mentioned in this specification are herein incorporated by reference to the same extent as if each individual publication, patent application, or technical standard was specifically and individually indicated to be incorporated by reference.

What is claimed is:

1. A colored composition comprising a dipyrromethene metal complex compound represented by the following formula (I) or a tautomer thereof: 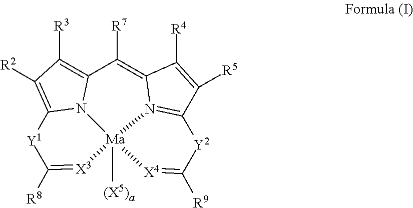
wherein, in formula (I), R² to R⁵ each independently represent a hydrogen atom or a monovalent substituent, provided that at least one of R² or R⁵ represents a heteroaryl group; R⁷ represents a hydrogen atom, a halogen atom, an alkyl group, an aryl group, or a heterocyclic group; Ma represents Zn; X³ and X⁴ each independently represent NR, a nitrogen atom, an oxygen atom, or a sulfur atom, wherein R represents a hydrogen atom, an alkyl group, an alkenyl group, an aryl group, a heterocyclic group, an acyl group, an alkylsulfonyl group, or an arylsulfonyl group; Y¹ and Y² each independently represent NR^{c}, a nitrogen atom, or a carbon atom, wherein R^{c} represents a hydrogen atom, an alkyl group, an alkenyl group, an aryl group, a heterocyclic group, an acyl group, an alkylsulfonyl group, or an arylsulfonyl group; R⁸ and R⁹ each independently represent an alkyl group, an alkenyl group, an aryl group, a heterocyclic group, an alkoxy group, an aryloxy group, an alkylamino group, an arylamino group, or a heterocyclic amino group; R⁸ and Y¹ may be bonded to each other to form a 5-membered, 6-membered or 7-membered ring; R⁹ and Y² may be bonded to each other to form a 5-membered, 6-membered or 7-membered ring; X⁵ represents a group capable of bonding to Ma; a represents 0, 1 or 2; and when a is 2, X⁵'s may be identical to or different from each other.

2. A colored composition comprising a dipyrromethene metal complex compound obtained from a dipyrromethene compound represented by the following formula and Zn, or a tautomer thereof: 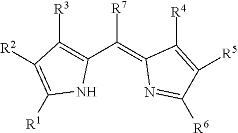
wherein, in the formula, R¹ to R⁶ each independently represent a hydrogen atom or a monovalent substituent, provided that at least one of R² or R⁵ represents a heteroaryl group; and R⁷ represents a hydrogen atom, a halogen atom, an alkyl group, an aryl group or a heterocyclic group.

3. The colored composition according to claim 1, wherein R² and R⁵ each independently represent a heteroaryl group.

4. The colored composition according to claim 1, wherein the heteroaryl group is represented by the following formula (II): 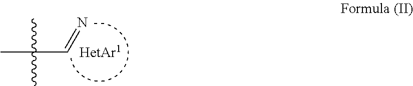
wherein, in formula (II), HetAr¹ represents a heteroaryl ring; the heteroaryl ring may have one or more substituents; and when the heteroaryl ring has a substituent, the substituent may be bonded to at least one of carbon atoms included in the heteroaryl ring to form a condensed ring together with the heteroaryl ring.

5. The colored composition according to claim 1, further comprising a polymerizable compound and a photopolymerization initiator.

6. A colored cured film obtained by curing the colored composition according to claim 1.

7. A color filter comprising the colored cured film according to claim 6.

8. A method for producing a color filter, comprising:
applying the colored composition according to claim 1 onto a support to form a colored composition layer; and
patternwise exposing and developing the formed colored composition layer to form a patterned colored cured film.

9. A liquid crystal display device comprising the color filter according to claim 7.

10. A solid-state imaging device comprising the color filter according to claim 7.

11. The colored composition according to claim 2, wherein R² and R⁵ each independently represent a heteroaryl group.

12. The colored composition according to claim 2, wherein the heteroaryl group is represented by the following formula (II): 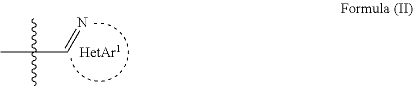
wherein, in formula (II), HetAr¹ represents a heteroaryl ring; the heteroaryl ring may have one or more substituents; and when the heteroaryl ring has a substituent, the substituent may be bonded to at least one of carbon atoms included in the heteroaryl ring to form a condensed ring together with the heteroaryl ring.

13. The colored composition according to claim 2, further comprising a polymerizable compound and a photopolymerization initiator.

14. A colored cured film obtained by curing the colored composition according to claim 2.

15. A color filter comprising the colored cured film according to claim 14.

16. A method for producing a color filter, comprising:
applying the colored composition according to claim 2 onto a support to form a colored composition layer; and
patternwise exposing and developing the formed colored composition layer to form a patterned colored cured film.

17. A liquid crystal display device comprising the color filter according to claim 15.

18. A solid-state imaging device comprising the color filter according to claim 15.

19. A dipyrromethene metal complex compound represented by the following formula (I) or a tautomer thereof: 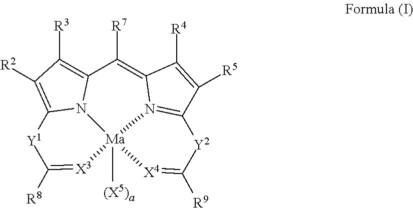
wherein, in formula (I), R² to R⁵ each independently represent a hydrogen atom or a monovalent substituent, provided that at least one of R² or R⁵ represents a heteroaryl group; R⁷ represents a hydrogen atom, a halogen atom, an alkyl group, an aryl group, or a heterocyclic group; Ma represents Zn; X³ and X⁴ each independently represent NR, a nitrogen atom, an oxygen atom, or a sulfur atom, wherein R represents a hydrogen atom, an alkyl group, an alkenyl group, an aryl group, a heterocyclic group, an acyl group, an alkylsulfonyl group, or an arylsulfonyl group; Y¹ and Y² each independently represent NR^{c}, a nitrogen atom, or a carbon atom, wherein R^{c} represents a hydrogen atom, an alkyl group, an alkenyl group, an aryl group, a heterocyclic group, an acyl group, an alkylsulfonyl group, or an arylsulfonyl group; R⁸ and R⁹ each independently represent an alkyl group, an alkenyl group, an aryl group, a heterocyclic group, an alkoxy group, an aryloxy group, an alkylamino group, an arylamino group, or a heterocyclic amino group; R⁸ and Y¹ may be bonded to each other to form a 5-membered, 6-membered or 7-membered ring; R⁹ and Y² may be bonded to each other to form a 5-membered, 6-membered or 7-membered ring; X⁵ represents a group capable of bonding to Ma; a represents 0, 1 or 2; and when a is 2, X⁵'s may be identical to or different from each other.
